(19) United States
(12) Patent Application Publication
(10) Pub. No.: US 2025/0389565 A1
(43) Pub. Date: Dec. 25, 2025

(54) Autonomous Vehicle Sensor Fusion Using Multimodal Series Transformation with Neural Upsampling and Error Resilience

(71) Applicant: AtomBeam Technologies Inc., Moraga, CA (US)

(72) Inventor: Brian Galvin, Silverdale, WA (US)

(21) Appl. No.: 19/314,418

(22) Filed: Aug. 29, 2025

Related U.S. Application Data
(63) Continuation-in-part of application No. 19/087,497, filed on Mar. 22, 2025, now Pat. No. 12,437,448.
Application No. 19/087,497 is a continuation-in-part of application No. 18/915,030, filed on Oct. 14, 2024, now Pat. No. 12,262,036.
Application No. 18/915,030 is a continuation-in-part of application No. 18/668,163, filed on May 18, 2024, now Pat. No. 12,167,031.
Application No. 18/668,163 is a continuation-in-part of application No. 18/537,728, filed on Dec. 12, 2023, now Pat. No. 12,058,333.

(51) Int. Cl. G01D 21/02

(52) U.S. Cl. CPC G01D 21/02

(57) ABSTRACT

A collaborative autonomous vehicle sensor fusion system enables multiple vehicles to share multimodal sensor data for enhanced perception capabilities beyond individual vehicle limitations. Each autonomous vehicle captures multimodal sensor data, identifies safety-critical objects, applies priority-based compression based on safety criticality, and shares compressed data via vehicle-to-vehicle communication. An enhanced multi-vehicle AI deblocking network receives the compressed sensor data and enhances perception data for each vehicle using sensor data from multiple vehicles in the collaborative network. The system prioritizes reconstruction quality for safety-critical objects over non-safety-critical objects and enables detection of safety-critical objects occluded from individual vehicles through collaborative sensor fusion. The network fuses multimodal sensor data by identifying cross-modal correlations between different sensor types and uses these correlations to reconstruct sensor information that is degraded or occluded in individual vehicles, providing improved situational awareness for autonomous vehicle operation.

### CROSS-REFERENCE TO RELATED APPLICATIONS

Priority is claimed in the application data sheet to the following patents or patent applications, each of which is expressly incorporated herein by reference in its entirety:
Ser. No. 19/087,497
Ser. No. 18/915,030
Ser. No. 18/668,163
Ser. No. 18/537,728

### BACKGROUND OF THE INVENTION

### Field of the Art

The present invention is in the field of data compression, and more particularly is directed to the problem of recovering data lost from lossy compression and decompression.

### Discussion of the State of the Art

Autonomous vehicles rely on sophisticated sensor arrays comprising multiple modalities such as light detection and ranging (LiDAR), optical cameras, thermal imaging, radar, and ultrasonic sensors to perceive their environment and make safety-critical driving decisions. Each sensor modality provides unique advantages: LiDAR offers precise geometric measurements and operates effectively in low-light conditions; optical cameras provide rich visual information and color discrimination; thermal sensors detect heat signatures useful for pedestrian detection; and radar systems excel at detecting moving objects and operate reliably in adverse weather conditions. However, individual autonomous vehicles face fundamental limitations including sensor occlusions caused by other vehicles, infrastructure, or environmental obstacles, finite sensor range and field-of-view constraints, weather-dependent degradation of sensor performance, and computational resource limitations that restrict real-time processing capabilities.

Traditional approaches to autonomous vehicle perception have focused on improving individual vehicle sensor suites and processing algorithms, but these approaches cannot overcome the fundamental physical limitations imposed by single-vehicle perspectives. Recent research has explored vehicle-to-vehicle (V2V) communication for sharing basic safety messages, but existing systems primarily transmit simple alerts rather than rich sensor data due to bandwidth limitations and the lack of efficient compression techniques suitable for multimodal automotive sensor data.

The challenge of efficiently compressing and transmitting multimodal sensor data between vehicles is compounded by the real-time requirements of autonomous vehicle operation, where safety-critical decisions must be made within milliseconds. Conventional compression algorithms designed for entertainment or communication applications are inadequate for automotive sensor data because they fail to preserve the spatial and temporal correlations essential for accurate object detection and tracking, do not account for the safety-critical nature of certain data regions, lack the robustness required for reliable transmission in mobile vehicular environments, and cannot efficiently exploit the complementary relationships between different sensor modalities.

Furthermore, the lossy nature of practical compression algorithms introduces artifacts that can degrade the quality of reconstructed sensor data, potentially compromising the accuracy of safety-critical object detection and tracking algorithms. Traditional deblocking and enhancement techniques are insufficient for automotive applications because they do not account for the multi-modal nature of automotive sensor data, cannot prioritize reconstruction quality based on safety criticality, and lack the cross-vehicle collaborative capabilities needed to overcome individual vehicle limitations.

The automotive industry has recognized the potential benefits of collaborative perception, where multiple vehicles share sensor information to create a more comprehensive understanding of the driving environment. However, existing approaches to collaborative perception face significant technical barriers including the massive bandwidth requirements for transmitting raw or lightly compressed sensor data, the lack of efficient compression techniques that preserve essential information while achieving practical transmission rates, insufficient error resilience for reliable data transmission in challenging mobile environments, and the absence of reconstruction techniques capable of leveraging cross-vehicle sensor correlations for enhanced perception quality.

What is needed is a collaborative autonomous vehicle sensor fusion system that applies advanced multimodal compression and neural upsampling techniques specifically adapted for automotive applications, enabling efficient sharing of sensor data between vehicles while maintaining the fidelity required for safety-critical perception tasks and providing robust error resilience for reliable operation in challenging mobile environments.

### SUMMARY OF THE INVENTION

Accordingly, the inventor has conceived and reduced to practice, a collaborative autonomous vehicle sensor fusion system enables multiple vehicles to share multimodal sensor data for enhanced perception capabilities beyond individual vehicle limitations. Each autonomous vehicle captures multimodal sensor data, identifies safety-critical objects, applies priority-based compression based on safety criticality, and shares compressed data via vehicle-to-vehicle communication. An enhanced multi-vehicle AI deblocking network receives the compressed sensor data and enhances perception data for each vehicle using sensor data from multiple vehicles in the collaborative network. The system prioritizes reconstruction quality for safety-critical objects over non-safety-critical objects and enables detection of safety-critical objects occluded from individual vehicles through collaborative sensor fusion. The network fuses multimodal sensor data by identifying cross-modal correlations between different sensor types and uses these correlations to reconstruct sensor information that is degraded or occluded in individual vehicles, providing superior situational awareness for autonomous vehicle operation.

According to a preferred embodiment, a collaborative autonomous vehicle sensor fusion system is disclosed, comprising: a plurality of autonomous vehicles configured to: capture multimodal sensor data; identify safety-critical objects within the sensor data; apply priority-based compression to the sensor data based on safety criticality of detected objects; and share compressed sensor data via vehicle-to-vehicle communication; and a multi-vehicle deblocking network configured to: receive compressed sensor data from the plurality of autonomous vehicles; enhance perception data for each autonomous vehicle using sensor data from multiple vehicles in the plurality; and prioritize reconstruction quality for safety-critical objects over non-safety-critical objects; wherein the system enables detection of safety-critical objects that are occluded from individual autonomous vehicles through collaborative sensor fusion across the plurality of autonomous vehicles.

According to another preferred embodiment, a method for collaborative autonomous vehicle sensor fusion is disclosed, comprising the steps of: capturing multimodal sensor data at each of a plurality of autonomous vehicles; identifying safety-critical objects within the sensor data at each autonomous vehicle; applying priority-based compression to the sensor data based on safety criticality of detected objects; sharing compressed sensor data between the autonomous vehicles via vehicle-to-vehicle communication; receiving the compressed sensor data from the plurality of autonomous vehicles at a multi-vehicle deblocking network; enhancing perception data for each autonomous vehicle using sensor data from multiple vehicles in the plurality; and prioritizing reconstruction quality for safety-critical objects over non-safety-critical objects; wherein the method enables detection of safety-critical objects that are occluded from individual autonomous vehicles through collaborative sensor fusion across the plurality of autonomous vehicles.

According to a further aspect, the method includes enhancing perception data by fusing multimodal sensor data from multiple vehicles by identifying cross-modal correlations between different sensor types and using the correlations to reconstruct sensor information that is degraded or occluded in individual vehicles.

According to a further aspect, the method includes applying priority-based compression by applying different compression ratios to different regions of the sensor data, with safety-critical regions receiving lower compression ratios than non-safety-critical regions.

According to a further aspect, the method includes identifying safety-critical objects by classifying vulnerable road users as having higher safety criticality than vehicles or infrastructure objects.

According to a further aspect, the method includes applying error correction coding with protection levels corresponding to the safety criticality of detected objects.

According to a further aspect, the method includes sharing compressed sensor data by adapting communication protocols based on latency requirements of the shared sensor data.

According to a further aspect, the method includes maintaining autonomous operation at each vehicle using local sensor data when vehicle-to-vehicle communication is unavailable.

According to a further aspect, the method includes enhancing perception data by processing sensor data from vehicles at different spatial positions to overcome line-of-sight limitations affecting individual vehicles.

According to a further aspect, the method includes identifying cross-modal correlations by determining spatial relationships between LiDAR geometry data and optical image features from multiple vehicles.

According to a further aspect, the method includes capturing multimodal sensor data by capturing at least two of: LiDAR point cloud data, optical camera data, thermal imaging data, and radar detection data.

### BRIEF DESCRIPTION OF THE DRAWING FIGURES

FIG. 1 is a block diagram illustrating an exemplary system architecture for complex-valued SAR image compression with predictive recovery, according to an embodiment.

FIGS. 2A and 2B illustrate an exemplary architecture for an AI deblocking network configured to provide deblocking on dual-channel data stream comprising SAR I/Q data, according to an embodiment.

FIG. 3 is a block diagram illustrating an exemplary architecture for a component of the system for SAR image compression, the channel-wise transformer.

FIG. 4 is a block diagram illustrating an exemplary system architecture for providing lossless data compaction, according to an embodiment.

FIG. 5 is a diagram showing an embodiment of one aspect of the lossless data compaction system, specifically data deconstruction engine.

FIG. 6 is a diagram showing an embodiment of another aspect of lossless data compaction system 600, specifically data reconstruction engine.

FIG. 7 is a diagram showing an embodiment of another aspect of lossless data compaction the system 700, specifically library manager.

FIG. 8 is a flow diagram illustrating an exemplary method for complex-valued SAR image compression, according to an embodiment.

FIG. 9 is a flow diagram illustrating and exemplary method for decompression of a complex-valued SAR image, according to an embodiment.

FIG. 10 is a flow diagram illustrating an exemplary method for deblocking using a trained deep learning algorithm, according to an embodiment.

FIGS. 11A and 11B illustrate an exemplary architecture for an AI deblocking network configured to provide deblocking for a general N-channel data stream, according to an embodiment.

FIG. 12 is a block diagram illustrating an exemplary system architecture for N-channel data compression with predictive recovery, according to an embodiment.

FIG. 13 is a flow diagram illustrating an exemplary method for processing a compressed n-channel bit stream using an AI deblocking network, according to an embodiment.

FIG. 14 is a block diagram illustrating an exemplary architecture for a system and method for image series transformation for optimal compressibility with neural upsampling.

FIG. 15 is a block diagram illustrating a component of a system for image series transformation for optimal compressibility with neural upsampling, an angle optimizer, where the angle optimizer uses a convolutional neural network.

FIG. 16 is a block diagram illustrating a component of a system for image series transformation for optimal compressibility with neural upsampling, an angle optimizer training system.

FIG. 17 is a flow diagram illustrating an exemplary method for optimizing the compression and decompression of medical images by slicing the images along various planes before compression.

FIG. 18 is a flow diagram illustrating an exemplary method for optimizing the compression and decompression of aerial images by slicing the images along various planes before compression.

FIG. 19 is a block diagram illustrating exemplary architecture for error resilience subsystem.

FIG. 20 is a method diagram illustrating the use of error resilience subsystem.

FIG. 21 is a block diagram illustrating an exemplary architecture for a system and method for multimodal series transformation for optimal compressibility with neural upsampling.

FIG. 22 is a block diagram illustrating a component of a system for multimodal series transformation for optimal compressibility with neural upsampling, a multimodal preprocessor.

FIG. 23 is a flow diagram illustrating an exemplary method for optimizing the compression and decompression of multimodal data by slicing data along various planes before compression.

FIG. 24 is a flow diagram illustrating an exemplary method for reconstructing and enhancing the compressed and decompressed multimodal data that has been sliced.

FIG. 25 is a block diagram illustrating an exemplary system architecture for autonomous vehicle sensor fusion with collaborative multimodal data compression and neural upsampling, according to an embodiment.

FIG. 26 is a block diagram illustrating an exemplary architecture for the enhanced multi-vehicle AI deblocking network, according to an embodiment.

FIG. 27 is a top-down view diagram illustrating an exemplary scenario for cross-vehicle occlusion handling using the collaborative autonomous vehicle sensor fusion system, according to an embodiment.

FIG. 28 is a flow diagram illustrating an exemplary method for safety-critical region detection and priority assignment, according to an embodiment

FIG. 29 is a block diagram illustrating an exemplary distributed processing architecture for the autonomous vehicle sensor fusion system, according to an embodiment.

FIG. 30 is a flow diagram illustrating an exemplary method for autonomous vehicle sensor fusion with collaborative multimodal data compression and neural upsampling, according to an embodiment.

FIG. 31 illustrates an exemplary computing environment on which an embodiment described herein may be implemented, in full or in part.

### DETAILED DESCRIPTION OF THE INVENTION

The inventor has conceived, and reduced to practice, a collaborative autonomous vehicle sensor fusion system enables multiple vehicles to share multimodal sensor data for enhanced perception capabilities beyond individual vehicle limitations. Each autonomous vehicle captures multimodal sensor data, identifies safety-critical objects, applies priority-based compression based on safety criticality, and shares compressed data via vehicle-to-vehicle communication. An enhanced multi-vehicle AI deblocking network receives the compressed sensor data and enhances perception data for each vehicle using sensor data from multiple vehicles in the collaborative network. The system prioritizes reconstruction quality for safety-critical objects over non-safety-critical objects and enables detection of safety-critical objects occluded from individual vehicles through collaborative sensor fusion. The network fuses multimodal sensor data by identifying cross-modal correlations between different sensor types and uses these correlations to reconstruct sensor information that is degraded or occluded in individual vehicles, providing superior situational awareness for autonomous vehicle operation.

The collaborative autonomous vehicle sensor fusion system described herein represents a specialized application of the multimodal series transformation technology with neural upsampling and error resilience previously disclosed. The fundamental principles of optimal compressibility through angle optimization, multimodal data correlation, and AI-based reconstruction that have proven effective for medical imaging, aerial photography, and synthetic aperture radar (SAR) applications are particularly well-suited to address the unique challenges of autonomous vehicle sensor fusion. In autonomous vehicle applications, multiple vehicles equipped with diverse sensor modalities including, but not limited to, LiDAR, optical cameras, thermal imaging, and radar, generate continuous streams of multimodal data that must be efficiently compressed, transmitted, and reconstructed in real-time to enable collaborative sensing capabilities. The safety-critical nature of autonomous vehicle operation demands not only the high-fidelity reconstruction capabilities provided by the neural upsampling technology, but also the robust error resilience techniques to ensure reliable data transmission between vehicles. By applying the established multimodal series transformation and neural upsampling framework to the specific context of vehicle-to-vehicle sensor data sharing, the system enables collaborative perception capabilities where individual vehicle sensor limitations and occlusions are overcome through cross-vehicle sensor fusion, while maintaining the computational efficiency and data integrity essential for real-time autonomous vehicle operation.

Synthetic Aperture Radar technology is used to capture detailed images of the Earth's surface by emitting microwave signals and measuring their reflections. Unlike traditional grayscale images that use a single intensity value per pixel, SAR images are more complex. Each pixel in a SAR image contains not just one value but a complex number (I+Qi). A complex number consists of two components: magnitude (or amplitude) and phase. In the context of SAR, the complex value at each pixel represents the strength of the radar signal's reflection (magnitude) and the phase shift (phase) of the signal after interacting with the terrain. This information is crucial for understanding the properties of the surface and the objects present. In a complex-value SAR image, the magnitude of the complex number indicates the intensity of the radar reflection, essentially representing how strong the radar signal bounced back from the surface. Higher magnitudes usually correspond to stronger reflections, which may indicate dense or reflective materials on the ground.

The complex nature of SAR images stems from the interference and coherence properties of radar waves. When radar waves bounce off various features on the Earth's surface, they can interfere with each other. This interference pattern depends on the radar's wavelength, the angle of incidence, and the distances the waves travel. As a result, the radar waves can combine constructively (amplifying the signal) or destructively (canceling out the signal). This interference phenomenon contributes to the complex nature of SAR images. The phase of the complex value encodes information about the distance the radar signal traveled and any changes it underwent during the round-trip journey. For instance, if the radar signal encounters a surface that's slightly elevated or depressed, the phase of the returning signal will be shifted accordingly. Phase information is crucial for generating accurate topographic maps and understanding the geometry of the terrain.

Coherence refers to the consistency of the phase relationship between different pixels in a SAR image. Regions with high coherence have similar phase patterns and are likely to represent stable surfaces or structures, while regions with low coherence might indicate changes or disturbances in the terrain.

Complex-value SAR image compression is important for several reasons such as data volume reduction, bandwidth and transmission efficiency, real-time applications, and archiving and retrieval. SAR images can be quite large due to their high resolution and complex nature. Compression helps reduce the storage and transmission requirements, making it more feasible to handle and process the data. When SAR images need to be transmitted over limited bandwidth channels, compression can help optimize data transmission and minimize communication costs. Some SAR applications, such as disaster response and surveillance, require real-time processing. Compressed data can be processed faster, enabling quicker decision-making. Additionally, compressed SAR images take up less storage space, making long-term archiving and retrieval more manageable. However, the compression process can introduce vulnerabilities to transmission errors, which is addressed by the error resilience techniques introduced in this invention.

According to various embodiments, a system is proposed which provides a novel pipeline for compressing and subsequently recovering complex-valued SAR image data using a prediction recovery framework that utilizes a conventional image compression algorithm to encode the original image to a bitstream. In an embodiment, a lossless compaction method may be applied to the encoded bitstream, further reducing the size of the SAR image data for both storage and transmission. The system then applies error resilience techniques to the compressed images, enhancing their robustness against transmission errors or data loss. Subsequently, the system decodes a prediction of the I/Q channels, performs error correction and concealment based on the applied error resilience techniques, and then recovers the phase and amplitude via a deep-learning based network to effectively remove compression artifacts and recover information of the SAR image as part of the loss function in the training. The deep-learning based network may be referred to herein as an artificial intelligence (AI) deblocking network.

Deblocking refers to a technique used to reduce or eliminate blocky artifacts that can occur in compressed images or videos. These artifacts are a result of lossy compression algorithms, such as JPEG for images or various video codecs like H.264, H.265 (HEVC), and others, which divide the image or video into blocks and encode them with varying levels of quality. Blocky artifacts, also known as “blocking artifacts,” become visible when the compression ratio is high, or the bitrate is low. These artifacts manifest as noticeable edges or discontinuities between adjacent blocks in the image or video. The result is a visual degradation characterized by visible square or rectangular regions, which can significantly reduce the overall quality and aesthetics of the content. Deblocking techniques are applied during the decoding process to mitigate or remove these artifacts. These techniques typically involve post-processing steps that smooth out the transitions between adjacent blocks, thus improving the overall visual appearance of the image or video. Deblocking filters are commonly used in video codecs to reduce the impact of blocking artifacts on the decoded video frames.

According to various embodiments, the disclosed system and methods may utilize a SAR recovery network configured to perform data deblocking during the data decoding process. Amplitude and phase images exhibit a non-linear relationship, while I and Q images demonstrate a linear relationship. The SAR recovery network is designed to leverage this linear relationship by utilizing the I/Q images to enhance the decoded SAR image. In an embodiment, the SAR recovery network is a deep learned neural network. According to an aspect of an embodiment, the SAR recovery network utilizes residual learning techniques. According to an aspect of an embodiment, the SAR recovery network comprises a channel-wise transformer with attention. According to an aspect of an embodiment, the SAR recovery network comprises Multi-Scale Attention Blocks (MSAB). The network is also designed to work in conjunction with the applied error resilience techniques, leveraging the additional information provided by these techniques to improve the quality of the reconstructed images.

A channel-wise transformer with attention is a neural network architecture that combines elements of both the transformer architecture and channel-wise attention mechanisms. It's designed to process multi-channel data, such as SAR images, where each channel corresponds to a specific feature map or modality. The transformer architecture is a powerful neural network architecture initially designed for natural language processing (NLP) tasks. It consists of self-attention mechanisms that allow each element in a sequence to capture relationships with other elements, regardless of their position. The transformer has two main components: the self-attention mechanism (multi-head self-attention) and feedforward neural networks (position-wise feedforward layers). Channel-wise attention, also known as “Squeeze-and-Excitation” (SE) attention, is a mechanism commonly used in convolutional neural networks (CNNs) to model the interdependencies between channels (feature maps) within a single layer. It assigns different weights to different channels to emphasize important channels and suppress less informative ones. At each layer of the network, a channel-wise attention mechanism is applied to the input data. This mechanism captures the relationships between different channels within the same layer and assigns importance scores to each channel based on its contribution to the overall representation. After the channel-wise attention, a transformer-style self-attention mechanism is applied to the output of the channel-wise attention. This allows each channel to capture dependencies with other channels in a more global context, similar to how the transformer captures relationships between elements in a sequence. Following the transformer self-attention, feedforward neural network layers (position-wise feedforward layers) can be applied to further process the transformed data.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

The error resilience techniques applied to the compressed images may include forward error correction coding, data partitioning based on importance, and embedding error concealment hints. Forward error correction coding, such as Reed-Solomon codes or Low-Density Parity-Check codes, adds redundant data to the compressed images, allowing for the correction of a certain number of errors without retransmission. Data partitioning separates the compressed images into at least three partitions: header information, low-frequency coefficients, and high-frequency coefficients. This partitioning allows for prioritized transmission and protection of the most critical image data. Error concealment hints, which may include information about neighboring blocks or redundant feature data, are embedded within the compressed data to assist in concealing errors during the decoding process.

During the decoding process, the system performs error correction and concealment based on the applied error resilience techniques. This process involves detecting and correcting errors using the forward error correction codes, prioritizing the reconstruction of the most important partitions of the image data, and utilizing the embedded error concealment hints to mitigate the impact of any uncorrectable errors. These techniques work in concert with the AI deblocking network to produce high-quality reconstructed images that are resilient to transmission errors and data loss.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “codebook” refers to a database containing sourceblocks each with a pattern of bits and reference code unique within that library. The terms “library” and “encoding/decoding library” are synonymous with the term codebook.

The terms “compression” and “deflation” as used herein mean the representation of data in a more compact form than the original dataset. Compression and/or deflation may be either “lossless”, in which the data can be reconstructed in its original form without any loss of the original data, or “lossy” in which the data can be reconstructed in its original form, but with some loss of the original data.

The terms “compression factor” and “deflation factor” as used herein mean the net reduction in size of the compressed data relative to the original data (e.g., if the new data is 70% of the size of the original, then the deflation/compression factor is 30% or 0.3.)

The terms “compression ratio” and “deflation ratio”, and as used herein all mean the size of the original data relative to the size of the compressed data (e.g., if the new data is 70% of the size of the original, then the deflation/compression ratio is 70% or 0.7.)

The term “data set” refers to a grouping of data for a particular purpose. One example of a data set might be a word processing file containing text and formatting information. Another example of a data set might comprise data gathered/generated as the result of one or more radars in operation.

The term “sourcepacket” as used herein means a packet of data received for encoding or decoding. A sourcepacket may be a portion of a data set.

The term “sourceblock” as used herein means a defined number of bits or bytes used as the block size for encoding or decoding. A sourcepacket may be divisible into a number of sourceblocks. As one non-limiting example, a 1 megabyte sourcepacket of data may be encoded using 512 byte sourceblocks. The number of bits in a sourceblock may be dynamically optimized by the system during operation. In one aspect, a sourceblock may be of the same length as the block size used by a particular file system, typically 512 bytes or 4,096 bytes.

The term “codeword” refers to the reference code form in which data is stored or transmitted in an aspect of the system. A codeword consists of a reference code to a sourceblock in the library plus an indication of that sourceblock's location in a particular data set.

The term “deblocking” as used herein refers to a technique used to reduce or eliminate blocky artifacts that can occur in compressed images or videos. These artifacts are a result of lossy compression algorithms, such as JPEG for images or various video codecs like H.264, H.265 (HEVC), and others, which divide the image or video into blocks and encode them with varying levels of quality. Blocky artifacts, also known as “blocking artifacts,” become visible when the compression ratio is high, or the bitrate is low. These artifacts manifest as noticeable edges or discontinuities between adjacent blocks in the image or video. The result is a visual degradation characterized by visible square or rectangular regions, which can significantly reduce the overall quality and aesthetics of the content. Deblocking techniques are applied during the decoding process to mitigate or remove these artifacts. These techniques typically involve post-processing steps that smooth out the transitions between adjacent blocks, thus improving the overall visual appearance of the image or video. Deblocking filters are commonly used in video codecs to reduce the impact of blocking artifacts on the decoded video frames. A primary goal of deblocking is to enhance the perceptual quality of the compressed content, making it more visually appealing to viewers. It's important to note that deblocking is just one of many post-processing steps applied during the decoding and playback of compressed images and videos to improve their quality.

The term “forward error correction (FEC) coding” refers to a technique used in data transmission where the sender adds redundant data to its messages, allowing the receiver to detect and correct errors without needing to request retransmission of data.

The term “error concealment hints” refers to additional information embedded in the compressed bitstream that provides guidance on how to reconstruct or approximate data that may be lost or corrupted during transmission.

The term “data partitioning” refers to the process of dividing compressed image data into multiple segments based on their importance to image reconstruction, allowing for prioritized protection and transmission of critical image components.

The term “AI deblocking network” refers to a deep learning-based system designed to remove compression artifacts and enhance the quality of decompressed images, utilizing convolutional layers and channel-wise transformers to capture both local and global image features.

The term “error flags” refers to indicators embedded in the decoded data that mark regions of the image affected by transmission errors, guiding the AI deblocking network in its reconstruction efforts.

These definitions would help ensure clarity and precision in the patent application, particularly when describing the novel aspects of the error resilience subsystem and its integration with the AI deblocking process.

### Conceptual Architecture

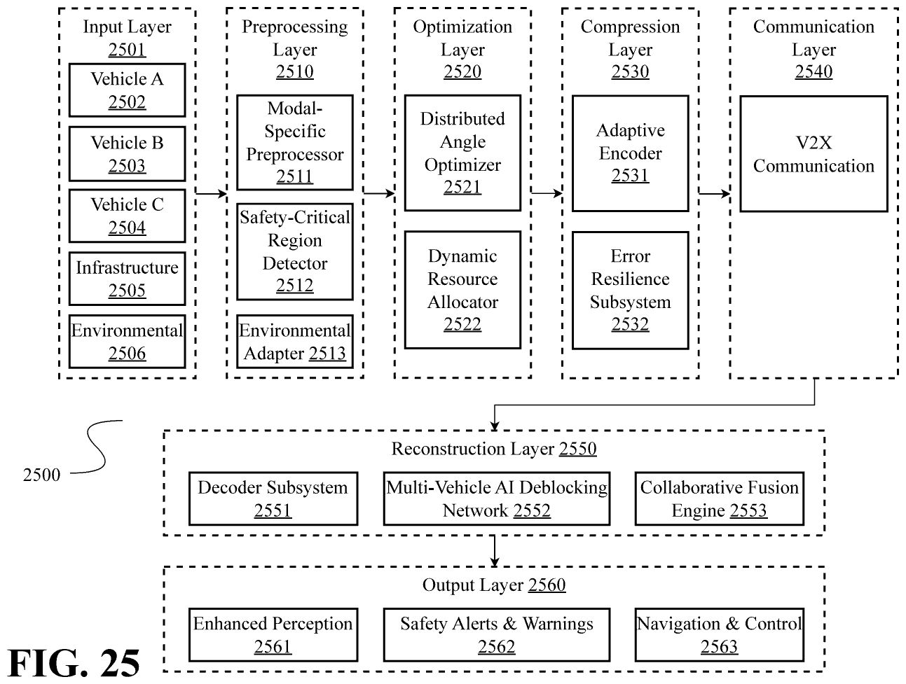

FIG. 25 is a block diagram illustrating an exemplary system architecture 2500 for autonomous vehicle sensor fusion with collaborative multimodal data compression and neural upsampling, according to an embodiment. The system 2500 represents a significant extension of the original multimodal compression invention, specifically adapted for safety-critical autonomous vehicle applications where real-time processing, cross-vehicle collaboration, and hazard detection are paramount.

According to the embodiment, the system 2500 comprises a multi-vehicle input layer 2501 configured to receive sensor data from a plurality of autonomous vehicles and infrastructure elements operating within a collaborative sensing network. The multi-vehicle input layer 2501 may comprise Vehicle A sensor suite 2502, Vehicle B sensor suite 2503, Vehicle C sensor suite 2504, infrastructure sensor suite 2505, and environmental sensor suite 2506. Vehicle A sensor suite 2502 may comprise high-resolution LiDAR sensors (such as 64-beam scanning LiDAR operating at 905 nm wavelength), stereo camera systems (typically 8-megapixel resolution with baseline separation of 20-30 cm for depth estimation), and thermal imaging cameras (e.g., operating in 8-12 micrometer infrared spectrum). For example, in a typical urban driving scenario, Vehicle A 2502 might be a lead autonomous vehicle equipped with premium sensor hardware capable of detecting pedestrians at distances up to 200 meters and vehicles at distances up to 500 meters under optimal conditions.

Vehicle B sensor suite 2503 may be configured with medium-resolution LiDAR sensors (such as 32-beam systems), monocular camera systems (4-megapixel resolution with advanced depth estimation algorithms), and 77 GHz radar arrays (with angular resolution of 1-2 degrees and range resolution of 0.1-0.2 meters). In an embodiment, Vehicle B 2503 represents a following vehicle in a convoy or platoon configuration, where it benefits from the enhanced sensing capabilities of Vehicle A 2502 while contributing its own unique sensor perspective to the collaborative network. Vehicle C sensor suite 2504 may comprise 360-degree LiDAR arrays (providing complete surround sensing), multiple surround-view cameras (typically 12 cameras providing spherical coverage), and ultrasonic sensors (e.g., operating at 40 kHz frequency for close-proximity detection). Vehicle C 2504 may represent a commercial vehicle such as a delivery truck or passenger bus, where comprehensive monitoring of the vehicle's immediate surroundings is critical for pedestrian safety and maneuvering in tight spaces.

Infrastructure sensor suite 2505 may include, but is not limited to, roadside unit (RSU) LiDAR systems, intersection monitoring cameras, traffic signal interface modules, and 5G base station connectivity. The infrastructure sensors 2505 provide a stationary reference point for the mobile vehicle sensors, enabling enhanced object tracking and trajectory prediction by maintaining continuous observation of specific geographic regions. Environmental sensor suite 2506 may comprise, but is not limited to, weather monitoring sensors (including precipitation, visibility, and wind speed sensors), traffic density analyzers, and ambient lighting condition detectors. The environmental sensor suite 2506 enables system 2500 to adapt its processing parameters based on real-time environmental conditions, such as reducing camera reliance during heavy rain or fog conditions while increasing LiDAR and radar processing priority.

The sensor data from the multi-vehicle input layer 2501 is processed by an enhanced preprocessing layer 2510 that extends the original modal-specific preprocessing capabilities to handle the unique requirements of autonomous vehicle sensor fusion. The preprocessing layer 2510 comprises a modal-specific preprocessor 2511, a safety-critical region detector 2512, and an environmental adapter 2513. Modal-specific preprocessor 2511 builds upon the preprocessing capabilities described herein, applying sensor-specific calibration, noise reduction, and feature extraction techniques. For LiDAR data, this may include statistical outlier removal, ground plane estimation, and intensity normalization. For camera data, this may include lens distortion correction, white balance adjustment, and temporal noise reduction. For radar data, this may include Doppler filtering, range-azimuth processing, and false alarm mitigation.

The safety-critical region detector 2512 can be configured to analyze the preprocessed sensor data to identify regions of the sensed environment that contain safety-critical objects such as pedestrians, cyclists, emergency vehicles, school buses, and construction workers. In one embodiment, detector 2512 employs deep learning algorithms, such as YOLO (You Only Look Once) or R-CNN (Region-based Convolutional Neural Network) architectures, trained specifically on automotive safety scenarios. The detector 2512 assigns priority levels to detected objects: CRITICAL priority for vulnerable road users (pedestrians, cyclists, motorcyclists) who present the highest risk of injury in collision scenarios; HIGH priority for other vehicles that present significant collision risks; MEDIUM priority for static infrastructure elements (traffic signs, barriers, construction equipment); and LOW priority for background elements (buildings, vegetation, sky) that provide contextual information but do not require immediate safety response.

For example, in a complex urban intersection scenario, safety-critical region detector 2512 can simultaneously identify a pedestrian waiting at a crosswalk (CRITICAL priority), an approaching vehicle in the adjacent lane (HIGH priority), a stop sign (MEDIUM priority), and surrounding buildings (LOW priority). Detector 2512 not only identifies these objects but also estimates their trajectory, velocity, and collision risk probability, enabling the downstream processing components to allocate computational resources appropriately.

According to an embodiment, environmental adapter 2513 is configured to modify preprocessing parameters based on real-time environmental conditions detected by environmental sensor suite 2506. During rain conditions, adapter 2513 may increase contrast enhancement for camera data, apply water droplet detection and removal algorithms, and increase temporal averaging to reduce noise from rain-scattered laser returns in LiDAR data. During night conditions, adapter 2513 may prioritize infrared and thermal camera channels, apply specialized noise reduction algorithms optimized for low-light conditions, and adjust radar processing to compensate for reduced visibility. During fog conditions, adapter 2513 may increase LiDAR processing priority while reducing camera reliance, apply specialized filtering algorithms to improve penetration through atmospheric scattering, and adjust detection thresholds to account for reduced sensor effectiveness.

The preprocessed sensor data flows to an optimization layer 2520 comprising a distributed angle optimizer 2521 and a dynamic resource allocator 2522. Distributed angle optimizer 2521 can be enhanced, extending the CNN-based optimization to operate across multiple vehicles in a federated learning framework. Rather than optimizing compression angles for a single data stream, distributed optimizer 2521 determines optimal slicing angles that maximize compression efficiency across the entire vehicle network while preserving the cross-modal relationships that are critical for safety-critical object detection and tracking.

According to an aspect of an embodiment, distributed angle optimizer 2521 employs a multi-objective optimization approach that balances compression efficiency, reconstruction quality, and safety-critical information preservation. The optimizer 2521 may use reinforcement learning techniques where each vehicle acts as an agent contributing to the overall optimization objective. For example, if Vehicle A 2502 detects a pedestrian partially occluded by a parked vehicle, the optimizer 2521 may determine that Vehicle B 2503, positioned 50 meters ahead with a clearer view, should prioritize high-quality encoding of the pedestrian region even at the cost of reduced compression efficiency for background elements.

Dynamic resource allocator 2522 can be configured as a component that manages computational resources across the vehicle network based on real-time processing demands, vehicle capabilities, and safety priorities. The allocator 2522 monitors CPU utilization, GPU memory usage, network bandwidth availability, and processing latency for each vehicle in the network. During high-demand scenarios, such as dense urban traffic or emergency situations, the allocator 2522 may dynamically redistribute processing tasks, reduce compression quality for non-critical regions, or temporarily increase latency tolerance for background processing tasks to ensure that safety-critical processing maintains real-time performance.

For instance, if Vehicle A 2502 experiences high computational load due to processing multiple pedestrian detections simultaneously, the resource allocator 2522 may temporarily redirect some background processing tasks to Vehicle B 2503 while ensuring that Vehicle A 2502 maintains maximum processing capacity for the safety-critical pedestrian tracking tasks. The allocator 2522 may also implement predictive resource allocation, using machine learning models to anticipate processing demands based on traffic patterns, time of day, and historical usage data.

The optimization layer 2520 outputs optimized processing parameters to a compression layer 2530 comprising an adaptive encoder 2531 and an error resilience subsystem 2532, according to an embodiment. Adaptive encoder 2531 extends encoding capabilities described herein to implement priority-based compression where different regions of the sensor data receive different levels of compression based on their safety criticality. Regions containing CRITICAL priority objects (pedestrians, cyclists) may be encoded using lossless compression or very low compression ratios (such as 2:1) to preserve maximum detail for safety-critical decision making. Regions containing HIGH priority objects (e.g., vehicles) may be encoded using moderate compression ratios (such as 4:1) that balance data reduction with preservation of essential features for collision avoidance. Regions containing MEDIUM priority objects may be encoded using standard compression ratios (such as 8:1), while LOW priority background regions may be encoded using aggressive compression ratios (such as 16:1 or higher).

According to an aspect, error resilience subsystem 2532 applies one or more error resilience techniques, including, but not limited to, forward error correction coding, data partitioning based on importance, and error concealment hints. In the autonomous vehicle application, the error resilience parameters can be dynamically adjusted based on the safety criticality of the data being protected. For example, CRITICAL priority data may be protected using Reed-Solomon error correction codes with a rate of 0.5 (50% redundancy), providing robust protection against transmission errors. HIGH priority data may use error correction with a rate of 0.7 (30% redundancy), while MEDIUM and LOW priority data may use progressively less redundant error correction (rates of 0.8 and 0.9, respectively). These error resilience parameters are merely exemplary and do not represent the full scope of values which may be used in various embodiments.

According to an implementation of an embodiment, the compressed and error-protected data is transmitted through a V2X communication layer 2540 that represents an integration with vehicle-to-everything communication protocols. The V2X communication layer 2540 supports multiple communication modes including Vehicle-to-Vehicle (V2V) communication using Dedicated Short-Range Communication (DSRC) protocols operating at 5.9 GHz or Cellular-V2X (C-V2X) protocols operating over 4G/5G cellular networks. The communication layer 2540 also supports Vehicle-to-Infrastructure (V2I) communication for interaction with traffic management systems, Vehicle-to-Pedestrian (V2P) communication for enhanced pedestrian safety, and Vehicle-to-Network (V2N) communication for cloud-based processing and analytics.

According to an aspect, V2X communication layer 2540 implements intelligent protocol selection based on latency requirements, bandwidth availability, and communication range needs. For immediate safety-critical alerts (such as collision warnings), the system may prioritize V2V communication using DSRC for its low latency characteristics (typically under 10 milliseconds). For broader area coordination (such as traffic flow optimization), the system may use V2I communication over 5G networks. For cloud-based analytics and machine learning model updates, the system may use V2N communication with higher latency tolerance but greater bandwidth capacity.

The transmitted data can be received and processed by a reconstruction layer 2550 comprising a decoder subsystem 2551, a multi-vehicle AI deblocking network 2552, and a collaborative fusion engine 2553. Decoder subsystem 2551 applies various known decompression techniques and the techniques, and variants thereof, specifically described herein, including error correction and concealment based on the applied error resilience techniques. The decoder 2551 performs priority-based decompression where CRITICAL priority regions are decompressed first to minimize latency for safety-critical decision making.

According to an embodiment, multi-vehicle AI deblocking network 2552 leverages specifically configured AI deblocking capabilities, extending the N-channel transformer architecture to handle N-vehicle×M-sensor data streams. The network 2552 employs a cross-vehicle attention mechanism that enables each vehicle to benefit from the sensor data and processing capabilities of other vehicles in the network. The network 2552 may comprise environmental adaptation capabilities that adjust its processing based on the detected environmental conditions, such as applying specialized noise reduction for rain conditions or enhanced edge detection for fog conditions.

According to an aspect, multi-vehicle AI deblocking network 2552 implements a loss function that incorporates safety-critical objectives in addition to traditional reconstruction quality metrics. The loss function may be expressed as:

$${L}_{total} = {α}_{1} \times {L}_{pedestrian} + {α}_{2} \times {L}_{vehicle} + {α}_{3} \times {L}_{infrastructure} + {α}_{4} \times {L}_{background} ,$$

where the weighting coefficients (α₁, α₂, α₃, α₄) reflect the relative importance of different object classes for safety-critical decision making. During training, the network 2552 learns to prioritize reconstruction quality for safety-critical objects while accepting lower fidelity for background elements.

For example, consider a scenario where Vehicle A 2502 detects a child chasing a ball toward a street, but the child is partially occluded by a parked vehicle from Vehicle A's perspective. Vehicle B 2503, positioned at a different angle, has a clearer view of the child. Multi-vehicle AI deblocking network 2552 uses Vehicle B's high-quality sensor data to enhance Vehicle A's reconstruction of the child, enabling Vehicle A to make appropriate safety-critical decisions (such as emergency braking or collision avoidance maneuvers) even though its direct sensor view was occluded.

According to an aspect, collaborative fusion engine 2553 is a component that combines the enhanced sensor data from multiple vehicles to create a comprehensive environmental model that exceeds the capabilities of any individual vehicle's sensor suite. Fusion engine 2553 may employ probabilistic fusion techniques that account for sensor uncertainty, calibration differences between vehicles, and temporal synchronization challenges. In some implementations, engine 2553 maintains a dynamic occupancy grid that represents the probability of object presence at each location in the environment, updating this grid based on inputs from all vehicles in the network.

Fusion engine 2553 can also implement temporal tracking capabilities that maintain object identities across time frames and across multiple vehicle perspectives. For example, a pedestrian detected by Vehicle A 2502 at time t may move out of Vehicle A's sensor range but into Vehicle B's sensor range at time t+1. Fusion engine 2553 maintains the pedestrian's identity and trajectory prediction, enabling seamless tracking across the vehicle network.

The reconstruction layer 2550 outputs enhanced environmental perception data through an output layer 2560 comprising enhanced perception data 2561, safety alerts and warnings 2562, and navigation and control data 2563. Enhanced perception data 2561 provides each vehicle with a comprehensive understanding of its environment that combines its own sensor data with the sensor data and processing capabilities of other vehicles in the network. This enhanced perception enables detection of objects and hazards that would be invisible to individual vehicles, such as pedestrians behind parked vehicles, vehicles in blind spots, or hazards around curves or over hills.

Safety alerts and warnings 2562 provide real-time notifications of safety-critical situations detected by the collaborative sensor network. These alerts may include collision warnings, pedestrian alerts, emergency vehicle notifications, and hazardous road condition warnings. The alerts 2562 can be prioritized based on immediacy and severity, with the most critical alerts (such as imminent collision risks) receiving immediate processing and transmission with minimal latency. For example, if system 2500 detects a pedestrian about to enter a crosswalk while a vehicle is approaching at high speed, it may simultaneously alert the approaching vehicle to brake and alert the pedestrian (through V2P communication to their smartphone) to delay crossing.

Navigation and control data 2563 provides enhanced information for autonomous vehicle path planning and control systems. This data may comprise, but is not limited to, optimized route recommendations that account for real-time traffic conditions, weather impacts, and infrastructure status as detected by the collaborative sensor network. The navigation data 2563 may also include predictive information about likely future scenarios, such as anticipated pedestrian movements or expected traffic pattern changes, enabling proactive rather than reactive autonomous vehicle control.

System 2500 implements a feedback control loop 2570 that continuously monitors the performance of the collaborative sensor fusion system and adjusts processing parameters to optimize safety, efficiency, and resource utilization. The feedback loop 2570 monitors key performance indicators such as object detection accuracy, false alarm rates, processing latency, network bandwidth utilization, and reconstruction quality. Based on these metrics, the feedback loop 2570 may adjust compression ratios, modify error correction parameters, redistribute processing tasks among vehicles, or update machine learning model parameters.

For example, if the feedback loop 2570 detects that pedestrian detection accuracy is degrading due to heavy rain conditions, it may automatically increase the allocation of processing resources to pedestrian detection algorithms, reduce compression ratios for pedestrian-containing regions, or adjust environmental adaptation parameters to improve sensor performance in rain conditions.

In a practical deployment scenario, system 2500 may be implemented in a mixed-traffic environment where autonomous vehicles equipped with the collaborative sensor fusion system operate alongside conventional human-driven vehicles. The autonomous vehicles would form a collaborative sensing network, sharing compressed sensor data to enhance each vehicle's perception capabilities while maintaining compatibility with existing V2X infrastructure and communication protocols. System 2500 can provide particular benefits in challenging scenarios such as urban intersections with limited visibility, highway merging situations with heavy traffic, school zones with high pedestrian activity, and construction zones with dynamic obstacles and changing traffic patterns.

System 2500 represents a significant advancement in autonomous vehicle sensor fusion technology, extending the multimodal compression and neural upsampling process described herein to address the unique challenges of safety-critical automotive applications. By enabling vehicles to collaborate and share sensor information efficiently, system 2500 can enhance the safety, reliability, and effectiveness of autonomous vehicle deployments while maintaining the data compression and transmission efficiency benefits of the original patent invention.

System 2500 implements a distributed hybrid processing architecture that optimally allocates computational tasks across multiple computing environments to balance safety-critical performance requirements with collaborative enhancement capabilities. According to an embodiment, safety-critical components including the modal-specific preprocessor 2511, safety-critical region detector 2512, environmental adapter 2513, and adaptive encoder 2531 operate as edge computing processes directly on each vehicle's onboard computer systems to ensure rapid (e.g., sub-10 millisecond) response times for life-critical decisions such as emergency braking or collision avoidance. These edge processing components maintain full autonomous operation capability even in the absence of network connectivity, ensuring that each vehicle can perform essential safety functions independently. The onboard computer systems may comprise high-performance automotive-grade processors such as, for example, NVIDIA Drive AGX or Intel Mobileye EyeQ series chips, equipped with specialized AI acceleration hardware including GPUs and dedicated neural processing units optimized for real-time sensor fusion and object detection tasks.

Distributed angle optimizer 2521, V2X communication layer 2540, multi-vehicle AI deblocking network 2552, and collaborative fusion engine 2553 can be configured to operate as distributed network computing processes that leverage vehicle-to-vehicle communication to share computational load and enhance perception capabilities across the connected vehicle fleet. These distributed components employ federated learning techniques where each vehicle contributes processing power and sensor data to improve the overall network performance while maintaining data privacy and minimizing bandwidth requirements. For example, when Vehicle A 2502 detects a computationally demanding scenario such as multiple pedestrians in a complex intersection, the distributed processing architecture may automatically redistribute non-critical background processing tasks to Vehicle B 2503 and Vehicle C 2504, allowing Vehicle A 2502 to maintain maximum processing capacity for safety-critical pedestrian tracking and trajectory prediction.

In some embodiments, dynamic resource allocator 2522 and long-term system optimization functions operate as cloud-based computing processes that leverage the scalability and computational power of remote data centers to perform fleet-wide analytics, machine learning model training, and traffic pattern optimization. The cloud infrastructure provides continuous updates to the AI models deployed on individual vehicles, analyzes aggregated performance data to identify system improvements, and coordinates with smart city infrastructure to optimize traffic flow and reduce congestion. The cloud components communicate with vehicle systems through the V2N communication protocols, providing services such as real-time traffic updates, weather condition forecasts, construction zone notifications, and over-the-air software updates that enhance system performance without requiring physical vehicle servicing.

This hybrid architecture implements intelligent task allocation where processing assignments are dynamically determined based on latency requirements, safety criticality, computational complexity, and network availability. Safety-critical tasks with latency requirements under 10 milliseconds are always processed locally on vehicle edge systems, while collaborative enhancement tasks with latency tolerance up to 100 milliseconds may be distributed across the vehicle network, and analytical tasks with latency tolerance exceeding 100 milliseconds may be processed in cloud infrastructure. System 2500 includes graceful degradation capabilities where vehicles maintain full autonomous operation capability when operating independently, gain enhanced perception and efficiency when connected to other vehicles in the collaborative network, and achieve optimal performance when connected to both the vehicle network and cloud infrastructure simultaneously.

It should be appreciated that the specific values, parameters, and technical specifications described herein with reference to FIG. 25 and autonomous vehicle sensor fusion system 2500, including but not limited to sensor resolutions (such as 64-beam LiDAR, 8-megapixel cameras), communication frequencies (such as 77 GHz radar, 5.9 GHz DSRC), latency requirements (such as sub-10 millisecond response times), compression ratios (such as 2:1, 4:1, 8:1, 16:1), error correction rates (such as Reed-Solomon rates of 0.5, 0.7, 0.8, 0.9), detection ranges (such as 200 meters for pedestrians, 500 meters for vehicles), processing specifications (such as NVIDIA Drive AGX, Intel Mobileye EyeQ series), and performance metrics (such as 40-60% bandwidth reduction) are provided merely as exemplary embodiments to illustrate the operation and advantages of the present invention. These values are not intended to, and do not, limit the scope of the invention in any way. The invention encompasses systems operating with different sensor specifications, alternative communication protocols, varying latency requirements, different compression parameters, alternative error correction schemes, modified detection ranges, other processing hardware configurations, and different performance characteristics, all of which fall within the scope of the claims and the spirit of the invention. One skilled in the art will recognize that the specific numerical values and technical parameters may be adjusted, modified, or optimized based on particular implementation requirements, available technology, regulatory constraints, cost considerations, or performance objectives without departing from the fundamental principles and novel aspects of the collaborative autonomous vehicle sensor fusion system described herein.

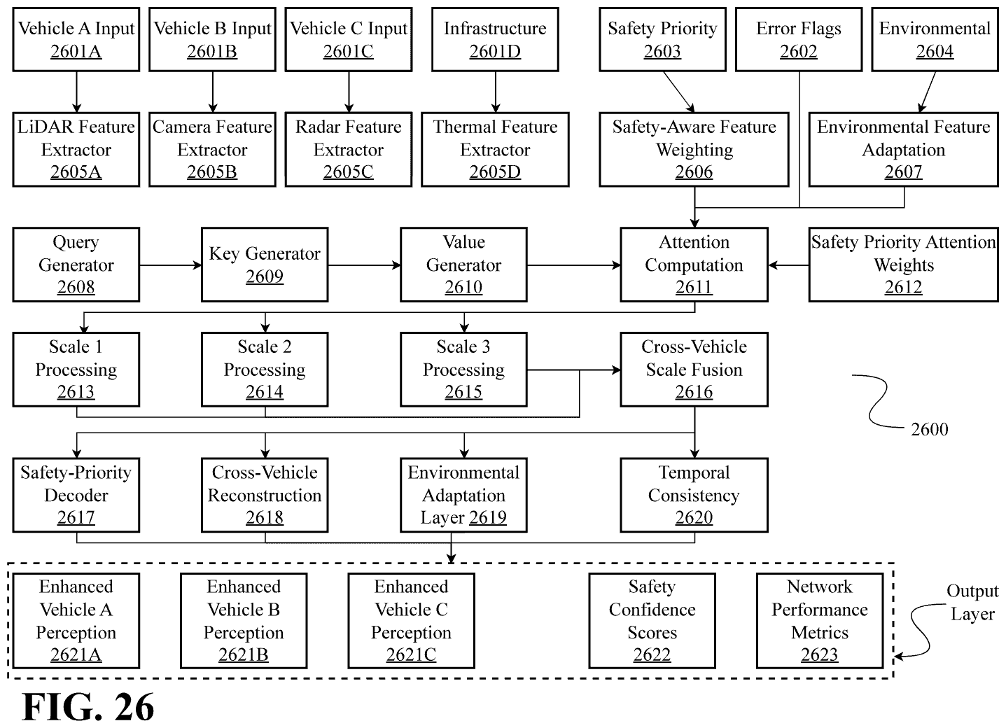

FIG. 26 is a block diagram illustrating an exemplary architecture for the enhanced multi-vehicle AI deblocking network 2600, according to an embodiment. Enhanced multi-vehicle AI deblocking network 2600 represents a significant extension of the N-channel transformer architecture, specifically adapted to process N-vehicle×M-sensor data streams while incorporating safety-critical prioritization and cross-vehicle collaborative enhancement capabilities that are essential for autonomous vehicle applications.

According to the embodiment, enhanced multi-vehicle AI deblocking network 2600 receives input from multiple synchronized data streams including Vehicle A input 2601A, Vehicle B input 2601B, Vehicle C input 2601C, and infrastructure input 2601D, each comprising compressed and potentially corrupted sensor data that has been transmitted through V2X communication layer 2540. Vehicle A input 2601A may comprise LiDAR point cloud data and camera image data that has been processed through the adaptive encoder 2531 and transmitted via V2V communication protocols. Vehicle B input 2601B may comprise radar detection data and camera image data from a second vehicle in the collaborative sensing network. Vehicle C input 2601C may comprise thermal imaging data and ultrasonic sensor data from a third vehicle, such as a commercial truck or bus equipped with specialized sensor arrays for comprehensive surround monitoring. Infrastructure input 2601D may comprise roadside unit sensor data, intersection monitoring camera feeds, and traffic signal state information transmitted via V2I communication protocols.

Enhanced multi-vehicle AI deblocking network 2600 also receives error flags 2602 that indicate regions of the input data streams that have been affected by transmission errors, network congestion, or communication failures during V2X data exchange. Error flags 2602 may be generated by the error resilience subsystem 2532 and provide spatial and temporal annotations indicating the reliability and quality of different portions of the received sensor data. For example, if Vehicle B's radar data experiences intermittent communication dropouts due to network congestion, error flags 2602 may identify the specific time intervals and spatial regions where the radar data is unreliable or missing, enabling enhanced multi-vehicle AI deblocking network 2600 to compensate using data from other vehicles or temporal interpolation techniques.

Safety priority information 2603 provides critical input that identifies regions of the sensor data containing safety-critical objects such as pedestrians, cyclists, emergency vehicles, school buses, and construction workers that require maximum reconstruction quality and minimal processing latency. Safety priority information 2603 can be generated by safety-critical region detector 2512 and may comprise spatial coordinates, object classifications, priority levels (e.g., CRITICAL, HIGH, MEDIUM, LOW), and trajectory predictions for detected objects. For instance, if a child is detected running toward a street, safety priority information 2603 can mark the child's location and predicted trajectory as CRITICAL priority, ensuring enhanced multi-vehicle AI deblocking network 2600 allocates maximum computational resources and reconstruction quality to accurately tracking and enhancing the child's image data across all available vehicle sensor streams.

According to an aspect, environmental context information 2604 can provide, but is not limited to, real-time weather, lighting, and road condition data that enables enhanced multi-vehicle AI deblocking network 2600 to adapt its processing algorithms based on environmental factors that affect sensor performance and data quality. Environmental context 2604 may comprise precipitation levels, visibility conditions, ambient lighting, road surface conditions, atmospheric interference factors, and/or the like. During heavy rain conditions, environmental context 2604 can trigger specialized algorithms for water droplet removal from camera data, enhanced temporal filtering for LiDAR data affected by rain scatter, and increased weighting of radar data which is less affected by precipitation.

The input data streams are processed through modal-specific feature extraction components including a LiDAR feature extractor 2605A, a camera feature extractor 2605B, a radar feature extractor 2605C, and a thermal feature extractor 2605D. These extractors build upon the feature extraction capabilities described herein while incorporating enhancements specific to autonomous vehicle sensor fusion requirements. LiDAR feature extractor 2605A may implement advanced point cloud processing techniques including ground plane removal, object clustering, surface normal estimation, and intensity-based material classification. Camera feature extractor 2605B may employ convolutional neural network architectures optimized for automotive object detection, including specialized layers for pedestrian detection, vehicle classification, and traffic sign recognition. Radar feature extractor 2605C can processes range-Doppler-angle data to extract moving object signatures, stationary obstacle classifications, and velocity estimations. Thermal feature extractor 2605D can implement temperature-based object segmentation, heat signature analysis, and thermal contrast enhancement techniques particularly effective for pedestrian detection in low-visibility conditions.

The extracted features are processed by a safety-aware feature weighting component 2606, which can be configured to dynamically adjust the importance and processing priority of different features based on their safety criticality. Safety-aware feature weighting component 2606 applies multiplicative scaling factors to extracted features, with features associated with CRITICAL priority objects receiving weight multipliers of 1.0 (maximum priority), HIGH priority objects receiving weight multipliers of 0.7, MEDIUM priority objects receiving weight multipliers of 0.4, and LOW priority background elements receiving weight multipliers of 0.1. This weighting ensures that computational resources and reconstruction quality are preferentially allocated to safety-critical elements of the sensor data. These weighting values are merely exemplary.

An environmental feature adaptation component 2607 modifies feature extraction and processing parameters based on the environmental context information 2604. For example, during fog conditions, environmental feature adaptation component 2607 may increase the weighting of LiDAR and radar features while reducing the weighting of camera features that are degraded by atmospheric scattering. During night conditions, environmental feature adaptation component 2607 may prioritize thermal and infrared camera features while applying specialized noise reduction algorithms to standard camera data. During rain conditions, environmental feature adaptation component 2607 may implement water droplet detection and removal algorithms for camera features while applying temporal averaging to reduce noise in LiDAR features caused by rain scatter.

The weighted and adapted features flow into a cross-vehicle attention mechanism comprising a query generator 2608, a key generator 2609, a value generator 2610, an attention computation 2611, and a safety priority attention weights component 2612. This attention mechanism enables each vehicle to leverage sensor data and processing results from other vehicles in the collaborative network to enhance its own perception capabilities. Query generator 2608 processes the features from each individual vehicle to generate query vectors Q=W_{q}×Features that represent what information each vehicle is seeking to enhance its perception. For example, if Vehicle A has a partially occluded view of a pedestrian, its query vectors would indicate the need for enhanced pedestrian detection information in the occluded region.

Key generator 2609 processes features from all vehicles in the network to generate key vectors K=Wₖ×Features that represent what information each vehicle can provide to assist other vehicles. Continuing the previous example, if Vehicle B has a clear view of the pedestrian that is occluded from Vehicle A's perspective, Vehicle B's key vectors would indicate its ability to provide high-quality pedestrian detection information for that spatial region. Value generator 2610 processes the enhanced data streams to generate value vectors V=Wᵥ×Features that contain the actual enhanced information that can be shared between vehicles.

Attention computation 2611 implements the core cross-vehicle attention mechanism using the formula Attention (Q,K,V)=Softmax (QK\hat{ }T/√dₖ)V, where the attention weights determine how much each vehicle should rely on information from other vehicles to enhance its own perception. This computation is enhanced with safety weighting that prioritizes attention between vehicles for safety-critical objects and regions. Safety priority attention weights component 2612 modifies the standard attention computation to ensure that safety-critical information receives maximum attention priority; for example, with critical objects receiving attention weight multiplier α_{critical}=1.0, high priority objects receiving α_{high}=0.7, medium priority objects receiving α_{medium}=0.4, and low priority background elements receiving α_{low}=0.1.

The attention mechanism outputs can be processed through a multi-scale processing pipeline comprising a Scale 1 processing component 2613, a Scale 2 processing component 2614, a Scale 3 processing component 2615, and a cross-vehicle scale fusion component 2616. Scale 1 processing component 2613 operates at full resolution to extract detailed features necessary for precise object localization and fine-grained detection tasks such as pedestrian limb tracking and facial recognition. Scale 2 processing component 2614 operates at half resolution to extract contextual features that provide understanding of object relationships and scene structure. Scale 3 processing component 2615 operates at quarter resolution to extract global features that provide overall scene understanding and long-range context. Cross-vehicle scale fusion component 2616 combines multi-scale information across vehicles, enabling each vehicle to benefit from the detailed, contextual, and global features extracted by other vehicles in the network.

The multi-scale processing outputs feed into an enhanced reconstruction layer comprising a safety-priority decoder 2617, a cross-vehicle reconstruction component 2618, an environmental adaptation layer 2619, and a temporal consistency component 2620. Safety-priority decoder 2617 implements a decoding strategy that prioritizes reconstruction of safety-critical regions, ensuring that pedestrians, cyclists, and other vulnerable road users are reconstructed with maximum quality and minimal latency. In some aspects, safety-priority decoder 2617 employs a hierarchical processing approach where CRITICAL priority regions are processed first using full network capacity, followed by HIGH priority regions using reduced capacity, and finally MEDIUM and LOW priority regions using remaining computational resources.

Cross-vehicle reconstruction component 2618 enables collaborative enhancement where each vehicle's reconstruction quality is improved using sensor data and processing results from other vehicles in the network. For example, if Vehicle A has a degraded view of a traffic sign due to sun glare, cross-vehicle reconstruction component 2618 can use Vehicle B's clear view of the same traffic sign to enhance Vehicle A's reconstruction quality. This collaborative reconstruction is particularly valuable for handling occlusions, sensor limitations, and environmental degradations that affect individual vehicles.

Environmental adaptation layer 2619 applies weather-specific and lighting-specific reconstruction algorithms based on the environmental context information 2604. During rain conditions, environmental adaptation layer 2619 may apply specialized algorithms for water droplet artifact removal, contrast enhancement for reduced visibility, and temporal noise reduction for rain-affected sensor data. During fog conditions, environmental adaptation layer 2619 may implement atmospheric scattering compensation, depth-aware enhancement based on LiDAR data, and multi-spectral fusion techniques that combine visible and infrared imagery for improved penetration through atmospheric obscuration.

Temporal consistency component 2620 ensures frame-to-frame coherence in the reconstructed output, preventing flickering artifacts and maintaining smooth object trajectories across time sequences. This component is particularly important for autonomous vehicle applications where temporal consistency is critical for accurate object tracking and trajectory prediction. According to an aspect, temporal consistency component 2620 may implement temporal attention mechanisms that consider previous frames when reconstructing current frames, applies motion compensation to account for vehicle and object movement, and employs temporal smoothing algorithms that preserve important transient events (such as pedestrian sudden movements) while suppressing reconstruction noise.

The reconstruction layer outputs enhanced perception data for each vehicle in the network, including enhanced Vehicle A perception 2621A, enhanced Vehicle B perception 2621B, and enhanced Vehicle C perception 2621C. Each vehicle receives perception data that combines its own sensor capabilities with the collaborative enhancement provided by other vehicles in the network, resulting in perception quality that significantly exceeds what any individual vehicle could achieve independently. For instance, Vehicle A 2621A may receive enhanced perception data that includes objects detected by Vehicle B and Vehicle C that were outside Vehicle A's sensor range, enabling comprehensive 360-degree awareness that extends well beyond the physical limitations of Vehicle A's sensor suite.

The system also outputs safety confidence scores 2622 that provide quantitative measures of the reliability and accuracy of safety-critical object detections and reconstructions. These confidence scores are computed based on multi-vehicle consensus, sensor data quality metrics, environmental conditions, and reconstruction quality assessments. High confidence scores (approaching 1.0) indicate that multiple vehicles have consistent detections of safety-critical objects under good environmental conditions with high-quality sensor data. Low confidence scores (approaching 0.0) indicate potential false positives, sensor degradation, adverse environmental conditions, or conflicting detections between vehicles that require additional verification or conservative safety responses.

Network performance metrics 2623 provide real-time monitoring of the collaborative sensing network's operational status, including, but not limited to, processing latency, bandwidth utilization, reconstruction quality metrics, object detection accuracy, and inter-vehicle synchronization status. These metrics enable dynamic optimization of network parameters, early detection of performance degradation, and adaptive resource allocation to maintain optimal system performance under varying operational conditions.

Enhanced multi-vehicle AI deblocking network 2600 processes N-vehicle×M-sensor channels with safety-critical prioritization and environmental adaptation. Enhanced multi-vehicle AI deblocking network 2600 enables collaborative enhancement where each vehicle's perception capabilities are augmented by leveraging the sensor data and processing power of other vehicles in the network, resulting in detection capabilities that significantly exceed the sum of individual vehicle capabilities. For example, while a single vehicle might detect pedestrians at ranges up to 50 meters under optimal conditions, the collaborative network can extend effective pedestrian detection ranges to 200 meters or more by leveraging multiple vehicle perspectives and enhanced reconstruction algorithms.

The system provides graceful performance degradation where vehicles maintain basic autonomous operation capability when operating independently, achieve enhanced performance when connected to other vehicles in the collaborative network, and reach optimal performance when the full enhanced multi-vehicle AI deblocking network 2600 is operational with comprehensive environmental adaptation and safety prioritization. This architecture ensures that autonomous vehicles can operate safely across a wide range of deployment scenarios while providing maximum safety and efficiency benefits when collaborative sensing infrastructure is available.

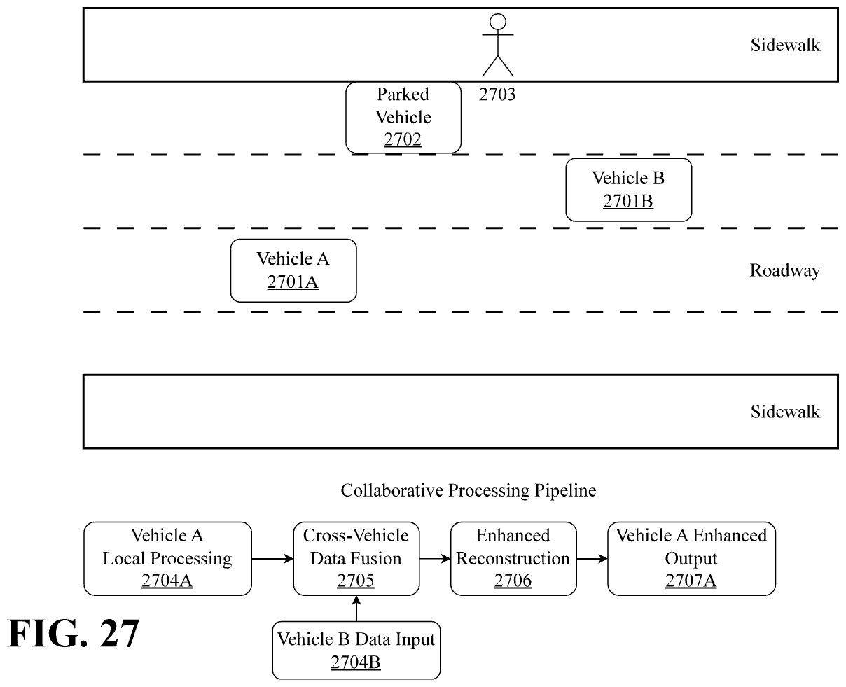

FIG. 27 is a top-down view diagram illustrating an exemplary scenario for cross-vehicle occlusion handling using the collaborative autonomous vehicle sensor fusion system 2500, according to an embodiment. This scenario demonstrates the fundamental capability of the enhanced multi-vehicle AI deblocking network 2600 to enable vehicles to detect and track safety-critical objects that are occluded from their direct sensor view by leveraging sensor data and processing capabilities from other vehicles in the collaborative sensing network.

According to the embodiment, the scenario comprises Vehicle A 2701A and Vehicle B 2701B operating in a typical urban environment where occlusion situations frequently occur due to parked vehicles, infrastructure elements, and other obstacles that can block direct line-of-sight between autonomous vehicles and safety-critical objects such as pedestrians. Vehicle A 2701A is positioned at a distance of approximately 75 meters from a pedestrian 2703, while Vehicle B 2701B is positioned at a distance of approximately 25 meters from the same pedestrian 2703. A parked vehicle 2702 is positioned between Vehicle A 2701A and pedestrian 2703, creating an occlusion scenario where Vehicle A's direct sensor view of the pedestrian is partially or completely blocked.

Vehicle A 2701A is equipped with a LiDAR sensor system and camera system that under normal circumstances would be capable of detecting pedestrians at distances up to 75 meters with high confidence. However, in this scenario, the parked vehicle 2702 creates a sensor shadow zone that prevents Vehicle A's sensors from obtaining a clear view of pedestrian 2703. Vehicle A's LiDAR and camera sensor beams are blocked by the parked vehicle 2702, resulting in a detection confidence level of only 15% for the pedestrian, which is below the safety threshold required for reliable pedestrian detection and tracking. Without the collaborative sensing capability provided by the autonomous vehicle sensor fusion system 2500, Vehicle A 2701A would be unable to reliably detect the presence of pedestrian 2703, potentially creating a safety hazard if the pedestrian were to enter the roadway.

Vehicle B 2701B is positioned with a clear line-of-sight to pedestrian 2703 and is equipped with similar LiDAR and camera sensor systems. Due to its advantageous position and unobstructed sensor view, Vehicle B 2701B achieves a pedestrian detection confidence level of 95%, which exceeds the safety threshold for reliable pedestrian detection and tracking. Vehicle B's sensor systems can accurately determine the pedestrian's position, velocity, trajectory, and behavioral characteristics, providing high-quality sensor data that can be shared with other vehicles in the collaborative sensing network through the V2X communication layer 2540.

The collaborative processing pipeline demonstrates how the autonomous vehicle sensor fusion system 2500 enables Vehicle A to overcome its occlusion limitation by leveraging Vehicle B's superior sensor view. Vehicle A local processing 2704A initially processes its own sensor data and determines that pedestrian detection confidence is insufficient for reliable safety-critical decision making. Simultaneously, Vehicle B local processing 2704B processes its sensor data and achieves high-confidence pedestrian detection with detailed object characteristics including position coordinates, velocity vector, and trajectory prediction.

A cross-vehicle data fusion component 2705 receives sensor data from both Vehicle A local processing 2704A and Vehicle B data input 2704B through the V2X communication layer 2540. Cross-vehicle data fusion component 2705 implements the distributed angle optimizer 2521 and collaborative fusion engine 2553 to optimally combine the sensor data from both vehicles while accounting for their different perspectives, sensor calibration differences, and temporal synchronization requirements. The fusion process applies the safety-critical region detector 2512 to identify the pedestrian as a CRITICAL priority object requiring maximum reconstruction quality and processing priority.

The fused sensor data is processed by an enhanced reconstruction component 2706 that implements the enhanced multi-vehicle AI deblocking network 2552 to generate high-quality pedestrian detection and tracking data for Vehicle A. Enhanced reconstruction component 2706 uses Vehicle B's clear-view sensor data to enhance Vehicle A's occluded sensor data, effectively enabling Vehicle A to “see through” the parked vehicle 2702 obstruction by leveraging Vehicle B's sensor perspective. The reconstruction process applies cross-vehicle attention mechanisms where Vehicle A's query vectors indicate the need for enhanced pedestrian detection information in the occluded region, while Vehicle B's key and value vectors provide the high-quality pedestrian data needed to satisfy Vehicle A's information requirements.

Vehicle A enhanced output 2707A receives the collaborative reconstruction results, achieving a fused detection confidence level of 92% for the pedestrian despite the direct occlusion of Vehicle A's sensors. This confidence level exceeds the safety threshold required for reliable pedestrian detection and enables Vehicle A to make appropriate safety-critical decisions such as reduced speed, increased alertness, or preparation for emergency braking if the pedestrian enters the roadway. The enhanced output includes not only the pedestrian detection with high confidence but also detailed trajectory prediction, velocity estimation, and behavioral analysis that would not have been possible using Vehicle A's sensors alone.

The processing latency for this collaborative occlusion handling scenario is maintained below 50 milliseconds, which satisfies the real-time requirements for safety-critical autonomous vehicle decision making. This low latency is achieved through the dynamic resource allocator 2522 that prioritizes safety-critical processing tasks and the adaptive encoder 2531 that applies priority-based compression to ensure that pedestrian-related data receives maximum quality encoding with minimal compression artifacts.

The cross-vehicle occlusion handling capability demonstrates several key advantages of the autonomous vehicle sensor fusion system 2500 over traditional single-vehicle sensor systems. First, the collaborative sensing network extends the effective detection range and coverage area beyond the physical limitations of any individual vehicle's sensor suite. Second, the system provides robust performance in challenging scenarios where occlusions, sensor limitations, or environmental conditions may degrade individual vehicle performance. Third, the system maintains high safety standards by ensuring that safety-critical objects like pedestrians are detected and tracked with high confidence even when direct sensor views are compromised.

The scenario also illustrates the importance of the V2X communication layer 2540 in enabling real-time data sharing between vehicles with sufficient bandwidth and low latency to support collaborative sensing applications. The V2V communication protocols facilitate the exchange of compressed sensor data between Vehicle A 2701A and Vehicle B 2701B, while the error resilience subsystem 2532 ensures that the shared data maintains integrity despite potential communication errors or network congestion.

Furthermore, the scenario demonstrates the effectiveness of the safety-critical region detector 2512 in identifying pedestrians as CRITICAL priority objects that require maximum processing attention and reconstruction quality. The safety prioritization ensures that even in complex scenarios with multiple detected objects, the system preferentially allocates computational resources to safety-critical pedestrian detection and tracking tasks.

The collaborative approach also provides scalability benefits where the addition of more vehicles to the sensing network further improves overall detection coverage and redundancy. For example, if a third vehicle were present with a different viewing angle of the same intersection, it could provide additional confirmation of the pedestrian detection or contribute sensor data for detecting other safety-critical objects that might be occluded from both Vehicle A and Vehicle B perspectives.

It should be appreciated that while this example focuses on pedestrian detection, the same collaborative occlusion handling principles apply to other safety-critical objects including cyclists, motorcyclists, emergency vehicles, construction workers, and wildlife that may pose safety hazards in autonomous vehicle operating environments. The autonomous vehicle sensor fusion system 2500 provides a comprehensive solution for enhancing detection and tracking of all safety-critical objects through collaborative sensing, regardless of individual vehicle sensor limitations or environmental occlusion factors.

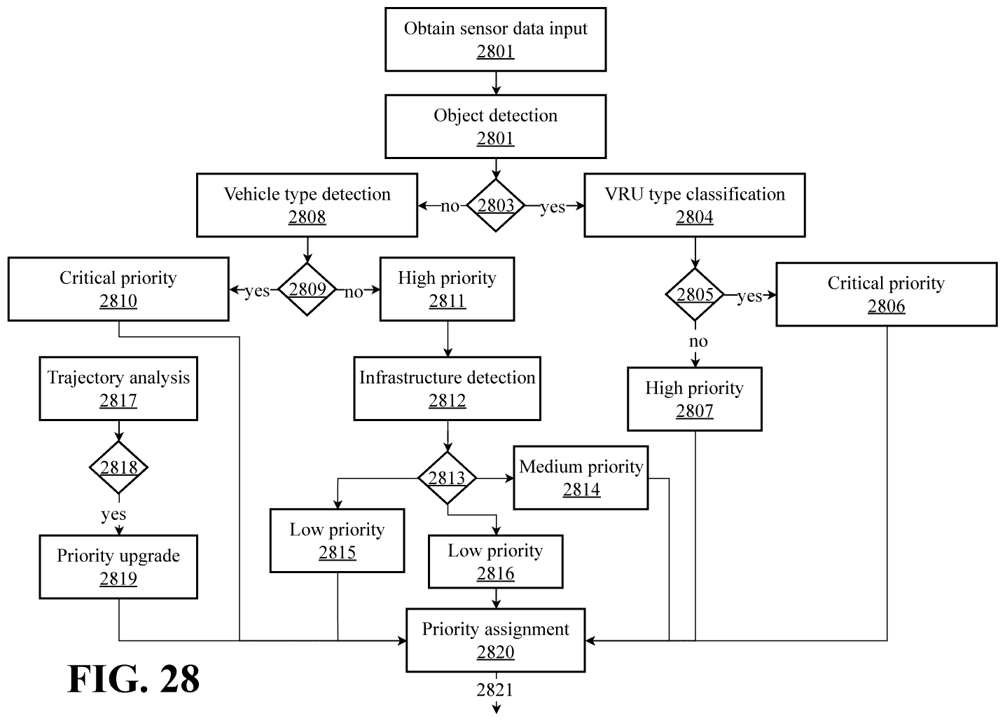

FIG. 28 is a flow diagram illustrating an exemplary method for safety-critical region detection and priority assignment, according to an embodiment. This flowchart demonstrates decision logic and processing steps that enable the autonomous vehicle sensor fusion system 2500 to dynamically classify detected objects based on their safety criticality and assign appropriate processing priorities, compression parameters, and error correction levels to ensure that safety-critical objects receive maximum attention and reconstruction quality.

According to the embodiment, the safety-critical region detection and priority assignment process begins with receiving, retrieving, or otherwise obtaining a plurality of sensor data input at step 2801 comprising multi-vehicle sensor streams received from the multi-vehicle input layer 2501. Sensor data input may comprise synchronized data streams from Vehicle A input 2601A, Vehicle B input 2601B, Vehicle C input 2601C, infrastructure input 2601D, and environmental context information 2604. The multi-vehicle sensor streams provide comprehensive coverage of the vehicle's operating environment and enable detection of objects that may be missed by individual vehicle sensor systems due to occlusions, sensor limitations, or environmental conditions.

The sensor data flows to an object detection component at step 2802 that implements deep learning recognition algorithms to identify and classify objects within the sensor data streams. Object detection component 2802 employs state-of-the-art convolutional neural network architectures such as YOLO (You Only Look Once), R-CNN (Region-based Convolutional Neural Network), or Transformer-based detection models that have been specifically trained on automotive safety scenarios. The detection algorithms analyze the multi-modal sensor data including, but not limited to, LiDAR point clouds, camera images, radar signatures, and thermal imagery to identify objects such as pedestrians, cyclists, vehicles, traffic signs, road barriers, and background elements. Object detection component 2802 also extracts object characteristics including position coordinates, velocity vectors, object dimensions, and confidence scores that are used in subsequent priority classification steps.

The detected objects are processed through a primary classification decision point 2803 that determines whether each detected object represents a vulnerable road user (VRU). This decision represents a fundamental safety classification that prioritizes human safety above all other considerations in autonomous vehicle operation. Vulnerable road users include pedestrians, cyclists, motorcyclists, wheelchair users, and other road users who are not protected by vehicle safety systems and who face the highest risk of injury or fatality in collision scenarios. The VRU classification decision 2803 analyzes object characteristics including size, shape, movement patterns, thermal signatures, and contextual information to distinguish vulnerable road users from vehicles and infrastructure elements.

If the detected object is classified as a vulnerable road user (YES path), the process flows to a VRU type classification component at step 2804 that performs more detailed analysis to determine the specific type of vulnerable road user. VRU type classification component applies specialized recognition algorithms that can distinguish between different types of vulnerable road users based on their unique characteristics. For example, pedestrians may be identified by their bipedal locomotion patterns, vertical posture, and thermal signatures, while cyclists may be identified by their association with bicycle-shaped objects, horizontal riding posture, and higher velocity characteristics compared to pedestrians.

The classified VRU objects proceed to a pedestrian or cyclist decision point 2805 that determines whether the detected vulnerable road user is a pedestrian or cyclist, representing the highest risk category for autonomous vehicle safety systems. Pedestrians and cyclists are assigned CRITICAL priority at step 2806 due to their extreme vulnerability in collision scenarios and the severe consequences of detection failures. CRITICAL priority designation triggers maximum processing attention, for example with Reed-Solomon error correction coding at rate 0.5, providing 50% redundancy to ensure robust protection against data corruption during transmission and processing. CRITICAL priority objects receive immediate processing with minimal latency, maximum reconstruction quality in the enhanced multi-vehicle AI deblocking network 2552, and preferential allocation of computational resources throughout the system.

Vulnerable road users that are not classified as pedestrians or cyclists (NO path from decision 2805) are typically motorcyclists and receive HIGH priority at step 2807 classification. Motorcyclists, while still representing vulnerable road users, typically have some protective equipment and higher visibility compared to pedestrians and cyclists, resulting in a slightly lower but still elevated priority classification. As an example, HIGH priority 2807 objects can receive Reed-Solomon error correction coding at rate 0.7, providing 30% redundancy for robust data protection while balancing processing efficiency with safety requirements.

Objects that are not classified as vulnerable road users (NO path from decision 2803) proceed to a vehicle type detection component 2808 that analyzes the detected objects to determine if they represent vehicles or other motorized transportation. Vehicle type detection component at step 2808 applies recognition algorithms specifically trained to identify different types of vehicles including passenger cars, trucks, buses, emergency vehicles, construction vehicles, and agricultural equipment. The detection algorithms analyze object characteristics such as size, shape, wheel patterns, lighting configurations, and movement characteristics to accurately classify vehicle types.

The classified vehicles proceed to an emergency vehicle decision point 2809 that determines whether the detected vehicle is an emergency vehicle such as police cars, fire trucks, ambulances, or other emergency response vehicles. Emergency vehicles receive CRITICAL priority classification at step 2810 equal to pedestrians and cyclists due to the critical nature of emergency response operations and the legal and safety requirements for autonomous vehicles to yield right-of-way to emergency vehicles. In some aspects, emergency vehicle CRITICAL priority may comprise Reed-Solomon error correction coding at rate 0.5 and maximum processing attention to ensure reliable detection of emergency vehicle lighting, sirens, and movement patterns.

Regular vehicles that are not emergency vehicles (NO path from decision 2809) receive HIGH priority classification at step 2811 with, for example, Reed-Solomon error correction coding at rate 0.7. Regular vehicle HIGH priority reflects the significant collision risks associated with vehicle-to-vehicle interactions and the need for reliable detection and tracking of other vehicles for collision avoidance, lane changing, merging, and other autonomous driving maneuvers.

Objects that are not classified as vulnerable road users or vehicles proceed to an infrastructure detection component at step 2812 that identifies traffic control devices, road infrastructure, and environmental elements. Infrastructure detection component analyzes object characteristics to identify traffic signals, stop signs, yield signs, speed limit signs, road barriers, construction equipment, bridge structures, and other infrastructure elements that affect autonomous vehicle navigation and safety decisions.

The classified infrastructure objects proceed to a traffic control device decision point 2813 that determines whether the detected infrastructure represents an active traffic control device that directly affects vehicle operation. Traffic control devices such as traffic signals, stop signs, yield signs, and regulatory signage receive MEDIUM priority classification at step 2814 with Reed-Solomon error correction coding at rate 0.8, for example. MEDIUM priority reflects the importance of traffic control devices for safe and legal autonomous vehicle operation while recognizing that infrastructure objects generally present lower immediate collision risks compared to moving objects like vehicles and vulnerable road users.

Infrastructure objects that are not traffic control devices (NO path from decision 2813) are classified as static infrastructure and receive LOW priority classification at step 2815 with Reed-Solomon error correction coding at rate 0.9. Static infrastructure LOW priority 2815 includes objects such as buildings, road barriers, utility poles, and permanent road features that provide contextual information for navigation but do not require immediate safety response.

Objects that do not fall into the vehicle or infrastructure categories are classified as background objects and receive LOW priority classification at step 2816 with Reed-Solomon error correction coding at rate 0.9, in some implementations. Background objects LOW priority 2816 includes elements such as vegetation, sky, distant terrain, and other environmental features that provide contextual information but do not directly affect immediate safety or navigation decisions.

A parallel processing path implements a trajectory analysis component at step 2817 that performs risk assessment for all detected objects regardless of their initial classification. Trajectory analysis component 2817 analyzes object movement patterns, velocity vectors, acceleration characteristics, and predicted future positions to assess collision risk and potential safety threats. The trajectory analysis considers factors such as object distance, relative velocity, predicted intersection points with the autonomous vehicle's path, and time-to-collision calculations.

The trajectory analysis results flow to a high collision risk decision point 2818 that determines whether any detected object presents an elevated collision risk regardless of its initial classification. Objects identified as high collision risk (YES path) receive a priority upgrade at step 2819 that elevates their priority classification to ensure enhanced processing attention. Priority upgrade can elevate objects from LOW or MEDIUM priority to HIGH or CRITICAL priority based on the assessed collision risk, ensuring that immediate safety threats receive appropriate processing attention even if their object classification would normally result in lower priority.

For example, a construction vehicle initially classified as MEDIUM priority infrastructure might receive a priority upgrade 2819 to HIGH or CRITICAL priority if trajectory analysis determines that it is moving into the autonomous vehicle's path with high collision probability. Similarly, a parked vehicle initially classified as LOW priority static object might receive priority upgrade 2819 if trajectory analysis detects that it is beginning to move or if a door is opening into the vehicle's path.

All priority classifications flow to a priority assignment component at step 2820 that implements resource allocation based on the determined priority levels. Priority assignment component coordinates with the dynamic resource allocator 2522 to allocate computational resources, bandwidth allocation, processing latency targets, and reconstruction quality parameters based on the assigned priorities. Providing some exemplary values, CRITICAL priority objects may receive maximum resource allocation with target processing latency under 10 milliseconds, HIGH priority objects may receive substantial resource allocation with target latency under 50 milliseconds, MEDIUM priority objects may receive standard resource allocation with target latency under 100 milliseconds, and LOW priority objects may receive minimal resource allocation with target latency under 200 milliseconds.

The prioritized output 2821 provides safety-critical processing directives that guide the enhanced multi-vehicle AI deblocking network 2552, adaptive encoder 2531, error resilience subsystem 2532, and other system components to allocate processing resources and reconstruction quality based on safety criticality. Prioritized output 2821 ensures that the autonomous vehicle sensor fusion system 2500 maintains focus on safety-critical objects while efficiently processing less critical information to optimize overall system performance.

The safety-critical region detection and priority assignment process may be configured with several advanced features that enhance its effectiveness in real-world autonomous vehicle scenarios. The system may include temporal consistency checking that maintains object priority classifications across multiple time frames to prevent priority fluctuations due to temporary detection uncertainties. The system can also implement confidence-weighted priority assignment where objects with higher detection confidence scores may receive elevated priority classifications to account for detection reliability.

Additionally, or alternatively, the system comprises environmental adaptation where priority classifications may be modified based on environmental conditions reported by environmental context information 2604. For example, during adverse weather conditions such as rain or fog, pedestrian detection confidence may be reduced, potentially triggering priority upgrades to compensate for increased detection uncertainty. The system also implements multi-vehicle consensus checking where priority classifications from multiple vehicles in the collaborative sensing network are compared to improve classification accuracy and reduce false positive priority assignments.

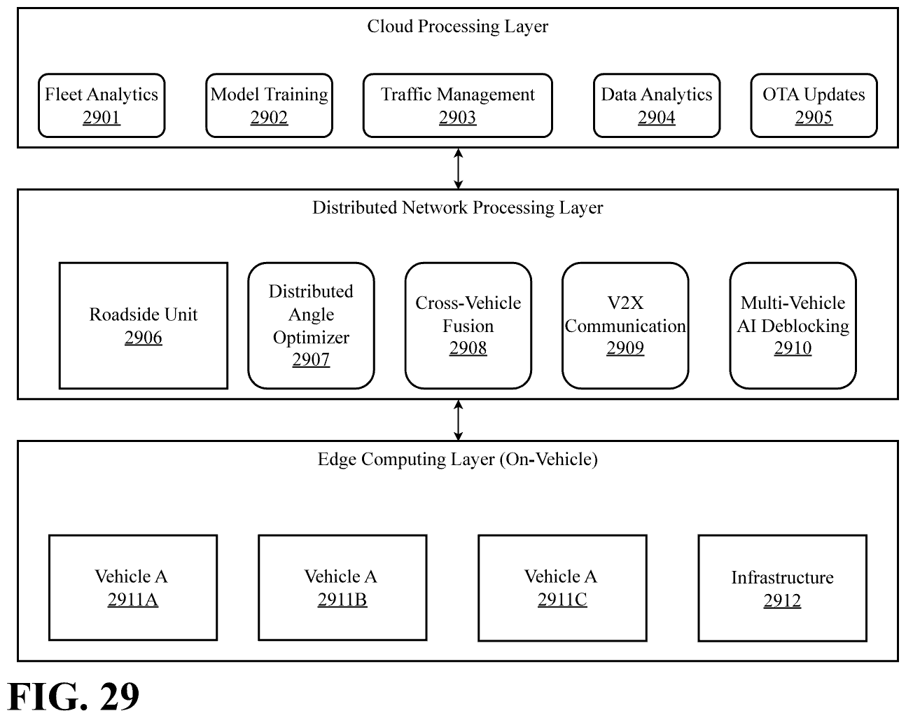

FIG. 29 is a block diagram illustrating an exemplary distributed processing architecture for the autonomous vehicle sensor fusion system 2500, according to an embodiment. This architecture demonstrates how the enhanced multi-vehicle AI deblocking network 2552 and associated processing components may be distributed across three distinct computing tiers: edge computing layer, distributed network processing layer, and cloud processing layer, each optimized for different latency requirements, computational capabilities, and safety-critical processing needs.

According to the embodiment, the distributed processing architecture implements a hierarchical computing model that balances real-time safety requirements with computational efficiency and resource optimization. The architecture ensures that safety-critical processing tasks are performed locally on vehicle edge computing systems with minimal latency, while collaborative enhancement and optimization tasks are distributed across the network, and long-term analytics and model training are performed in cloud infrastructure with access to vast computational resources and global data sets.

The edge computing layer operates with latency requirements (e.g., under 10 milliseconds) and is responsible for safety-critical processing and real-time decision making that directly affects autonomous vehicle operation. This layer comprises Vehicle A 2911A, Vehicle B 2911B, Vehicle C 2911C, and infrastructure nodes 2912 that perform local processing using onboard automotive-grade computing hardware. The edge computing layer ensures that each vehicle maintains autonomous operation capability even when network connectivity is limited or unavailable, providing fail-safe operation for safety-critical autonomous vehicle functions.

As an example, Vehicle A 2911A represents an autonomous sedan equipped with an NVIDIA Drive AGX Xavier processor that provides high-performance AI computing capability specifically designed for automotive applications. The Drive AGX Xavier processor includes dedicated GPU cores optimized for deep learning inference, ARM CPU cores for general processing tasks, and specialized accelerators for computer vision and sensor fusion applications. Vehicle A 2911A implements safety-critical processing components including safety-critical region detector 2512 and environmental adapter 2513 that operate with sub-5 millisecond latency to ensure immediate response to safety threats such as pedestrian detection or emergency vehicle identification.

Vehicle A 2911A also implements modal-specific preprocessor 2511 that performs real-time preprocessing of LiDAR, camera, radar, and thermal sensor data streams. The preprocessor 2511 applies sensor-specific calibration, noise reduction, distortion correction, and feature extraction optimized for the vehicle's specific sensor configuration. Additionally, Vehicle A 2911A implements adaptive encoder 2531 that performs priority-based compression of sensor data based on safety criticality assignments from safety-critical region detector 2512, ensuring that safety-critical objects receive maximum compression quality while background elements are compressed more aggressively to optimize bandwidth utilization.

As an example, Vehicle B 2911B represents an autonomous SUV equipped with an Intel Mobileye EyeQ5 processor that provides specialized computer vision processing capabilities optimized for automotive object detection and tracking applications. The EyeQ5 processor includes multiple programmable accelerators specifically designed for automotive vision algorithms, deep learning inference engines, and real-time image processing pipelines. Vehicle B 2911B implements environmental adaptation component 2513 and environmental feature adaptation component 2607 that modify processing parameters based on real-time weather, lighting, and road conditions detected by environmental sensor suite 2506.

Vehicle B 2911B also implements feature extraction components 2605 that extract modal-specific features from LiDAR, camera, radar, and thermal sensor data using algorithms optimized for the vehicle's sensor configuration and computational capabilities. Additionally, Vehicle B 2911B implements error resilience subsystem 2532 that applies forward error correction coding, data partitioning, and error concealment hints to ensure robust data transmission during V2V and V2I communication despite potential network interference or congestion.

As an example, Vehicle C 2911C represents a commercial truck equipped with a Qualcomm Snapdragon Ride processor that provides balanced CPU and AI processing capabilities suitable for commercial vehicle applications with extended operational requirements. The Snapdragon Ride processor includes Kryo CPU cores, Adreno GPU cores, and Hexagon AI accelerators that provide efficient processing for sensor fusion and decision-making algorithms. Vehicle C 2911C implements dynamic resource allocator 2522 that monitors computational load across the vehicle's processing systems and dynamically redistributes tasks to maintain optimal performance during varying operational demands.

Vehicle C 2911C also implements safety-priority decoder 2617 that prioritizes reconstruction of safety-critical regions during decompression operations, ensuring that pedestrians, cyclists, and emergency vehicles receive maximum reconstruction quality and minimal processing latency. Additionally, Vehicle C 2911C implements temporal consistency component 2620 that maintains frame-to-frame coherence in processed sensor data to prevent flickering artifacts and ensure smooth object tracking across time sequences.

Infrastructure node 2912 represents a smart city infrastructure deployment that may comprise edge server clusters, traffic control interfaces, V2I gateways 2540, and sensor fusion hubs. The infrastructure node 2912 provides stationary computing resources that complement the mobile vehicle computing capabilities and enable enhanced coverage of specific geographic regions such as complex intersections, construction zones, or high-traffic corridors. Infrastructure node 2912 implements roadside sensor arrays including traffic monitoring cameras, intersection LiDAR systems, and environmental monitoring equipment that provide additional sensor data to enhance the collaborative sensing network.

The distributed network processing layer operates with latency requirements between 10 and 100 milliseconds and is responsible for V2V/V2I communication and collaborative enhancement processing that leverages multiple vehicle perspectives to improve overall network performance. This layer may comprise roadside unit 2906, distributed angle optimizer 2907, cross-vehicle fusion component 2908, V2X communication component 2909, and multi-vehicle AI deblocking component 2910.

Roadside unit 2906 provides edge computing capabilities positioned along roadways and at intersections to facilitate vehicle-to-infrastructure communication and regional processing coordination. Roadside unit 2906 includes GPU clusters optimized for real-time AI processing and 5G base stations that provide high-bandwidth, low-latency communication between vehicles and infrastructure systems. The GPU clusters implement distributed processing algorithms that can supplement vehicle onboard computing during high-demand scenarios or provide enhanced processing capabilities for vehicles with limited computational resources.

Distributed angle optimizer 2907 extends the angle optimization capabilities described herein to operate across multiple vehicles in the collaborative sensing network. Distributed angle optimizer 2907 implements federated learning algorithms that enable vehicles to contribute to angle optimization model training without sharing raw sensor data, preserving privacy while improving optimization performance. According to an implementation, the optimizer 2907 operates with bandwidth requirements between 10 and 100 Mbps and communication ranges up to 1 kilometer, enabling coordination across extended vehicle platoons or urban traffic networks.

Cross-vehicle fusion component 2908 implements the collaborative sensing capabilities that enable vehicles to share processed sensor data and enhance each other's perception capabilities. Cross-vehicle fusion component 2908 coordinates the data sharing between vehicles, manages temporal synchronization across different vehicle sensor systems, and implements consensus algorithms that resolve conflicts between different vehicle perspectives of the same objects or scenarios.

V2X communication component 2909 manages the vehicle-to-everything communication protocols including, but not limited to, DSRC, C-V2X, and 5G communications that enable data sharing between vehicles, infrastructure, pedestrians, and network services. V2X communication component 2909 implements intelligent protocol selection that chooses the optimal communication method based on latency requirements, bandwidth availability, and communication range needs. For immediate safety-critical alerts, the component may prioritize DSRC for its sub-10 millisecond latency characteristics, while broader coordination tasks may use 5G networks with higher bandwidth capacity.

Multi-vehicle AI deblocking component 2910 implements the distributed processing aspects of enhanced multi-vehicle AI deblocking network 2552 that operate across the vehicle network rather than on individual vehicles. Multi-vehicle AI deblocking component 2910 coordinates the cross-vehicle attention mechanisms, manages the federated learning processes for model improvement, and implements the collaborative reconstruction algorithms that enable vehicles to enhance each other's sensor data quality through network cooperation.

The cloud processing layer operates with latency tolerance greater than 100 milliseconds and provides global analytics, model training, and long-term optimization services that benefit the entire autonomous vehicle ecosystem. This layer comprises fleet analytics 2901, model training 2902, traffic management 2903, data analytics 2904, and over-the-air (OTA) updates 2905.

Fleet analytics component 2901 performs global optimization analysis using aggregated data from multiple vehicle fleets to identify system-wide performance trends, optimize traffic flow patterns, and develop predictive models for traffic management and route optimization. Fleet analytics 2901 analyzes historical performance data, identifies patterns in vehicle behavior and traffic conditions, and generates recommendations for system-wide improvements that can be implemented through model updates or infrastructure modifications.

Model training component 2902 implements deep learning model training using vast datasets collected from the global vehicle network to continuously improve the performance of object detection, trajectory prediction, environmental adaptation, and collaborative sensing algorithms. Model training component 2902 uses cloud-scale computational resources including GPU clusters and tensor processing units to train sophisticated neural network models that would be impractical to train on individual vehicles or even regional infrastructure.

Traffic management component 2903 provides city-wide traffic control coordination that optimizes traffic signal timing, manages traffic flow during special events or emergencies, and coordinates with public transportation systems to improve overall transportation efficiency. Traffic management component 2903 integrates with municipal traffic control systems and provides real-time optimization recommendations based on current traffic conditions detected by the autonomous vehicle sensor fusion network.

Data analytics component 2904 implements pattern recognition and anomaly detection across the global vehicle network to identify emerging safety issues, optimize system parameters, and detect potential security threats or system malfunctions. Data analytics component 2904 processes massive datasets using machine learning algorithms to extract insights that inform system improvements and policy recommendations for autonomous vehicle deployment.

OTA updates component 2905 manages the distribution of model updates, software patches, and system improvements to vehicles and infrastructure components across the network. OTA updates component 2905 ensures that all network participants operate with compatible and up-to-date software versions while managing the rollout process to prevent disruptions to ongoing vehicle operations.

In various embodiments, the distributed processing architecture implements intelligent task allocation that dynamically assigns processing tasks based on latency requirements, computational complexity, safety criticality, and resource availability. Safety-critical tasks with latency requirements under 5 milliseconds, such as emergency braking decisions or collision avoidance maneuvers, are always processed on vehicle edge computing systems. Navigation and coordination tasks with latency tolerance up to 10 milliseconds may be processed locally or shared with nearby vehicles depending on computational load and network conditions.

Collaborative enhancement tasks with latency tolerance between 10 and 100 milliseconds can be processed in the distributed network processing layer, enabling vehicles to benefit from enhanced perception capabilities while maintaining acceptable response times for operational decisions. Long-term optimization and analysis tasks with latency tolerance greater than 100 milliseconds are processed in the cloud processing layer, providing access to vast computational resources and global datasets for system-wide improvements.

Performance metrics component monitors the operational performance of all three processing layers to ensure optimal task allocation and system performance. Performance metrics component tracks edge processing latency for safety-critical tasks (target: <5 ms), navigation tasks (target: <10 ms), and background tasks (target: <50 ms). For network processing, performance metrics component monitors V2V communication range (typical: 300 m), bandwidth utilization, and inter-vehicle synchronization accuracy.

The distributed processing architecture provides graceful performance degradation where vehicles maintain essential autonomous operation capabilities even when higher-level processing layers are unavailable. If network connectivity is lost, vehicles continue operating using edge computing layer capabilities. If cloud services are unavailable, vehicles and infrastructure continue operating using edge and network layer capabilities. This hierarchical degradation ensures that safety-critical functions are never compromised by network or infrastructure failures.

The architecture also implements dynamic load balancing where computational tasks can be redistributed based on real-time resource availability. For example, if Vehicle A experiences high computational load due to complex traffic scenarios, some background processing tasks may be temporarily redistributed to Vehicle B or nearby infrastructure resources. Similarly, if network bandwidth is limited, the system may prioritize safety-critical data transmission while deferring less critical data exchanges.

Communication between the three processing layers is optimized for different data types and priorities. Real-time sensor data flows from edge to network layers using high-frequency, low-latency protocols. Processed results and collaborative enhancements flow between network layer components using moderate-latency protocols optimized for reliability. Model updates and analytical results flow from cloud to edge layers using lower-frequency, high-bandwidth protocols that can tolerate higher latency.

The architecture is designed to scale efficiently as the autonomous vehicle network grows, with each additional vehicle contributing computational resources to the network layer while benefiting from the enhanced perception and optimization capabilities provided by the collaborative sensing network. Infrastructure deployments can be strategically positioned to provide additional computational resources in high-traffic areas or complex scenarios where enhanced processing capabilities are most beneficial.

Furthermore, the distributed processing architecture supports regulatory compliance and safety certification requirements by maintaining clear separation between safety-critical edge processing and enhancement-focused network processing. This separation ensures that safety-critical functions can be certified and validated independently while allowing for continuous improvement and optimization of collaborative enhancement capabilities through network and cloud processing layers.

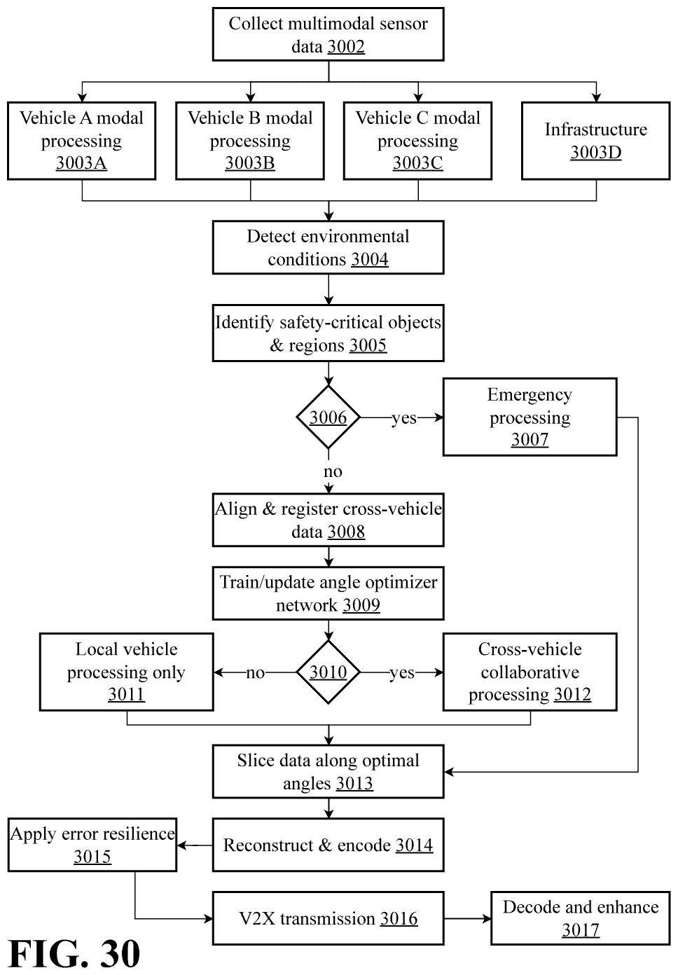

FIG. 30 is a flow diagram illustrating an exemplary method for autonomous vehicle sensor fusion with collaborative multimodal data compression and neural upsampling, according to an embodiment. This method flow demonstrates the sequential and parallel processing steps that enable multiple autonomous vehicles to collaboratively share sensor data, perform safety-critical object detection, apply priority-based compression, and enhance perception capabilities through cross-vehicle AI deblocking networks.

According to the embodiment, the autonomous vehicle sensor fusion system 2500 initiates multi-vehicle operation mode. The system establishes communication links with other vehicles in the collaborative sensing network through V2X communication layer 2540, synchronizes system clocks for temporal alignment, and initializes the distributed processing architecture across edge computing, network processing, and cloud processing layers as described in the distributed processing architecture deployment.

According to an embodiment, the process begins at step 3002 where the system collects multimodal sensor data from multiple vehicles and infrastructure sources. Step 3002 implements the multi-vehicle input layer 2501 to simultaneously gather sensor data streams including LiDAR point clouds, camera images, radar signatures, thermal imagery, and environmental context information from Vehicle A input 2601A, Vehicle B input 2601B, Vehicle C input 2601C, infrastructure input 2601D, and environmental sensor suite 2506. The data collection process implements temporal synchronization to ensure that sensor data from different vehicles represents the same time instance, accounting for communication delays and processing latencies between vehicles.

Following data collection, the method implements parallel processing across multiple vehicles through steps 3003A, 3003B, 3003C, and 3003D, representing modal processing performed simultaneously by Vehicle A, Vehicle B, Vehicle C, and infrastructure systems respectively. This parallel processing approach enables the system to leverage the distributed computational resources of multiple vehicles while maintaining real-time performance requirements for safety-critical autonomous vehicle operation.

Vehicle A modal processing 3003A implements modal-specific preprocessor 2511 to perform LiDAR point cloud filtering, camera image correction, and sensor calibration specific to Vehicle A's sensor configuration. Vehicle A modal processing 3003A also implements feature extraction components 2605A through 2605D to extract relevant features from each sensor modality using algorithms optimized for Vehicle A's computational hardware capabilities.

Vehicle B modal processing 3003B performs similar modal-specific preprocessing and feature extraction tailored to Vehicle B's sensor configuration and computational resources. Vehicle B modal processing 3003B may implement different preprocessing parameters or algorithms based on Vehicle B's sensor characteristics, such as different camera calibration parameters, radar processing algorithms, or thermal imaging enhancement techniques.

Vehicle C modal processing 3003C and infrastructure modal processing 3003D similarly perform modality-specific preprocessing and feature extraction optimized for their respective sensor configurations and computational capabilities. The parallel processing approach enables each vehicle and infrastructure node to contribute its unique sensor perspective and computational resources to the collaborative sensing network while maintaining processing efficiency.

The method continues to step 3004 where the system detects environmental conditions using environmental adapter 2513 and environmental context information 2604. Step 3004 analyzes real-time weather conditions, lighting conditions, road surface conditions, and traffic density to determine how environmental factors may affect sensor performance and processing requirements. For example, if rain conditions are detected, step 3004 may trigger enhanced temporal filtering for LiDAR data, water droplet removal algorithms for camera data, and increased weighting of radar data which is less affected by precipitation.

The method proceeds to step 3005 where the system identifies safety-critical objects and regions using safety-critical region detector 2512. Step 3005 implements the safety-critical region detection and priority assignment process, applying deep learning recognition algorithms to identify vulnerable road users, emergency vehicles, and other safety-critical objects within the sensor data streams. Step 3005 assigns priority levels (CRITICAL, HIGH, MEDIUM, LOW) to detected objects and regions based on their safety criticality and collision risk assessment.

The method includes an emergency situation decision point 3006 that determines whether the detected sensor data indicates an emergency situation requiring immediate response. Emergency situations may include imminent collision scenarios, pedestrian sudden movements into vehicle paths, emergency vehicle approach, or other safety-critical events that require immediate autonomous vehicle response with minimal processing latency.

If an emergency situation is detected (YES path from decision 3006), the method flows to emergency processing step 3007 that implements immediate response protocols. Emergency processing 3007 bypasses normal collaborative processing steps to minimize latency and applies maximum processing priority to safety-critical regions. Emergency processing 3007 may implement emergency braking commands, collision avoidance maneuvers, or emergency vehicle yield protocols while simultaneously alerting other vehicles in the network through high-priority V2V communication.

If no emergency situation is detected (NO path from decision 3006), the method continues to step 3008 where the system aligns and registers cross-vehicle data using multi-modal registrar 2252 and geometry corrector 2251. Step 3008 implements spatial and temporal alignment of sensor data from multiple vehicles to account for different vehicle positions, orientations, and sensor calibration differences. The alignment process uses feature matching, homography estimation, and coordinate transformation techniques to create a unified spatial reference frame for cross-vehicle data fusion.

The method proceeds to step 3009 where the system trains or updates the angle optimizer network using distributed angle optimizer 2521. Step 3009 implements federated learning techniques that enable multiple vehicles to contribute to angle optimization model training without sharing raw sensor data. The training process optimizes slicing angles that maximize compression efficiency across the entire vehicle network while preserving cross-modal relationships and safety-critical information.

The method includes a collaborative enhancement decision point 3010 that determines whether collaborative processing should be applied based on network availability, computational resources, and processing requirements. The decision 3010 considers factors such as V2X communication quality, network bandwidth availability, computational load on participating vehicles, and the potential benefits of collaborative enhancement for the current scenario.

If collaborative enhancement is not available or beneficial (NO path from decision 3010), the method flows to local vehicle processing step 3011 where individual vehicles perform sensor fusion and processing using only their local computational resources and sensor data. Local vehicle processing 3011 ensures that each vehicle maintains autonomous operation capability even when network connectivity is limited or collaborative processing is not advantageous.

If collaborative enhancement is available and beneficial (YES path from decision 3010), the method flows to cross-vehicle collaborative processing step 3012 that implements enhanced multi-vehicle AI deblocking network 2552 and collaborative fusion engine 2553. Cross-vehicle collaborative processing 3012 enables vehicles to share processed sensor data and enhance each other's perception capabilities through cross-vehicle attention mechanisms and collaborative reconstruction techniques.

Both processing paths converge at step 3013 where the system slices data along optimal angles determined by distributed angle optimizer 2521. Step 3013 implements the enhanced slicing techniques that reorient multimodal sensor data along optimal angles to maximize compression efficiency while preserving safety-critical information and cross-modal relationships.

The method continues to step 3014 where the system reconstructs and encodes the sliced data using adaptive encoder 2531 with priority-based compression. Step 3014 applies different compression ratios based on safety priority assignments, with CRITICAL priority regions receiving minimal compression (high quality preservation) and LOW priority regions receiving aggressive compression (maximum bandwidth efficiency). The reconstruction process optimizes the sliced data for subsequent compression while maintaining essential characteristics for safety-critical object detection and tracking.

The method proceeds to step 3015 where the system applies error resilience techniques using error resilience subsystem 2532. Step 3015 may implement forward error correction coding with Reed-Solomon codes, data partitioning based on importance levels, and error concealment hints embedding. The error resilience parameters are adjusted based on safety priority levels, with CRITICAL priority data receiving maximum error protection (Reed-Solomon rate 0.5) and LOW priority data receiving standard error protection (Reed-Solomon rate 0.9).

The method continues to step 3016 where the system performs V2X transmission using V2X communication layer 2540. Step 3016 implements intelligent protocol selection between DSRC, C-V2X, and 5G communication methods based on latency requirements, bandwidth availability, and communication range needs. Safety-critical data receives highest transmission priority with minimal latency, while background data may be transmitted with lower priority to optimize overall network efficiency.

The method proceeds to step 3017 where receiving vehicles decode and enhance the transmitted data using enhanced multi-vehicle AI deblocking network 2552. Step 3017 implements error correction and concealment based on the applied error resilience techniques, followed by AI-based enhancement that removes compression artifacts and recovers lost information through cross-vehicle collaborative reconstruction.

The method concludes at output enhanced multi-vehicle perception where each vehicle receives enhanced perception data that combines its own sensor capabilities with collaborative enhancement from other vehicles in the network. This step provides each vehicle with perception quality that significantly exceeds what any individual vehicle could achieve independently, enabling detection of objects and hazards that would be invisible to single-vehicle sensor systems.

The method implements several performance targets to ensure real-time operation suitable for safety-critical autonomous vehicle applications. Safety processing operations including steps 3005 through 3007 maintain target latency under 10 milliseconds (for instance) to ensure immediate response to safety-critical situations. Collaborative enhancement operations including steps 3008 through 3012 maintain target latency under 100 milliseconds to provide enhanced perception capabilities while preserving real-time operation. V2X communication operations in step 3016 maintain target latency under 50 milliseconds for safety-critical data transmission. The overall method maintains target completion time under 200 milliseconds for complete sensor fusion processing from data collection to enhanced perception output.

The method supports graceful degradation where processing can adapt to varying network conditions and computational resource availability. If collaborative processing is unavailable, the method continues with local processing to ensure continuous autonomous vehicle operation. If emergency situations are detected, the method bypasses normal processing steps to minimize response latency for safety-critical scenarios.

The method may also implement dynamic resource allocation where computational tasks can be redistributed based on real-time vehicle capabilities and network conditions. For example, if Vehicle A experiences high computational load, some processing tasks may be temporarily shifted to Vehicle B or infrastructure resources to maintain overall system performance.

Furthermore, the method may include continuous feedback loops where performance metrics are monitored to optimize processing parameters, adjust compression ratios, modify error correction levels, and update neural network models based on real-world performance data. This continuous optimization ensures that the autonomous vehicle sensor fusion system maintains optimal performance across diverse operational scenarios and environmental conditions.

According to an aspect, the method implements temporal consistency checking throughout the processing pipeline to ensure that object detections and trajectory predictions remain stable across time frames. This temporal consistency is particularly important for safety-critical applications where flickering detections or inconsistent object tracking could lead to inappropriate autonomous vehicle responses.

The method may further comprise bandwidth optimization strategies that dynamically adjust data transmission based on network conditions and priority levels. During network congestion, the method may temporarily reduce transmission of LOW priority data while maintaining full transmission of CRITICAL and HIGH priority data. During optimal network conditions, the method may increase data sharing to enhance collaborative processing capabilities.

Environmental adaptation may be integrated throughout the method flow, where processing parameters are continuously adjusted based on real-time environmental conditions. During adverse weather conditions such as heavy rain or fog, the method may increase error correction redundancy, modify sensor processing algorithms, and adjust collaborative processing parameters to maintain optimal performance despite environmental challenges.

The method supports scalable deployment where additional vehicles can join the collaborative sensing network dynamically without disrupting ongoing operations. New vehicles are automatically integrated into the distributed processing architecture and begin contributing their sensor data and computational resources to enhance overall network performance.

Security and privacy protections may be implemented throughout the method flow to ensure that sensitive vehicle and passenger information is protected during collaborative processing. The federated learning approach in step 3009 enables model training without sharing raw sensor data, while encryption and authentication protocols protect V2X communications in step 3016.

The method may further comprise fault tolerance mechanisms that detect and isolate malfunctioning vehicles or sensors to prevent degraded data from affecting overall network performance. If a vehicle's sensors are determined to be unreliable due to calibration errors or hardware malfunctions, the method can exclude that vehicle's data from collaborative processing while maintaining network operation with remaining vehicles.

According to an aspect, quality assurance monitoring is integrated throughout the method to continuously assess the accuracy and reliability of object detections, trajectory predictions, and collaborative enhancements. Quality metrics are used to adjust processing parameters, update neural network models, and optimize system performance based on real-world operational data.

The method supports regulatory compliance requirements for autonomous vehicle safety systems by maintaining clear audit trails of all processing decisions, safety-critical detections, and emergency responses. This documentation enables safety certification and regulatory approval of autonomous vehicle deployments using the collaborative sensor fusion system.

Furthermore, the method includes provisions for over-the-air updates that enable continuous improvement of processing algorithms, neural network models, and system parameters without requiring physical vehicle servicing. These updates are coordinated across the vehicle network to ensure compatibility and optimal collaborative performance.

### Exemplary V2X Communication Protocol Stack Description

It should be appreciated that the following description of the V2X communication protocol stack is provided merely as an exemplary embodiment to illustrate the integration of vehicle-to-everything communication capabilities with the autonomous vehicle sensor fusion system. The specific protocols, standards, performance characteristics, and architectural components described herein are not intended to limit the scope of the invention in any way. The invention encompasses V2X communication systems operating with different protocols, alternative performance specifications, varying architectural configurations, and other communication technologies, all of which fall within the scope of the claims and the spirit of the invention. One skilled in the art will recognize that the V2X communication implementation may be adapted, modified, or optimized based on particular deployment requirements, available communication standards, regulatory constraints, or technological developments without departing from the fundamental principles of collaborative autonomous vehicle sensor fusion described herein.

The V2X communication protocol stack illustrates an exemplary V2X communication architecture implemented by the V2X communication layer, according to an embodiment. This protocol stack demonstrates the layered communication architecture that enables the autonomous vehicle sensor fusion system to transmit compressed sensor data, safety-critical alerts, and collaborative enhancement information between vehicles, infrastructure, pedestrians, and network services using multiple communication protocols including DSRC, C-V2X, and 5G technologies.

According to the embodiment, the V2X communication protocol stack implements a five-layer architecture comprising application layer, transport layer, network layer, MAC (Media Access Control) layer, and physical layer, each optimized for different aspects of autonomous vehicle communication requirements. The protocol stack supports multiple communication standards simultaneously and implements intelligent protocol selection to choose the optimal communication method based on message type, latency requirements, bandwidth needs, and network availability.

The application layer provides vehicle-specific applications and services that utilize the V2X communication infrastructure to support autonomous vehicle operation and collaborative sensing capabilities. The AV sensor fusion application represents the primary application for the autonomous vehicle sensor fusion system, implementing collaborative processing protocols that enable vehicles to share compressed sensor data, safety-critical region information, and enhanced perception results through the V2X network. The AV sensor fusion application implements priority-based message formatting where CRITICAL priority data (pedestrian detections, emergency situations) receives immediate transmission with minimal protocol overhead, while LOW priority data (background objects, analytics) may be buffered and transmitted with standard protocol processing.

Safety applications implement standardized V2X safety message protocols including Basic Safety Message (BSM), Decentralized Environmental Notification Message (DENM), and Cooperative Awareness Message (CAM) that provide basic vehicle-to-vehicle safety communication. Safety applications integrate with the safety-critical region detector to ensure that safety-critical object detections are immediately translated into appropriate V2X safety messages and transmitted to nearby vehicles and infrastructure with minimal latency.

The traffic management application implements Signal Phase and Timing (SPaT), MAP data, and Traveler Information Message (TIM) protocols that enable coordination with traffic infrastructure and city-wide traffic management systems. The traffic management application integrates with the collaborative fusion engine to provide traffic flow optimization based on real-time vehicle sensor data and collaborative sensing results.

The infotainment application provides media streaming and entertainment services that utilize available V2X bandwidth during non-critical periods. The infotainment application implements adaptive quality control that automatically reduces streaming quality during high-demand periods to preserve bandwidth for safety-critical and collaborative sensing applications.

The OTA updates application manages over-the-air distribution of model updates, software patches, and system improvements to vehicles and infrastructure components across the network. The OTA updates application coordinates with model training components in the cloud processing layer to distribute updated neural network models, improved angle optimization parameters, and enhanced collaborative sensing algorithms.

The message prioritization component implements intelligent message scheduling and priority management that ensures safety-critical messages receive immediate transmission while optimizing overall network efficiency. The message prioritization component coordinates with the safety-critical region detector and dynamic resource allocator to dynamically adjust message priorities based on real-time safety requirements and network conditions.

The transport layer provides reliable and efficient data transmission services tailored to different autonomous vehicle communication requirements. TCP reliable transport provides connection-oriented, reliable data transmission for large data transfers such as detailed sensor data sharing, map updates, and model distribution where data integrity is more important than minimal latency. TCP implements adaptive congestion control that adjusts transmission rates based on network conditions while ensuring complete data delivery.

UDP fast transport provides connectionless, low-latency data transmission for safety messages and real-time sensor data where speed is more critical than guaranteed delivery. UDP is optimized for safety-critical communications that require sub-10 millisecond latency, such as emergency braking alerts, collision warnings, and immediate hazard notifications.

SCTP multi-stream transport provides multi-stream data transmission capabilities specifically designed for multi-modal sensor data sharing where different sensor types (LiDAR, camera, radar, thermal) can be transmitted in parallel streams with different priority and reliability requirements. SCTP enables efficient transmission of the multimodal sensor data collected by the multi-vehicle input layer while maintaining temporal synchronization across different modalities.

The custom protocol implements priority-based delivery mechanisms specifically designed for the autonomous vehicle sensor fusion system. The custom protocol provides adaptive delivery guarantees where CRITICAL priority data receives reliable delivery with immediate retransmission, HIGH priority data receives best-effort delivery with limited retransmission, and LOW priority data uses opportunistic delivery that may be dropped during network congestion.

The network layer provides routing, addressing, and network management services that enable V2X communications across diverse network topologies and communication technologies. IPv6 provides next-generation Internet Protocol addressing and routing capabilities that support the large address space required for massive vehicle deployment and enable end-to-end connectivity between vehicles, infrastructure, and cloud services.

GeoNetworking implements location-based networking protocols that route messages based on geographic coordinates rather than network addresses, enabling efficient communication in mobile vehicle networks where traditional IP routing may be inefficient. GeoNetworking is particularly important for collaborative sensing applications where sensor data sharing is most valuable between vehicles in close geographic proximity.

Routing protocols implement dynamic routing algorithms including OSPF (Open Shortest Path First) and BGP (Border Gateway Protocol) that adapt to changing network topologies as vehicles move and network connectivity changes. Routing protocols ensure that collaborative sensing data can be efficiently routed between vehicles and infrastructure despite constant changes in network topology.

The security component implements comprehensive security measures including Public Key Infrastructure (PKI), digital certificates, message authentication, and encryption to protect V2X communications from cyber attacks, message spoofing, and privacy violations. The security component ensures that collaborative sensor data sharing maintains data integrity and prevents malicious actors from corrupting the autonomous vehicle sensor fusion network.

QOS management implements Quality of Service controls including traffic shaping, bandwidth allocation, and priority enforcement that ensure safety-critical messages receive preferential network treatment while maintaining fair access for all legitimate traffic. QoS management coordinates with the safety-critical region detector to dynamically adjust bandwidth allocation based on the detected safety criticality of transmitted data, ensuring that CRITICAL priority messages receive maximum available bandwidth while background data is throttled during network congestion.

Mobility management handles seamless handover control and connection continuity as vehicles move between different network coverage areas, cellular towers, and infrastructure zones. Mobility management ensures that collaborative sensing connections are maintained during vehicle movement and that handover processes do not interrupt safety-critical communications or ongoing collaborative data sharing sessions.

The MAC layer provides medium access control and channel management for different V2X communication technologies. IEEE 802.11p DSRC MAC implements the traditional Dedicated Short-Range Communication protocol optimized for low-latency, direct vehicle-to-vehicle communication without requiring cellular infrastructure. DSRC MAC provides deterministic channel access with sub-5 millisecond latency characteristics that are essential for immediate safety-critical communications such as emergency braking alerts and collision warnings.

PC5 interface C-V2X direct implements the direct communication mode of Cellular Vehicle-to-Everything technology that enables vehicles to communicate directly with each other using cellular protocols without requiring cellular network infrastructure. PC5 interface provides improved coverage and penetration characteristics compared to DSRC while maintaining relatively low latency for safety-critical applications.

5G NR MAC Uu interface implements the network-based communication mode of 5G New Radio Vehicle-to-Everything technology that utilizes cellular network infrastructure to provide high-bandwidth, wide-area communication capabilities. Uu interface enables vehicle-to-network communication for cloud-based processing, traffic management coordination, and large data transfers such as map updates and model distribution.

The protocol selector implements intelligent switching logic that dynamically chooses the optimal communication protocol based on message type, latency requirements, bandwidth needs, and network availability. The protocol selector coordinates with the message prioritization component to ensure that safety-critical messages are transmitted using the lowest-latency available protocol (typically DSRC or PC5), while large data transfers utilize high-bandwidth protocols (typically 5G NR), and background communications use the most efficient available protocol based on current network conditions.

Channel access manages spectrum allocation and interference mitigation across multiple communication technologies operating in overlapping frequency bands. Channel access implements dynamic spectrum management that optimizes channel utilization while minimizing interference between different V2X protocols and other wireless services.

The physical layer provides the radio frequency transmission and reception capabilities for different V2X communication technologies. 5.9 GHz DSRC implements the traditional Dedicated Short-Range Communication physical layer operating in the 75 MHz bandwidth allocation at 5.9 GHz frequency band. DSRC physical layer provides reliable communication at ranges up to 1000 meters with data rates between 3 and 27 Mbps, optimized for direct vehicle-to-vehicle and vehicle-to-infrastructure communication without cellular network dependencies.

LTE PC5 implements the LTE-based physical layer for Cellular Vehicle-to-Everything direct communication operating in various frequency bands depending on regional spectrum allocations. LTE PC5 provides improved coverage and penetration characteristics compared to DSRC, with communication ranges up to 1500 meters and data rates up to 100 Mbps, while maintaining compatibility with existing cellular infrastructure.

5G NR radio implements the 5G New Radio physical layer supporting both millimeter wave (mmWave) and sub-6 GHz frequency bands for ultra-high bandwidth communication. 5G NR radio provides data rates exceeding 100 Mbps with advanced features including network slicing, ultra-reliable low-latency communication (URLLC), and massive machine-type communication (mMTC) that enable sophisticated collaborative sensing applications and cloud-based processing integration.

Antenna systems implement Multiple-Input Multiple-Output (MIMO) antenna configurations and beamforming technologies that improve communication reliability, increase data throughput, and extend communication range through advanced signal processing techniques. Antenna systems coordinate with the different V2X protocols to optimize antenna patterns and beamforming parameters for each communication technology and application requirement.

RF front-end provides the radio frequency hardware including power amplifiers, low-noise amplifiers, filters, and frequency conversion circuits that enable simultaneous operation of multiple V2X communication technologies in a single vehicle platform. RF front-end implements advanced interference mitigation and spectrum coexistence techniques that allow DSRC, C-V2X, and 5G systems to operate simultaneously without mutual interference.

The protocol stack supports three primary V2X communication technologies with distinct performance characteristics optimized for different autonomous vehicle applications. DSRC (IEEE 802.11p) provides legacy protocol support with 1-5 millisecond latency, 300-1000 meter range, 3-27 Mbps data rates, and no infrastructure requirements, making it optimal for immediate safety-critical communications and legacy vehicle compatibility.

C-V2X (3GPP Release 14+) provides direct communication capabilities with 5-20 millisecond latency, 300-1500 meter range, 1-100 Mbps data rates, and better coverage and penetration characteristics than DSRC, making it suitable for enhanced safety applications and moderate-bandwidth collaborative sensing.

5G V2X (3GPP Release 16+) provides network communication capabilities with 1-10 millisecond latency, 1-10+ kilometer range, 100+ Mbps data rates, and advanced features including network slicing and ultra-reliable low-latency communication, making it optimal for high-bandwidth collaborative sensing, cloud-based processing integration, and sophisticated autonomous vehicle applications.

The V2X communication protocol stack implements adaptive protocol selection that automatically chooses the optimal communication technology based on application requirements and network conditions. For immediate safety-critical alerts such as emergency braking or collision warnings, the protocol selector prioritizes DSRC or PC5 direct communication to minimize latency. For collaborative sensor data sharing, the selector may choose C-V2X or 5G based on required bandwidth and acceptable latency. For large data transfers such as map updates or model distribution, the selector utilizes 5G network communication to maximize throughput.

The protocol stack also implements seamless protocol switching that can dynamically change communication methods during ongoing sessions based on changing network conditions, vehicle movement, or application requirements. For example, a collaborative sensing session might begin using 5G for high-bandwidth data sharing, switch to C-V2X when vehicles move out of 5G coverage, and fall back to DSRC when all other options are unavailable.

Quality of service management is implemented across all protocol layers to ensure that safety-critical communications receive preferential treatment regardless of which underlying communication technology is used. The QoS system coordinates with the safety-critical region detector to automatically prioritize messages containing CRITICAL priority object detections while deprioritizing background data transmission during network congestion.

Security and privacy protection is implemented consistently across all communication protocols using standardized PKI infrastructure, digital certificates, and encryption mechanisms. The security system ensures that collaborative sensor data sharing maintains data integrity and authenticity while protecting vehicle and passenger privacy from unauthorized access or tracking.

The V2X communication protocol stack represents a fundamental enabler for the autonomous vehicle sensor fusion system, providing the communication infrastructure necessary to implement collaborative sensing, cross-vehicle AI enhancement, and distributed processing across multiple vehicles and infrastructure elements. The protocol stack's support for multiple communication technologies and intelligent protocol selection ensures that the autonomous vehicle sensor fusion system can operate effectively across diverse deployment scenarios and network conditions while maintaining the real-time performance requirements essential for safety-critical autonomous vehicle applications.

The protocol stack is designed to evolve with advancing communication technologies, providing a forward-compatible architecture that can incorporate future V2X communication standards and protocols while maintaining backward compatibility with existing deployments. This evolutionary capability ensures that autonomous vehicles equipped with the sensor fusion system can benefit from improving communication technologies over their operational lifetime through software updates and protocol enhancements.

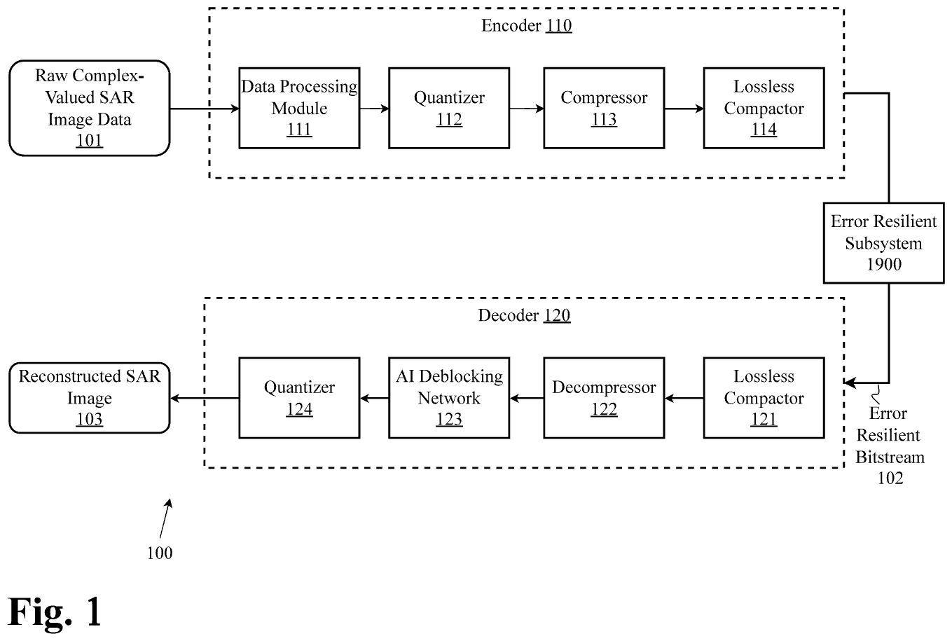

FIG. 1 is a block diagram illustrating an exemplary system architecture 100 for complex-valued SAR image compression with predictive recovery and error resilience, according to an embodiment. According to the embodiment, the system 100 comprises an encoder subsystem 110 configured to receive as input raw complex-valued (comprising both real (I) and imaginary (Q) components) SAR image data 101 and compress and compact the input data into a bitstream 102, an error resilience subsystem 1900 configured to apply error resilience techniques to the compressed bitstream, and a decoder subsystem 120 configured to receive and decompress the error-resilient bitstream 102 to output a reconstructed SAR image data 103. In some embodiments, the SAR image data is stored as a 32-bit floating-point value, covering a range (e.g., full range −R to +R) that varies depending on the specific dataset.

A data processor 111 may be present and configured to apply one or more data processing techniques to the raw input data to prepare the data for further processing by encoder subsystem 110. Data processing techniques can include (but are not limited to) any one or more of data cleaning, data transformation, encoding, dimensionality reduction, data slitting, and/or the like. In an embodiment, data processor 111 is configured to perform data clipping on the input data to a new range (e.g., cut range −C to +C). The selection of the new clipped range should be done such that only 1% of the total pixels in both I and Q channels are affected by the clipping action. Clipping the data limits the effect of extreme values while preserving the overall information contained in the SAR image.

After data processing, a quantizer 112 performs uniform quantization on the I and Q channels. Quantization is a process used in various fields, including signal processing, data compression, and digital image processing, to represent continuous or analog data using a discrete set of values. It involves mapping a range of values to a smaller set of discrete values. Quantization is commonly employed to reduce the storage requirements or computational complexity of digital data while maintaining an acceptable level of fidelity or accuracy. In an embodiment, quantizer 112 receives the clipped I/Q channels and quantizes them to 12 bits, thereby limiting the range of I and Q from 0 to 4096. The result is a more compact representation of the data. According to an implementation, the quantized I/Q images are then stored in uncompressed PNG format, which is used as input to a compressor 113. Compressor 113 may be configured to perform data compression on quantized I/Q images using a suitable conventional compression algorithm. According to an embodiment, compressor 113 may utilize High Efficiency Video Coding (HVEC) in intra mode to independently encode the I/Q image. In such embodiments, HVEC may be used at a decompressor 122 at decoder subsystem 120.

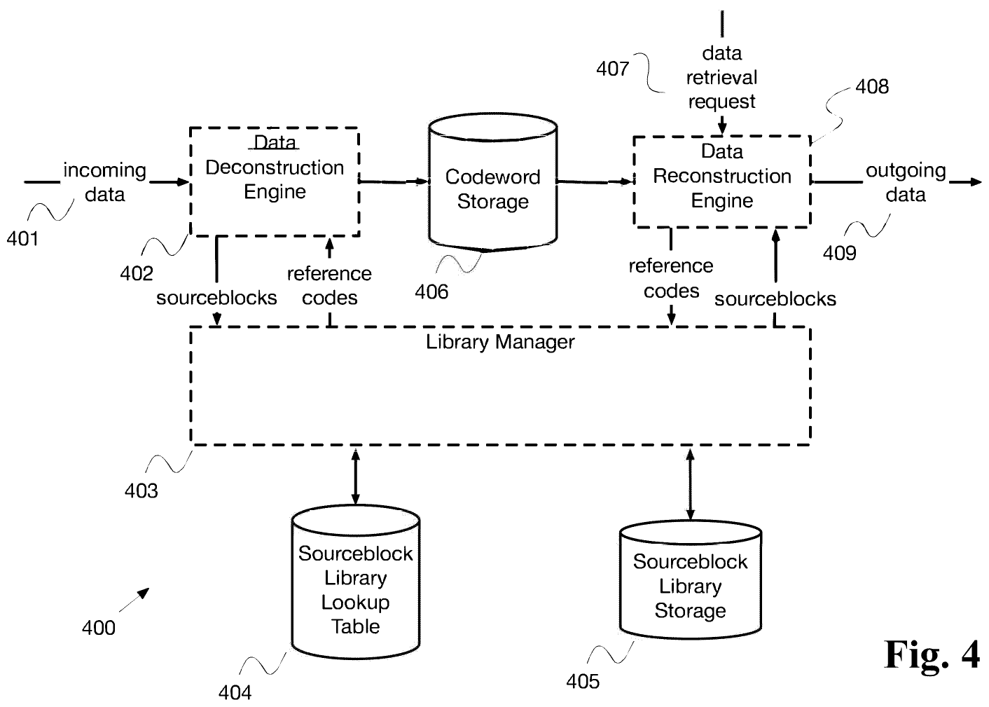

The resulting encoded bitstream may then be (optionally) input into a lossless compactor 114 which can apply data compaction techniques on the received encoded bitstream. An exemplary lossless data compaction system which may be integrated in an embodiment of system 100 is illustrated with reference to FIG. 4-7. For example, lossless compactor 114 may utilize an embodiment of data deconstruction engine 501 and library manager 403 to perform data compaction on the encoded bitstream. The output of the compactor is a compacted bitstream which is then processed by the error resilience subsystem 1900.

The error resilience subsystem 1900 applies error resilience techniques to the compressed bitstream. These techniques may include forward error correction coding, data partitioning based on importance, and embedding error concealment hints. The output of the error resilience subsystem is an error-resilient bitstream 102 which can be stored in a database, requiring much less space than would have been necessary to store the raw 32-bit complex-valued SAR image, or it can be transmitted to some other endpoint.

At the endpoint which receives the transmitted error-resilient bitstream 102 may be decoder subsystem 120 configured to restore the compacted data into the original SAR image by essentially reversing the process conducted at encoder subsystem 110. The received bitstream may first be (optionally) passed through a lossless compactor 121 which de-compacts the data into an encoded bitstream. In an embodiment, a data reconstruction engine 601 may be implemented to restore the compacted bitstream into its encoded format. The encoded bitstream may flow from compactor 121 to decompressor 122 wherein a data compaction technique may be used to decompress the encoded bitstream into the I/Q channels. In an embodiment, decompressor 122 uses HVEC techniques to decompress the encoded bitstream. It should be appreciated that lossless compactor components 114 and 121 are optional components of the system and may or may not be present in the system, dependent upon the embodiment.

According to the embodiment, an Artificial Intelligence (AI) deblocking network 123 is present and configured to utilize a trained deep learning network to enhance a decoded SAR image (i.e., I/Q channels) as part of the decoding process. AI deblocking network 123 may leverage the linear relationship demonstrated between I and Q images to enhance the reconstructed SAR image 103. Effectively, AI deblocking network 123 provides an improved and novel method for removing compression artifacts that occur during lossy compression/decompression using a network designed during the training process to simultaneously address the removal of artifacts and maintain fidelity of the amplitude information by optimizing the balance between SAR loss and amplitude loss, ensuring a comprehensive optimization of the network during the training stages. The AI deblocking network 123 also incorporates error correction and concealment based on the error resilience techniques applied by subsystem 1900.

The output of AI deblocking network 123 may be dequantized by quantizer 124, restoring the I/Q channels to their initial dynamic range. The dequantized SAR image may be reconstructed and output 103 by decoder subsystem 120 or stored in a database.

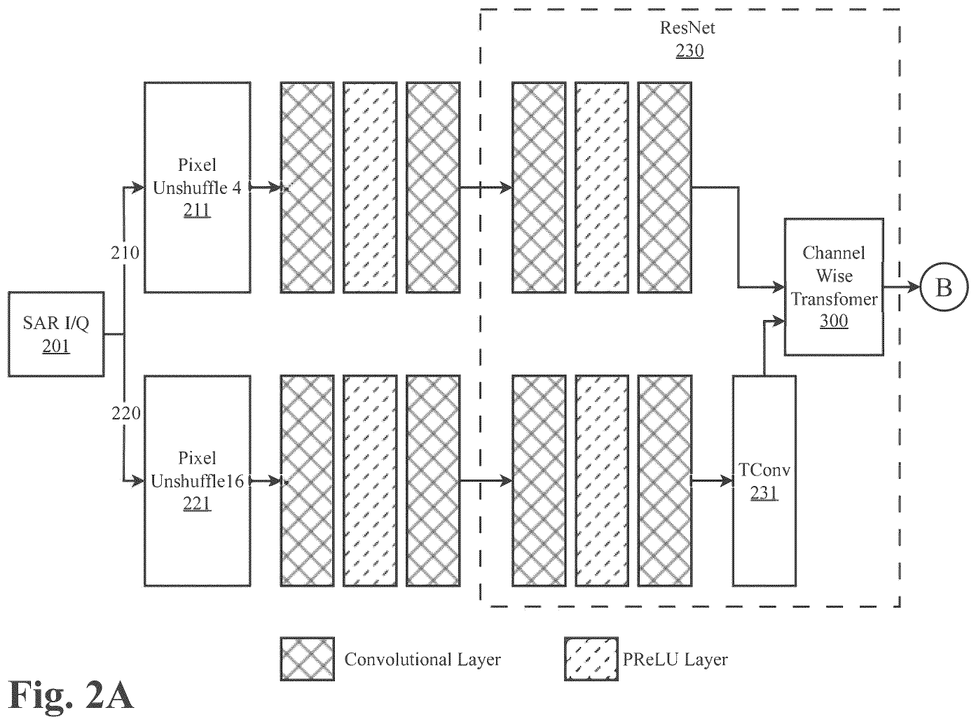

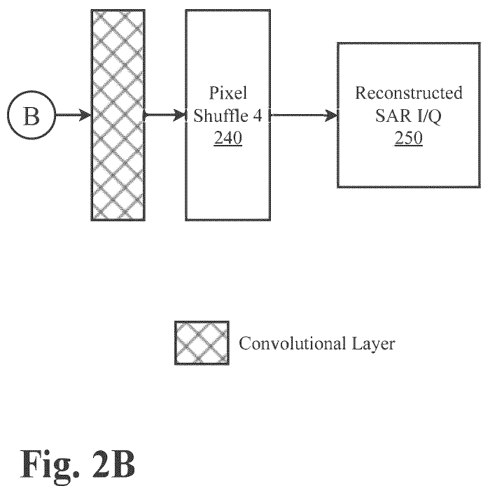

FIGS. 2A and 2B illustrate an exemplary architecture for an AI deblocking network configured to provide deblocking for dual-channel data stream comprising SAR I/Q data, according to an embodiment. In the context of this disclosure, dual-channel data refers to fact that SAR image signal can be represented as two (dual) components (i.e., I and Q) which are correlated to each other in some manner. In the case of I and Q, their correlation is that they can be transformed into phase and amplitude information and vice versa. AI deblocking network utilizes a deep learned neural network architecture for joint frequency and pixel domain learning. According to the embodiment, a network may be developed for joint learning across one or more domains. As shown, the top branch 210 is associated with the pixel domain learning and the bottom branch 220 is associated with the frequency domain learning. According to the embodiment, the AI deblocking network receives as input complex-valued SAR image I and Q channels 201 which, having been encoded via encoder 110, has subsequently been decompressed via decoder 120 before being passed to AI deblocking network for image enhancement via artifact removal. Inspired by the residual learning network and the MSAB attention mechanism, AI deblocking network employs resblocks that take two inputs. In some implementations, to reduce complexity the spatial resolution may be downsampled to one-half and one-fourth. During the final reconstruction the data may be upsampled to its original resolution. In one implementation, in addition to downsampling, the network employs deformable convolution to extract initial features, which are then passed to the resblocks. In an embodiment, the network comprises one or more resblocks and one or more convolutional filters. In an embodiment, the network comprises 8 resblocks and 64 convolutional filters.

Deformable convolution is a type of convolutional operation that introduces spatial deformations to the standard convolutional grid, allowing the convolutional kernel to adaptively sample input features based on the learned offsets. It's a technique designed to enhance the modeling of spatial relationships and adapt to object deformations in computer vision tasks. In traditional convolutional operations, the kernel's positions are fixed and aligned on a regular grid across the input feature map. This fixed grid can limit the ability of the convolutional layer to capture complex transformations, non-rigid deformations, and variations in object appearance. Deformable convolution aims to address this limitation by introducing the concept of spatial deformations. Deformable convolution has been particularly effective in tasks like object detection and semantic segmentation, where capturing object deformations and accurately localizing object boundaries are important. By allowing the convolutional kernels to adaptively sample input features from different positions based on learned offsets, deformable convolution can improve the model's ability to handle complex and diverse visual patterns.

According to an embodiment, the network may be trained as a two stage process, each utilizing specific loss functions. During the first stage, a mean squared error (MSE) function is used in the I/Q domain as a primary loss function for the AI deblocking network. The loss function of the SAR I/Q channel LSAR is defined as:

$${L}_{SAR} = 𝔼 [ {‖ I - {I}_{amp} ‖}_{2} ]$$

Moving to the second stage, the network reconstructs the amplitude component and computes the amplitude loss using MSE as follows:

$${L}_{amp} = 𝔼 [ {‖ {I}_{amp} - {I}_{dec , amp} ‖}_{2} ]$$

To calculate the overall loss, the network combines the SAR loss and the amplitude loss, incorporating a weighting factor, a, for the amplitude loss. The total loss is computed as:

$${L}_{total} = {L}_{SAR} + α \times {L}_{amp}$$

The weighting factor value may be selected based on the dataset used during network training. In an embodiment, the network may be trained using two different SAR datasets: the National Geospatial-Intelligence Agency (NGA) SAR dataset and the Sandia National Laboratories Mini SAR Complex Imagery dataset, both of which feature complex-valued SAR images. In an embodiment, the weighting factor is set to 0.0001 for the NGA dataset and 0.00005 for the Sandia dataset. By integrating both the SAR and amplitude losses in the total loss function, the system effectively guides the training process to simultaneously address the removal of the artifacts and maintain the fidelity of the amplitude information. The weighting factor, a, enables AI deblocking network to balance the importance of the SAR loss and the amplitude loss, ensuring comprehensive optimization of the network during the training stages. In some implementations, diverse data augmentation techniques may be used to enhance the variety of training data. For example, techniques such as horizontal and vertical flops and rotations may be implemented on the training dataset. In an embodiment, model optimization is performed using MSE loss and Adam optimizer with a learning rate initially set to 1×10⁻⁴ and decreased by a factor of 2 at epochs 100, 200, and 250, with a total of 300 epochs. In an implementation, the batch size is set to 256×256 with each batch containing 16 images.

Both branches first pass through a pixel unshuffling layer 211, 221 which implements a pixel unshuffling process on the input data. Pixel unshuffling is a process used in image processing to reconstruct a high-resolution image from a low-resolution image by rearranging or “unshuffling” the pixels. The process can involve the following steps, low-resolution input, pixel arrangement, interpolation, and enhancement. The input to the pixel unshuffling algorithm is a low-resolution image (i.e., decompressed, quantized SAR I/Q data). This image is typically obtained by downscaling a higher-resolution image such as during the encoding process executed by encoder 110. Pixel unshuffling aims to estimate the original high-resolution pixel values by redistributing and interpolating the low-resolution pixel values. The unshuffling process may involve performing interpolation techniques, such as nearest-neighbor, bilinear, or more sophisticated methods like bicubic or Lanczos interpolation, to estimate the missing pixel values and generate a higher-resolution image.

The output of the unshuffling layers 211, 221 may be fed into a series of layers which can include one or more convolutional layers and one or more parametric rectified linear unit (PReLU) layers. A legend is depicted for both FIG. 2A and FIG. 2B which indicates the cross hatched block represents a convolutional layer and the dashed block represents a PRELU layer. Convolution is the first layer to extract features from an input image. Convolution preserves the relationship between pixels by learning image features using small squares of input data. It is a mathematical operation that takes two inputs such as an image matrix and a filter or kernel. The embodiment features a cascaded ResNet-like structure comprising 8 ResBlocks to effectively process the input data. The filter size associated with each convolutional layer may be different. The filter size used for the pixel domain of the top branch may be different than the filter size used for the frequency domain of the bottom branch.

A PRELU layer is an activation function used in neural networks. The PRELU activation function extends the ReLU by introducing a parameter that allows the slope for negative values to be learned during training. The advantage of PRELU over ReLU is that it enables the network to capture more complex patterns and relationships in the data. By allowing a small negative slope for the negative inputs, the PRELU can learn to handle cases where the output should not be zero for all negative values, as is the case with the standard ReLU. In other implementations, other non-linear functions such as tanh or sigmoid can be used instead of PReLU.

After passing through a series of convolutional and PRELU layers, both branches enter the ResNet 230 which further comprises more convolutional and PRELU layers. The frequency domain branch is slightly different than the pixel domain branch once inside ResNet 230, specifically the frequency domain is processed by a transposed convolutional (TConv) layer 231. Transposed convolutions are a type of operation used in neural networks for tasks like image generation, image segmentation, and upsampling. They are used to increase the spatial resolution of feature maps while maintaining the learned relationships between features. Transposed convolutions aim to increase spatial dimensions of feature maps, effectively “upsampling” them. This is typically done by inserting zeros (or other values) between existing values to create more space for new values.

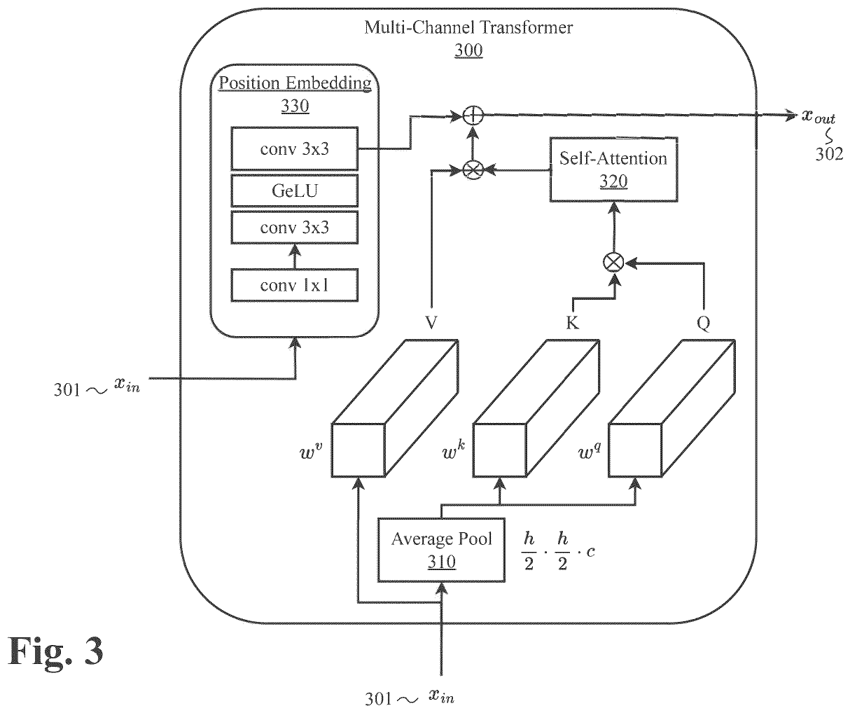

Inside ResBlock 230 the data associated with the pixel and frequency domains are combined back into a single stream by using the output of the Tconv 231 and the output of the top branch. The combined data may be used as input for a channel-wise transformer 300. In some embodiments, the channel-wise transformer may be implemented as a multi-scale attention block utilizing the attention mechanism. For more detailed information about the architecture and functionality of channel-wise transformer 300 refer to FIG. 3. The output of channel-wise transformer 300 may be a bit stream suitable for reconstructing the original SAR I/Q image. FIG. 2B shows the output of ResBlock 230 is passed through a final convolutional layer before being processed by a pixel shuffle layer 240 which can perform upsampling on the data prior to image reconstruction. The output of the AI deblocking network may be passed through a quantizer 124 for dequantization prior to producing a reconstructed SAR I/Q image 250.

The AI deblocking network has been further enhanced to incorporate error resilience information provided by the error resilience subsystem 1900. The network's input now includes not only the decompressed I and Q channels, but also error flags indicating regions affected by transmission errors and subsequently corrected or concealed. These error flags are processed alongside the image data through the network's convolutional and PRELU layers.

The ResNet 230 and channel-wise transformer 300 have been adapted to utilize this error information. The ResNet 230 now includes additional filters designed to identify and process artifacts resulting from both compression and error concealment. The channel-wise transformer 300 has been modified to adjust its attention mechanism based on the reliability of different image regions, as indicated by the error flags.

Furthermore, the loss function used during training has been updated to include an additional term that accounts for the error resilience information:

$$L\_total = L\_SAR + α \times L\_amp + β \times L\_error$$

where Lₑᵣᵣₒᵣ is a new loss term that penalizes discrepancies between the reconstructed image and the original in areas flagged as affected by transmission errors. The β factor is a weighting term that balances the importance of this new error-aware loss.

This integration allows the AI deblocking network to not only remove compression artifacts but also to refine and improve upon the initial error concealment performed by the decoder, resulting in a more robust reconstruction process that can handle both compression and transmission errors effectively.

FIG. 3 is a block diagram illustrating an exemplary architecture for a component of the system for SAR image compression, the channel-wise transformer 300. According to the embodiment, channel-wise transformer receives an input signal, Xin 301, the input signal comprising SAR I/Q data which is being processed by AI deblocking network 123. The input signal may be copied and follow two paths through multi-channel transformer 300.

A first path may process input data through a position embedding module 330 comprising series of convolutional layers as well as a Gaussian Error Linear Unit (GeLU). In traditional recurrent neural networks or convolutional neural networks, the order of input elements is inherently encoded through the sequential or spatial nature of these architectures. However, in transformer-based models, where the attention mechanism allows for non-sequential relationships between tokens, the order of tokens needs to be explicitly conveyed to the model. Position embedding module 330 may represent a feedforward neural network (position-wise feedforward layers) configured to add position embeddings to the input data to convey the spatial location or arrangement of pixels in an image. The output of position embedding module 330 may be added to the output of the other processing path the received input signal is processed through.

A second path may process the input data. It may first be processed via a channel-wise configuration and then through a self-attention layer 320. The signal may be copied/duplicated such that a copy of the received signal is passed through an average pool layer 310 which can perform a downsampling operation on the input signal. It may be used to reduce the spatial dimensions (e.g., width and height) of feature maps while retaining the most important information. Average pooling functions by dividing the input feature map into non-overlapping rectangular or square regions (often referred to as pooling windows or filters) and replacing each region with the average of the values within that region. This functions to downsample the input by summarizing the information within each pooling window.

Self-attention layer 320 may be configured to provide an attention to AI deblocking network 123. The self-attention mechanism, also known as intra-attention or scaled dot-product attention, is a fundamental building block used in various deep learning models, particularly in transformer-based models. It plays a crucial role in capturing contextual relationships between different elements in a sequence or set of data, making it highly effective for tasks involving sequential or structured data like complex-valued SAR I/Q channels. Self-attention layer 320 allows each element in the input sequence to consider other elements and weigh their importance based on their relevance to the current element. This enables the model to capture dependencies between elements regardless of their positional distance, which is a limitation in traditional sequential models like RNNs and LSTMs.

The input 301 and downsampled input sequence is transformed into three different representations: Query (Q), Key (K), and Value (V). These transformations (w^{V}, w^{K}, and w^{Q}) are typically linear projections of the original input. For each element in the sequence, the dot product between its Query and the Keys of all other elements is computed. The dot products are scaled by a factor to control the magnitude of the attention scores. The resulting scores may be normalized using a SoftMax function to get attention weights that represent the importance of each element to the current element. The Values (V) of all elements are combined using the attention weights as coefficients. This produces a weighted sum, where elements with higher attention weights contribute more to the final representation of the current element. The weighted sum is the output of the self-attention mechanism for the current element. This output captures contextual information from the entire input sequence.

The output of the two paths (i.e., position embedding module 330 and self-attention layer 320) may be combined into a single output data stream Xout 302.

FIG. 4 is a block diagram illustrating an exemplary system architecture 400 for providing lossless data compaction, according to an embodiment. As incoming data 401 is received by data deconstruction engine 402. Data deconstruction engine 402 breaks the incoming data into sourceblocks, which are then sent to library manager 403. Using the information contained in sourceblock library lookup table 404 and sourceblock library storage 405, library manager 403 returns reference codes to data deconstruction engine 402 for processing into codewords, which are stored in codeword storage 106. When a data retrieval request 407 is received, data reconstruction engine 408 obtains the codewords associated with the data from codeword storage 406, and sends them to library manager 403. Library manager 403 returns the appropriate sourceblocks to data reconstruction engine 408, which assembles them into the proper order and sends out the data in its original form 409.

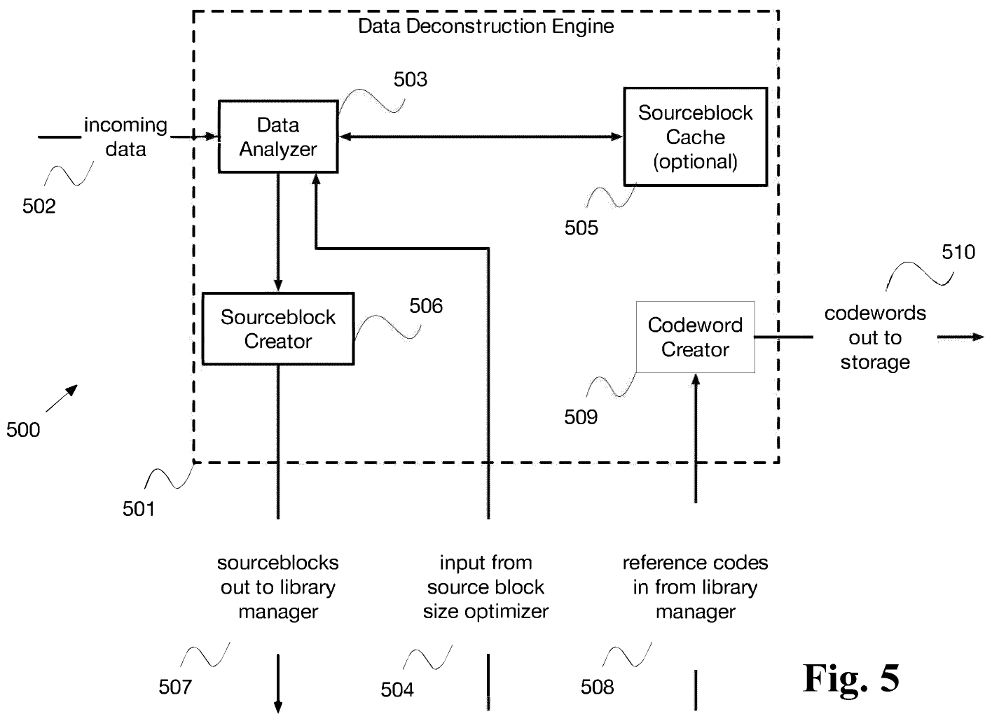

FIG. 5 is a diagram showing an embodiment of one aspect 500 of the system, specifically data deconstruction engine 501. Incoming data 502 is received by data analyzer 503, which optimally analyzes the data based on machine learning algorithms and input 504 from a sourceblock size optimizer, which is disclosed below. Data analyzer may optionally have access to a sourceblock cache 505 of recently processed sourceblocks, which can increase the speed of the system by avoiding processing in library manager 403. Based on information from data analyzer 503, the data is broken into sourceblocks by sourceblock creator 506, which sends sourceblocks 507 to library manager 403 for additional processing. Data deconstruction engine 501 receives reference codes 508 from library manager 403, corresponding to the sourceblocks in the library that match the sourceblocks sent by sourceblock creator 506, and codeword creator 509 processes the reference codes into codewords comprising a reference code to a sourceblock and a location of that sourceblock within the data set. The original data may be discarded, and the codewords representing the data are sent out to storage 510.

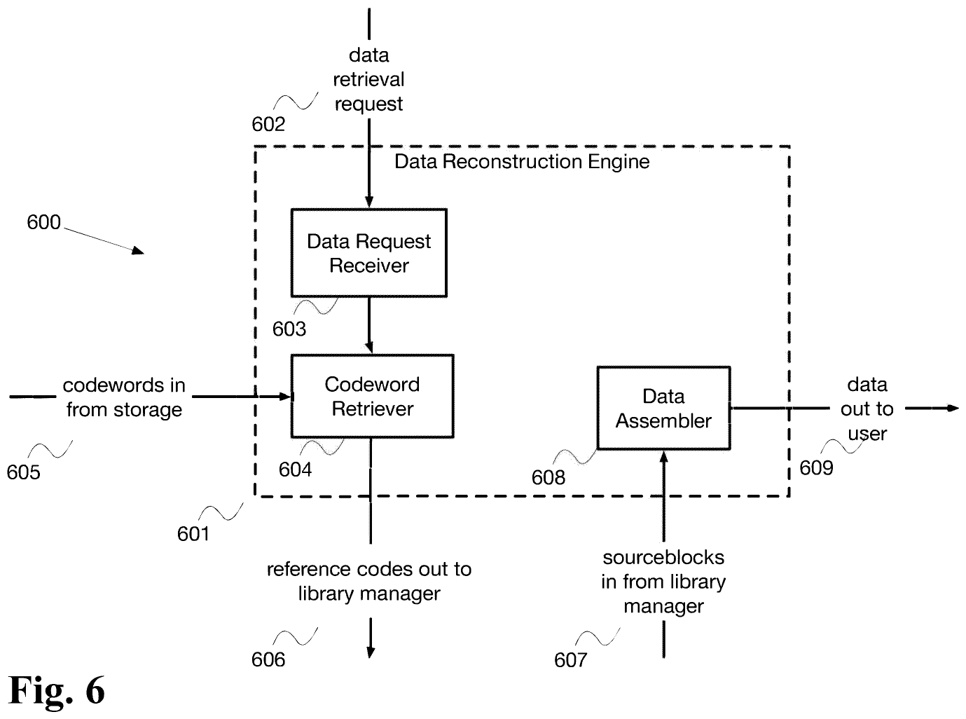

FIG. 6 is a diagram showing an embodiment of another aspect of system 600, specifically data reconstruction engine 601. When a data retrieval request 602 is received by data request receiver 603 (in the form of a plurality of codewords corresponding to a desired final data set), it passes the information to data retriever 604, which obtains the requested data 605 from storage. Data retriever 604 sends, for each codeword received, a reference codes from the codeword 606 to library manager 403 for retrieval of the specific sourceblock associated with the reference code. Data assembler 608 receives the sourceblock 607 from library manager 403 and, after receiving a plurality of sourceblocks corresponding to a plurality of codewords, assembles them into the proper order based on the location information contained in each codeword (recall each codeword comprises a sourceblock reference code and a location identifier that specifies where in the resulting data set the specific sourceblock should be restored to. The requested data is then sent to user 609 in its original form.

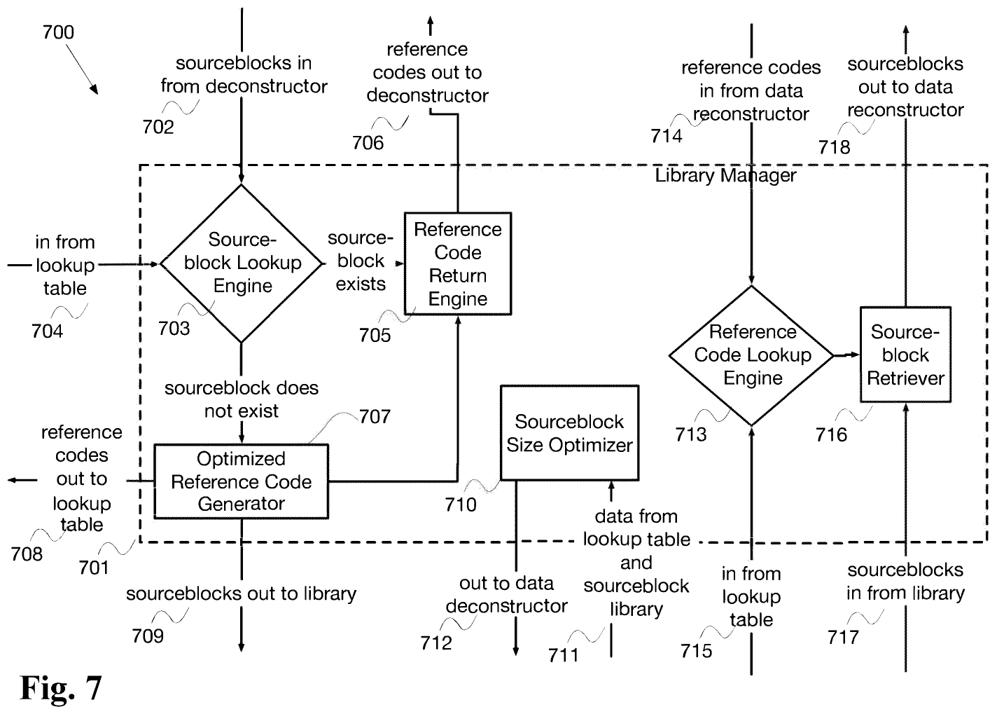

FIG. 7 is a diagram showing an embodiment of another aspect of the system 700, specifically library manager 701. One function of library manager 701 is to generate reference codes from sourceblocks received from data deconstruction engine 701. As sourceblocks are received 702 from data deconstruction engine 501, sourceblock lookup engine 703 checks sourceblock library lookup table 704 to determine whether those sourceblocks already exist in sourceblock library storage 705. If a particular sourceblock exists in sourceblock library storage 105, reference code return engine 705 sends the appropriate reference code 706 to data deconstruction engine 601. If the sourceblock does not exist in sourceblock library storage 105, optimized reference code generator 407 generates a new, optimized reference code based on machine learning algorithms. Optimized reference code generator 707 then saves the reference code 708 to sourceblock library lookup table 704; saves the associated sourceblock 709 to sourceblock library storage 105; and passes the reference code to reference code return engine 705 for sending 706 to data deconstruction engine 501. Another function of library manager 701 is to optimize the size of sourceblocks in the system. Based on information 711 contained in sourceblock library lookup table 404, sourceblock size optimizer 410 dynamically adjusts the size of sourceblocks in the system based on machine learning algorithms and outputs that information 712 to data analyzer 603. Another function of library manager 701 is to return sourceblocks associated with reference codes received from data reconstruction engine 601. As reference codes are received 714 from data reconstruction engine 601, reference code lookup engine 713 checks sourceblock library lookup table 715 to identify the associated sourceblocks; passes that information to sourceblock retriever 716, which obtains the sourceblocks 717 from sourceblock library storage 405; and passes them 718 to data reconstruction engine 601.

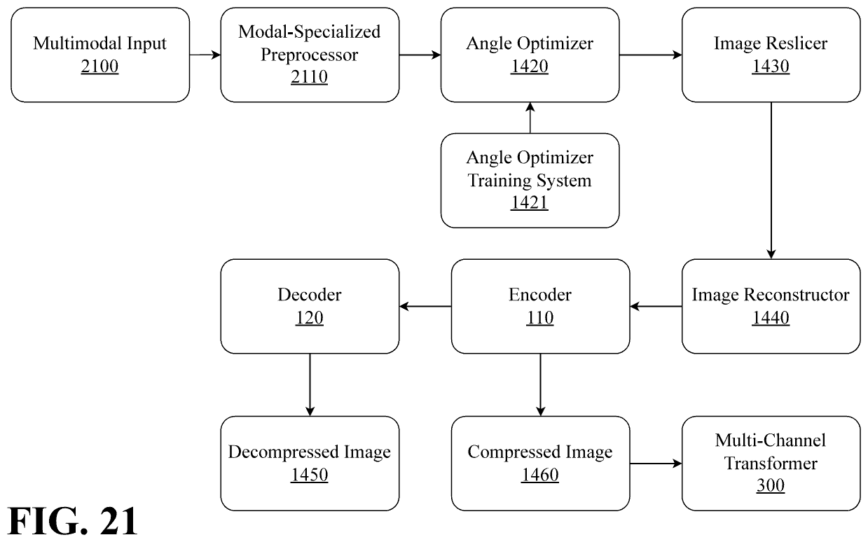

FIG. 21 is a block diagram illustrating an exemplary architecture for a system and method for multimodal series transformation for optimal compressibility with neural upsampling. In one embodiment, raw multimodal input data 2100 is received by a modal-specialized preprocessor 2110, which applies modality-specific preprocessing operations to each input stream. Modal-specialized preprocessor 2110 includes dedicated processing pipelines for each modality—for example, for optical data, it performs RGB to YUV color space conversion, corrects for barrel and pincushion distortions, and applies gamma correction; for thermal imagery, it performs blackbody calibration, normalizes temperature ranges to standard units (Kelvin), and applies noise reduction specific to microbolometer sensors; for hyperspectral data, it performs band selection using principal component analysis, corrects for atmospheric absorption using MODTRAN models, and applies spectral unmixing to separate material signatures; and for LIDAR inputs, it filters sparse points using statistical outlier removal, performs ground plane estimation, and normalizes point cloud density through voxel grid downsampling.

The preprocessed multimodal data is then passed to an angle optimizer 1420, which determines optimal slicing angles that maximize compressibility across all modalities while preserving their complementary information. For example, when processing urban scenes, the optimizer might identify building facade angles from LIDAR data and align slicing planes to maximize the correlation between thermal signatures and optical features along these surfaces. The angle optimizer is guided by an angle optimizer training system 1421 that continuously refines the optimization parameters based on the characteristics of each modality through a deep learning approach. This training system employs a convolutional neural network that learns from historical data how different slicing angles affect compression efficiency across modality combinations—such as how thermal-optical correlations vary with slice orientation, or how LIDAR point density affects optimal sampling directions. The optimized multimodal data is then processed by an image reslicer 1430 that reorients the data along the calculated optimal angles using trilinear interpolation for optical/thermal data and point cloud transformation matrices for LIDAR data, ensuring that geometric relationships and feature correlations are preserved during resampling.

The resliced multimodal data moves to an image reconstructor 1440 which combines the various modalities into a unified representation suitable for compression. For instance, LIDAR depth information is used to create depth-aware feature maps that guide the fusion of thermal and optical data, while hyperspectral signatures are encoded as feature vectors aligned with spatial coordinates from other modalities. Reconstructor 1440 may employ a hierarchical fusion approach-first combining spatially-correlated data (optical-LIDAR) through depth-guided convolution, then integrating thermal data using temperature-weighted feature aggregation, and finally incorporating hyperspectral features through band-wise attention mechanisms. This reconstructed data is then processed by an encoder 110 to produce a compressed representation 2130, employing a modified HEVC algorithm with custom quantization tables optimized for multimodal data characteristics. The encoder utilizes different quantization parameters for different modality components-preserving high-frequency details in LIDAR data while allowing more aggressive compression of redundant thermal information.

During decompression, a decoder 120 processes the compressed data to produce a decompressed representation 2120, using an inverse quantization scheme that adapts to modality-specific reconstruction requirements. The decompressed data is further enhanced by a multi-channel transformer 300, which employs a multi-head attention mechanism where each head specializes in a different modality relationship—one head might focus on optical-thermal correlations, another on LIDAR-optical relationships, and others on hyperspectral-thermal dependencies. The transformer includes modality-specific embedding layers that project each data type into a common feature space while preserving their unique characteristics—for example, preserving phase information in complex-valued SAR data while maintaining spatial consistency with optical features. The architecture implements cross-modal attention blocks that allow each modality to query relevant information from others, such as using LIDAR geometry to guide the refinement of thermal boundaries or leveraging hyperspectral signatures to enhance optical color reconstruction.

The system achieves high compression efficiency through careful orchestration of modality interactions throughout the pipeline. For example, when compressing urban scene data, LIDAR-derived geometric features guide the preservation of important structural details in optical and thermal data, while hyperspectral material classifications inform the selective compression of regions with similar compositional properties. Modal-specialized preprocessor 2110 employs adaptive preprocessing parameters that adjust based on scene content-such as varying thermal calibration based on temperature ranges or adjusting LIDAR filtering thresholds based on point cloud density. multi-channel transformer 300 may implement a feature pyramid network structure that processes information at multiple scales, allowing it to capture both fine-grained details (like building textures in optical data) and broad patterns (like thermal gradients across large structures) during reconstruction. This multi-scale approach, combined with modality-specific attention mechanisms, enables the system to achieve compression ratios up to 50% higher than single-modality approaches while maintaining critical information from each input source.

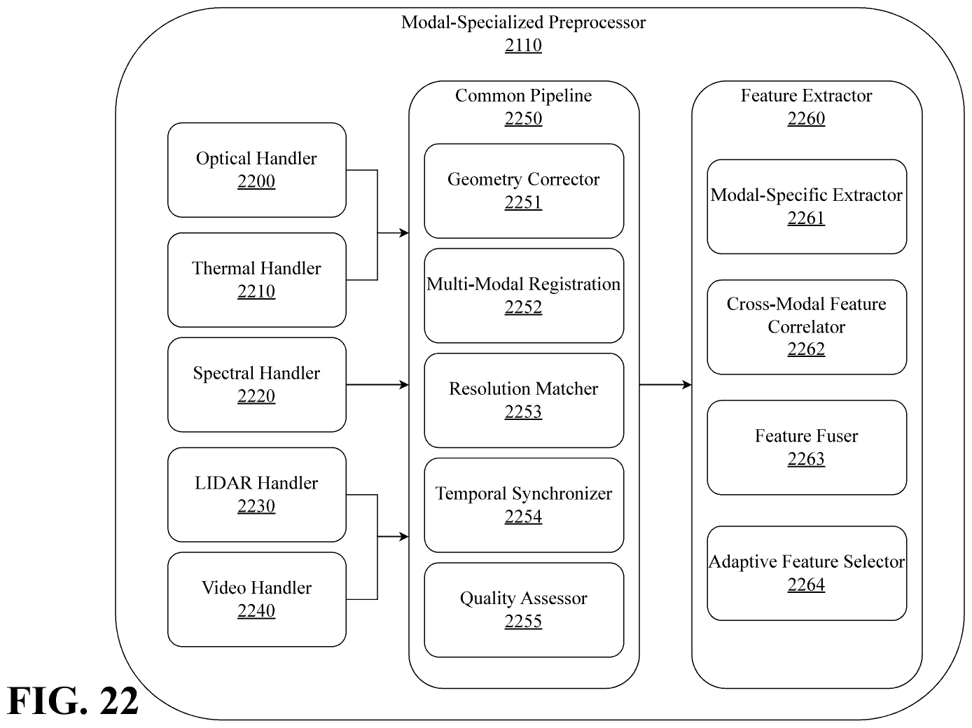

FIG. 22 is a block diagram illustrating a component of a system for multimodal series transformation for optimal compressibility with neural upsampling, a multimodal preprocessor. Each component within the system performs specialized processing to maintain data fidelity while enabling efficient compression. An optical handler 2200 executes a series of image processing operations. In one embodiment, it may perform color space transformations between multiple formats (RGB, YUV, and LAB) to optimize for different compression requirements, apply radial and tangential distortion correction using calibrated lens parameters and Brown-Conrady models, and implement local contrast enhancement through adaptive histogram equalization with overlapping tiles. Optical handler 2200 may employ a multi-scale illumination normalization approach using Retinex theory, decomposing the image into illumination and reflectance components through Gaussian pyramids, and applies scene-dependent gamma correction based on automated exposure analysis.

A thermal handler 2210 may employ temperature calibration routines that account for sensor-specific characteristics. In one embodiment, it may apply non-uniformity correction using a two-point reference method with blackbody calibration curves, implement temporal noise reduction through selective Kalman filtering that preserves thermal gradients while suppressing sensor artifacts, and perform range standardization using a piecewise linear mapping function that optimizes the dynamic range for the specific temperature span of the scene. Thermal handler 2210 may include dead pixel detection and interpolation algorithms that maintain thermal continuity across the image.

A spectral handler 2220 implements hyperspectral processing techniques. In one embodiment, it performs automated band selection using mutual information criteria and principal component analysis to identify the most informative spectral channels, applies linear and non-linear unmixing algorithms (including N-FINDR and kernel-based methods) to separate pure endmember signatures, and employs MODTRAN-based atmospheric correction that accounts for viewing geometry, solar angle, and atmospheric conditions. In another embodiment, spectral handler 2220 may include destriping algorithms to remove sensor artifacts and applies spectral smile correction using sensor-specific calibration data.

A LIDAR handler 2230 may employs point cloud processing algorithms. In one embodiment, LIDAR handler 2230 applies statistical outlier removal using adaptive neighborhood analysis, performs ground plane estimation through progressive morphological filtering, and implements surface reconstruction using advancing front surface reconstruction with adaptive density estimation. In another embodiment, LIDAR handler 2230 may include range normalization that accounts for sensor-specific characteristics like intensity falloff with distance and implements automated registration of multiple scans using iterative closest point algorithms with noise-aware weighting schemes.

A video handler 2240 implements temporal processing techniques. In one embodiment, video handler 2240 performs hierarchical motion estimation using block matching and optical flow methods, applies temporal filtering through motion-compensated frame averaging, and implements content-adaptive frame interpolation using bidirectional motion vectors with occlusion handling. Video handler 2240 may include scene change detection algorithms that adjust processing parameters based on content dynamics and implements temporal super-resolution through multi-frame analysis with sub-pixel motion estimation.

Within the common pipeline 2250, a geometry corrector 2251 implements a comprehensive spatial correction framework. Geometry corrector 2251 applies non-linear coordinate transformations using thin-plate splines for global geometric adjustments, corrects perspective distortions through vanishing point detection and homography estimation, and implements terrain-aware corrections using digital elevation models. In an embodiment, geometry corrector 2251 may also employ automated control point detection through SIFT and SURF feature extractors, with robust outlier rejection using RANSAC, and applies piece-wise polynomial warping with adaptive tessellation based on local distortion magnitudes.

A multi-modal registrar 2252 executes cross-modality alignment. Multi-modal registrar 2252 performs hierarchical feature matching using modality-invariant descriptors (like gradient orientation histograms for optical-thermal pairs and geometric primitives for LIDAR-optical alignment), estimates local and global transformations through a coarse-to-fine approach using both rigid and non-rigid registration models, and implements mutual information maximization for modalities with different appearance characteristics. In an embodiment, multi-modal registrar 2252 may include confidence-weighted feature matching that adapts to modality-specific reliability metrics and employs a graph-based optimization framework for globally consistent registration across all modalities.

A resolution matcher 2253 implements content-aware resampling strategies. Resolution matcher 2253 analyzes local frequency content using wavelet decomposition to guide sampling density, applies directional interpolation kernels that preserve edges and structural features, and implements super-resolution techniques for low-resolution modalities using cross-modal guidance. In one embodiment, resolution matcher 2253 may employ structure-tensor analysis to identify important image features, uses these to guide the resampling process with anisotropic filtering, and implements modality-specific detail preservation constraints.

A temporal synchronizer 2254 manages complex temporal relationships. Temporal synchronizer 2254 performs timestamp analysis using both hardware and software timestamps, implements motion-aware temporal interpolation using optical flow estimation, and applies modality-specific temporal models that account for different sensor capture rates and exposure times. In one embodiment, temporal synchronizer 2254 includes predictive synchronization for real-time streams using Kalman filtering, handles missing or corrupted frames through temporal hole filling, and maintains causal relationships between modalities through event-based synchronization.

A quality assessor 2255 provides comprehensive quality monitoring. Quality assessor 2255 applies modality-specific metrics like PSNR for optical data, temperature accuracy for thermal data, and point cloud density for LIDAR data, while also implementing cross-modal consistency checks through feature correspondence analysis and geometric constraint verification. Quality assessor 2255 may include automated artifact detection using deep learning models trained on modality-specific degradations, implements real-time quality feedback loops that adjust processing parameters, and maintains historical quality metrics for trend analysis and system optimization.

A feature extractor 2260 implements a multi-stage feature extraction pipeline optimized for multimodal compression. Feature extractor 2260 employs a hierarchical processing architecture that extracts features at multiple scales through pyramid decomposition, implements parallel processing streams for different feature types, and maintains spatial-spectral relationships through tensor-based representations. Feature extractor 2260 may dynamically adjust feature extraction parameters based on scene complexity and modality characteristics, employing adaptive thresholding techniques and region-based processing strategies.

A modal-specific extractor 2261 executes specialized algorithms for each modality. Modal-specific extractor 2261 implements multi-scale edge detection using oriented gradient operators and phase congruency analysis for optical data, along with texture feature extraction through Gabor filter banks and local binary patterns; performs temperature gradient analysis using adaptive threshold selection and ridge detection for thermal data, while implementing thermal blob detection through scale-space analysis; extracts surface normals using principal component analysis of local neighborhoods for LIDAR data, implements geometric primitive detection through RANSAC-based fitting, and performs curvature analysis using differential geometry operators. Modal-specific extractor 2261 may include modality-specific noise models that guide feature detection parameters and implements adaptive spatial sampling based on feature density.

A cross-modal feature correlator 2262 employs statistical analysis techniques. Cross-modal feature correlator 2262 performs canonical correlation analysis across modality pairs to identify common underlying patterns, implements mutual information maximization using adaptive kernel density estimation, and applies tensor canonical correlation analysis for handling multiple modalities simultaneously. Cross-modal feature correlator 2262 may include graph-based feature matching that exploits spatial relationships, implements probabilistic feature correspondence using Gaussian mixture models, and maintains a hierarchical correlation structure that captures both local and global relationships between modalities.

A feature fuser 2263 implements feature combination strategies. Feature fuser 2263 applies attention-weighted fusion that dynamically adjusts feature importance based on local content analysis, employs graph convolutional networks for structure-aware feature fusion, and implements adaptive feature normalization that preserves modality-specific characteristics. Feature fuser 2263 may include residual learning modules that capture complementary information across modalities, implements cross-modal feature refinement through iterative feedback, and maintains feature consistency through geometric constraint enforcement.

An adaptive feature selector 2264 executes content-aware feature selection. Adaptive feature selector 2264 employs deep reinforcement learning to optimize feature selection policies based on compression performance, implements information theoretic measures to evaluate feature importance, and applies online learning to adapt selection criteria to changing content characteristics. Adaptive feature selector 2264 may include feature ranking mechanisms based on compression impact analysis, implements dynamic feature pruning to maintain optimal compression efficiency, and employs modality-specific importance weighting that accounts for perceptual significance in each domain.

This architecture enables the system to process multiple input modalities while maintaining their unique characteristics and exploiting cross-modal relationships for improved compression efficiency. Each component is designed to handle both the general case and modality-specific edge cases, ensuring robust performance across a wide range of input conditions.

### Detailed Description of Exemplary Aspects

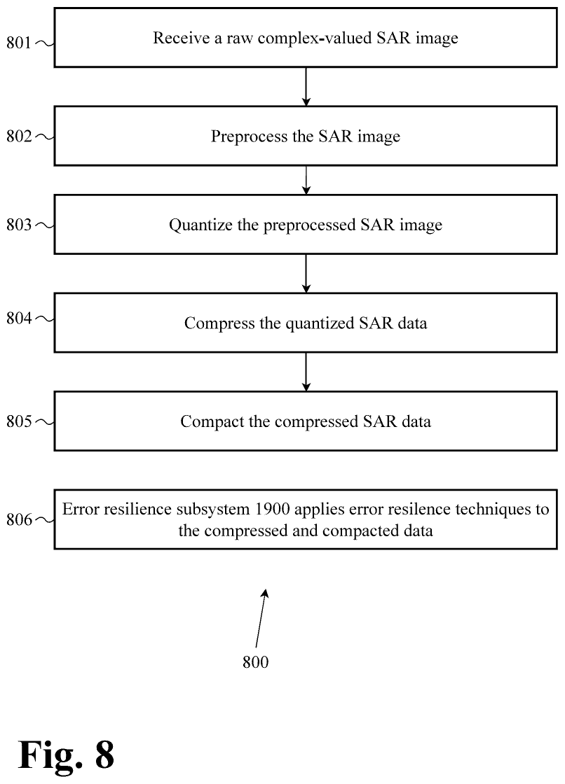

FIG. 8 is a flow diagram illustrating an exemplary method 800 for complex-valued SAR image compression with error resilience, according to an embodiment. According to the embodiment, the process begins at step 801 when encoder subsystem 110 receives a raw complex-valued SAR image. The complex-valued SAR image comprises both I and Q components. In some embodiments, the I and Q components may be processed as separate channels. At step 802, the received SAR image may be preprocessed for further processing by encoder subsystem 110. For example, the input image may be clipped or otherwise transformed in order to facilitate further processing. As a next step 803, the preprocessed data may be passed to quantizer 112 which quantizes the data. The next step 804 comprises compressing the quantized SAR data using a compression algorithm known to those with skill in the art. In an embodiment, the compression algorithm may comprise HEVC encoding for both compression and decompression of SAR data. At step 805, the compressed data may be compacted. The compaction may be a lossless compaction technique, such as those described with reference to FIGS. 4-7. Following compaction, at step 806, the error resilience subsystem 1900 applies error resilience techniques to the compressed and compacted data. These techniques include forward error correction coding, data partitioning based on importance, and embedding error concealment hints. The output of method 800 is a compressed, compacted, and error-resilient bit stream of SAR image data which can be stored in a database, requiring much less storage space than would be required to store the original, raw SAR image, while also being robust against transmission errors and data loss. The error-resilient bit stream may be transmitted to an endpoint for storage or processing. Transmission of the compressed, compacted, and error-resilient data requires less bandwidth and computing resources than transmitting raw SAR image data, while providing enhanced protection against transmission errors.

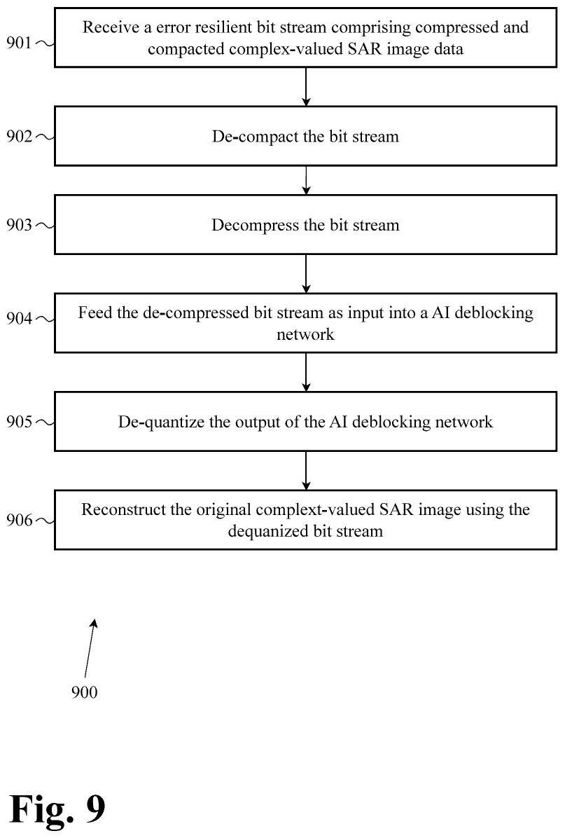

FIG. 9 is a flow diagram illustrating an exemplary method 900 for decompression of a complex-valued SAR image with error resilience, according to an embodiment. According to the embodiment, the process begins at step 901 when decoder subsystem 120 receives a bit stream comprising compressed, compacted, and error-resilient complex-valued SAR image data. The error-resilient bit stream may be received from encoder subsystem 110 or from a suitable data storage device. At step 902, the received bit stream is first de-compacted to produce an encoded (compressed) bit stream. In some embodiments, data reconstruction engine 601 may be implemented as a system for de-compacting a received bit stream. The next step 903 comprises decompressing the de-compacted bit stream using a suitable compression algorithm known to those with skill in the art, such as HEVC encoding. During this step, the system also performs error correction and concealment based on the applied error resilience techniques, utilizing the forward error correction coding, data partitioning, and error concealment hints embedded in the bit stream. At step 904, the de-compressed and error-corrected SAR data is fed as input into AI deblocking network 123 for image enhancement via a trained deep learning network. The AI deblocking network utilizes a series of convolutional layers and/or ResBlocks to process the input data and perform artifact removal on the de-compressed SAR image data. It also incorporates the error concealment hints to further improve image quality. AI deblocking network is further configured to implement an attention mechanism for the model to capture dependencies between elements regardless of their positional distance. In an embodiment, during training of AI deblocking network, the amplitude loss in conjunction with the SAR loss is computed and accounted for, further boosting the compression performance of system 100. The output of AI deblocking network 123 is sent to a quantizer 124 which executes step 905 by de-quantizing the output bit stream from AI deblocking network. As a last step 906, the system reconstructs the original complex-valued SAR image using the de-quantized bit stream, resulting in a high-quality image that has been effectively protected against transmission errors and data loss.

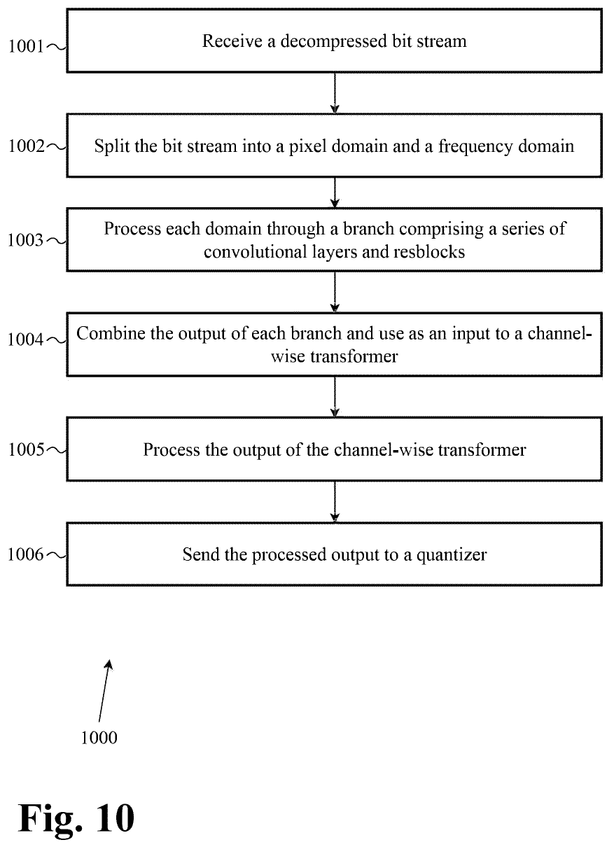

FIG. 10 is a flow diagram illustrating an exemplary method for deblocking using a trained deep learning algorithm, according to an embodiment. According to the embodiment, the process begins at step 1001 wherein the trained deep learning algorithm (i.e., AI deblocking network 123) receives a decompressed bit stream comprising SAR I/Q image data. At step 1002, the bit stream is split into a pixel domain and a frequency domain. Each domain may pass through AI deblocking network, but have separate, almost similar processing paths. As a next step 1003, each domain is processed through its respective branch, the branch comprising a series of convolutional layers and ResBlocks. In some implementations, frequency domain may be further processed by a transpose convolution layer. The two branches are combined and used as input for a multi-channel transformer with attention mechanism at step 1004. Multi-channel transformer 300 may perform functions such as downsampling, positional embedding, and various transformations, according to some embodiments. Multi-channel transformer 300 may comprise one or more of the following components: channel-wise attention, transformer self-attention, and/or feedforward layers. In an implementation, the downsampling may be performed via average pooling. As a next step 1005, the AI deblocking network processes the output of the channel-wise transformer. The processing may include the steps of passing the output through one or more convolutional or PRELU layers and/or upsampling the output. As a last step 1006, the processed output may be forwarded to quantizer 124 or some other endpoint for storage or further processing.

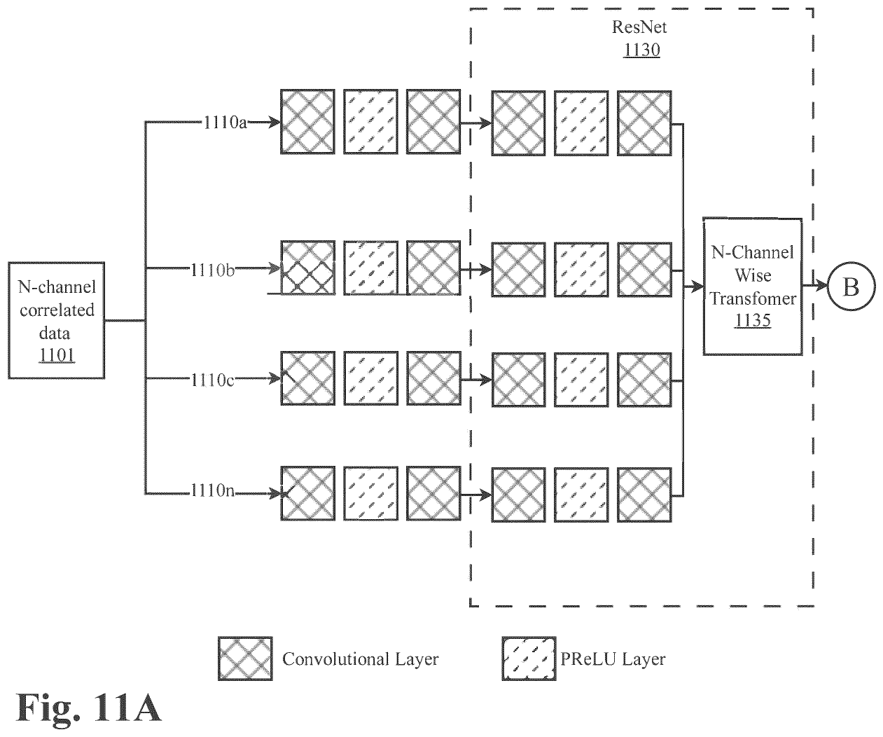

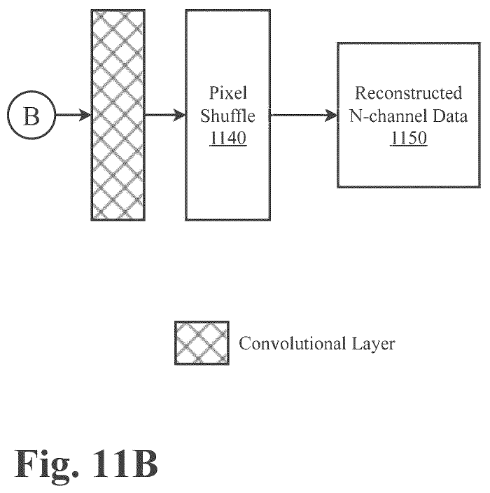

FIGS. 11A and 11B illustrate an exemplary architecture for an AI deblocking network configured to provide deblocking for a general N-channel data stream, according to an embodiment. The term “N-channel” refers to data that is composed of multiple distinct channels of modalities, where each channel represents a different aspect of type of information. These channels can exist in various forms, such as sensor readings, image color channels, or data streams, and they are often used together to provide a more comprehensive understanding of the underlying phenomenon. Examples of N-channel data include, but is not limited to, RGB images (e.g., in digital images, the red, green, and blue channels represent different color information; combining these channels allows for the representation of a wide range of colors), medical imaging (e.g., may include Magnetic Resonance Imaging scans with multiple channels representing different tissue properties, or Computed Tomography scans with channels for various types of X-ray attenuation), audio data (e.g., stereo or multi-channel audio recordings where each channel corresponds to a different microphone or audio source), radar and lidar (e.g., in autonomous vehicles, radar and lidar sensors provide multi-channel data, with each channel capturing information about objects' positions, distances, and reflectivity) SAR image data, text data (e.g., in natural language processing, N-channel data might involve multiple sources of text, such as social media posts and news articles, each treated as a separate channel to capture different textual contexts), sensor networks (e.g., environmental monitoring systems often employ sensor networks with multiple sensors measuring various parameters like temperature, humidity, air quality, and more. Each sensor represents a channel), climate data, financial data, and social network data.

The disclosed AI deblocking network may be trained to process any type of N-channel data, if the N-channel data has a degree of correlation. More correlation between and among the multiple channels yields a more robust and accurate AI deblocking network capable of performing high quality compression artifact removal on the N-channel data stream. A high degree of correlation implies a strong relationship between channels. Using SAR image data has been used herein as an exemplary use case for an AI deblocking network for a N-channel data stream comprising 2 channels, the In-phase and Quadrature components (i.e., I and Q, respectively).

Exemplary data correlations that can be exploited in various implementations of AI deblocking network can include, but are not limited to, spatial correlation, temporal correlation, cross-sectional correlation (e.g., This occurs when different variables measured at the same point in time are related to each other), longitudinal correlation, categorical correlation, rank correlation, time-space correlation, functional correlation, and frequency domain correlation, to name a few.

As shown, an N-channel AI deblocking network may comprise a plurality of branches 1110a-n. The number of branches is determined by the number of channels associated with the data stream. Each branch may initially be processed by a series of convolutional and PRELU layers. Each branch may be processed by resnet 1130 wherein each branch is combined back into a single data stream before being input to N-channel wise transformer 1135, which may be a specific configuration of transformer 300. The output of N-channel wise transformer 1135 may be sent through a final convolutional layer before passing through a last pixel shuffle layer 1140. The output of AI deblocking network for N-channel video/image data is the reconstructed N-channel data 1150.

As an exemplary use case, video/image data may be processed as a 3-channel data stream comprising Green (G), Red (R), and Blue (B) channels. An AI deblocking network may be trained that provides compression artifact removal of video/image data. Such a network would comprise 3 branches, wherein each branch is configured to process one of the three channels (R, G, or B). For example, branch 1110a may correspond to the R-channel, branch 1110b to the G-channel, and branch 1110c to the B-channel. Each of these channels may be processed separately via their respective branches before being combined back together inside resnet 1130 prior to being processed by N-channel wise transformer 1135.

As another exemplary use case, a sensor network comprising a half dozen sensors may be processed as a 6-channel data stream. The exemplary sensor network may include various types of sensors collecting different types of, but still correlated, data. For example, sensor network can include a pressure sensor, a thermal sensor, a barometer, a wind speed sensor, a humidity sensor, and an air quality sensor. These sensors may be correlated to one another in at least one way. For example, the six sensors in the sensor network may be correlated both temporally and spatially, wherein each sensor provides a time series data stream which can be processed by one of the 6 channels 1110a-n of AI deblocking network. As long as AI deblocking network is trained on N-channel data with a high degree of correlation and which is representative of the N-channel data it will encounter during model deployment, it can reconstruct the original data using the methods described herein.

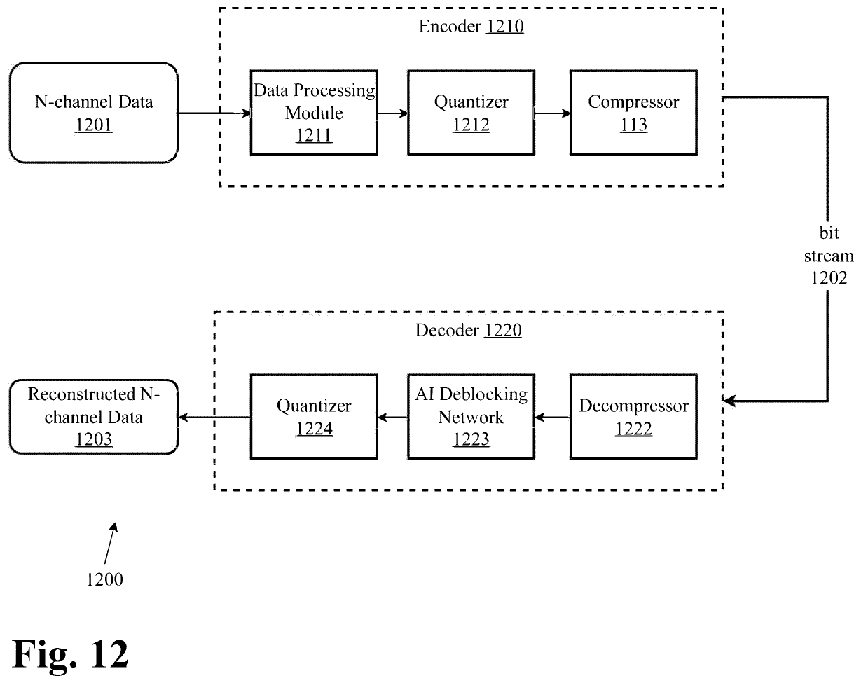

FIG. 12 is a block diagram illustrating an exemplary system architecture 1200 for N-channel data compression with predictive recovery, according to an embodiment. According to the embodiment, the system 1200 comprises an encoder module 1210 configured to receive as input N-channel data 1201 and compress and compact the input data into a bitstream 102, and a decoder module 120 configured to receive and decompress the bitstream 1202 to output a reconstructed N-channel data 1203.

A data processor module 1211 may be present and configured to apply one or more data processing techniques to the raw input data to prepare the data for further processing by encoder 1210. Data processing techniques can include (but are not limited to) any one or more of data cleaning, data transformation, encoding, dimensionality reduction, data slitting, and/or the like.

After data processing, a quantizer 1212 performs uniform quantization on the n-number of channels. Quantization is a process used in various fields, including signal processing, data compression, and digital image processing, to represent continuous or analog data using a discrete set of values. It involves mapping a range of values to a smaller set of discrete values. Quantization is commonly employed to reduce the storage requirements or computational complexity of digital data while maintaining an acceptable level of fidelity or accuracy. Compressor 1213 may be configured to perform data compression on quantized N-channel data using a suitable conventional compression algorithm.

The resulting encoded bitstream may then be (optionally) input into a lossless compactor (not shown) which can apply data compaction techniques on the received encoded bitstream. An exemplary lossless data compaction system which may be integrated in an embodiment of system 1200 is illustrated with reference to FIG. 4-7. For example, lossless compactor may utilize an embodiment of data deconstruction engine 501 and library manager 403 to perform data compaction on the encoded bitstream. The output of the compactor is a compacted bitstream 1202 which can be stored in a database, requiring much less space than would have been necessary to store the raw N-channel data, or it can be transmitted to some other endpoint.

At the endpoint which receives the transmitted compacted bitstream 1202 may be decoder module 1220 configured to restore the compacted data into the original SAR image by essentially reversing the process conducted at encoder module 1210. The received bitstream may first be (optionally) passed through a lossless compactor which de-compacts the data into an encoded bitstream. In an embodiment, a data reconstruction engine 601 may be implemented to restore the compacted bitstream into its encoded format. The encoded bitstream may flow from compactor to decompressor 1222 wherein a data compaction technique may be used to decompress the encoded bitstream into the I/Q channels. It should be appreciated that lossless compactor components are optional components of the system, and may or may not be present in the system, dependent upon the embodiment.

According to the embodiment, an Artificial Intelligence (AI) deblocking network 1223 is present and configured to utilize a trained deep learning network to provide compression artifact removal as part of the decoding process. AI deblocking network 1223 may leverage the relationship demonstrated between the various N-channels of a data stream to enhance the reconstructed N-channel data 1203. Effectively, AI deblocking network 1223 provides an improved and novel method for removing compression artifacts that occur during lossy compression/decompression using a network designed during the training process to simultaneously address the removal of artifacts and maintain fidelity of the original N-channel data signal, ensuring a comprehensive optimization of the network during the training stages.

The output of AI deblocking network 1223 may be dequantized by quantizer 1224, restoring the n-channels to their initial dynamic range. The dequantized n-channel data may be reconstructed and output 1203 by decoder module 1220 or stored in a database.

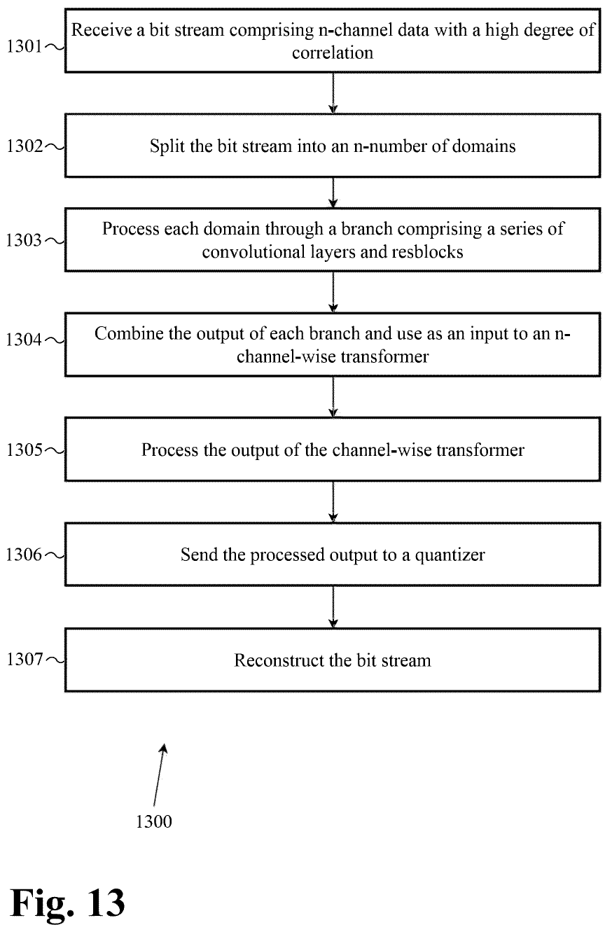

FIG. 13 is a flow diagram illustrating an exemplary method for processing a compressed n-channel bit stream using an AI deblocking network, according to an embodiment. According to the embodiment, the process begins at step 1301 when a decoder module 1220 receives, retrieves, or otherwise obtains a bit stream comprising n-channel data with a high degree of correlation. At step 1302, the bit stream is split into an n-number of domains. For example, if the received bit stream comprises image data in the form of R-, G,- and B-channels, then the bit stream would be split into 3 domains, one for each color (RGB). At step 1303, each domain is processed through a branch comprising a series of convolutional layers and ResBlocks. The number of layers and composition of said layers may depend upon the embodiment and the n-channel data being processed. At step 1304, the output of each branch is combined back into a single bitstream and used as an input into an n-channel wise transformer 1135. At step 1305, the output of the channel-wise transformer may be processed through one or more convolutional layers and/or transformation layers, according to various implementations. At step 1306, the processed output may be sent to a quantizer for upscaling and other data processing tasks. As a last step 1307, the bit stream may be reconstructed into its original uncompressed form.

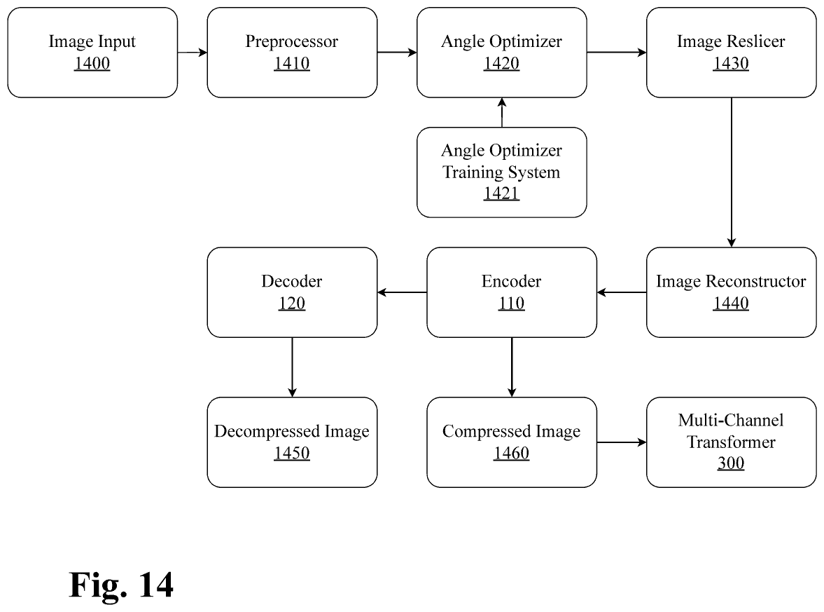

FIG. 14 is a block diagram illustrating an exemplary architecture for a system and method for image series transformation for optimal compressibility with neural upsampling. This system is suited for applications involving series of images, such as slices in a CAT scan or successive aerial images of a location on Earth. For instance, in a CAT scan of a patient's abdomen, the system can process hundreds of parallel slices, each representing a cross-section of the body at a specific position along the scanning axis. Similarly, in aerial photography, the system can handle a series of overlapping images captured by a drone or satellite over a specific geographic area.

The system receives an image input 1400, which represents a series of images. In the case of a CAT scan, these images would be parallel slices perpendicular to the axis of motion of the target as the imaging device moves over the target. For example, a CAT scan of a patient's brain might consist of 200 slices, each 1 mm thick, covering the entire brain volume. For aerial photography, the images may be successive photographs of a ground location taken by an imaging platform in motion. For instance, a drone equipped with a high-resolution camera might capture a series of images of a city block from different angles as it flies over the area.

A preprocessor 1410 prepares the input image series for further processing. This may involve data cleaning, normalization, or other transformations specific to the application domain. For example, in a CAT scan, the preprocessor might apply noise reduction algorithms to improve the signal-to-noise ratio of the images or normalize the intensity values across slices to ensure consistent brightness and contrast. In aerial photography, the preprocessor may perform image registration to correct for platform motion and create a consistent 3D representation of the ground location. This could involve using feature detection and matching algorithms to align overlapping images and create a seamless mosaic of the area.

An angle optimizer 1420 is responsible for determining the optimal rotation angle for reslicing the image series to achieve maximum compressibility. In one embodiment, the optimizer 1420 may utilize machine learning infrastructure to analyze the image series and predict the best slicing angle for optimal compression. The angle optimizer 1420 may employ various machine learning methods to accomplish this task. For example, it might use a convolutional neural network (CNN) trained on a dataset of image series with known compressibility at different angles. The CNN would learn to extract relevant features from the input images and predict the optimal slicing angle based on these features. Another approach could involve using a decision tree or random forest algorithm to identify the most informative image characteristics for determining the best slicing angle. These algorithms can handle complex, non-linear relationships between image features and compressibility, making them well-suited for this optimization task. The angle optimizer 1420 may also utilize clustering techniques, such as k-means or hierarchical clustering, to group similar image series together based on their compressibility profiles. By analyzing the common properties of highly compressible image series, the angle optimizer 1420 can infer the optimal slicing angle for new, unseen datasets. Alternatively, the angle optimizer 1420 could employ reinforcement learning algorithms to iteratively explore different slicing angles and learn the optimal strategy over time. The reinforcement learning agent would receive feedback in the form of compression ratios achieved at each angle and adapt its strategy to maximize the overall compressibility of the image series.

An image reslicer 1430 takes the output from the angle optimizer 1420 and reslices the image series accordingly. This process involves transforming the series of images by combining data from multiple original images to create a new series at the optimal rotation angle. For example, in a CAT scan, the image reslicer 1430 might use interpolation techniques, such as trilinear interpolation, to estimate the pixel values in the new slices based on the surrounding pixels in the original slices. This would effectively rotate the image set from a series perpendicular to the axis of motion to a series at the optimal angle off the axis of motion. In the CAT scan scenario, this would effectively rotate the image set from a series perpendicular to the axis of motion to a series at the optimal angle off the axis of motion. For instance, if the optimal angle is determined to be 45 degrees, the image reslicer 1430 would generate a new series of slices that are oriented at a 45-degree angle relative to the original axial slices. For aerial photography, the image reslicer 1430 may adjust for platform motion and topographical features to create an optimally resliced image series. This could involve using 3D projection and mapping techniques to transform the images into a common coordinate system and align them based on the optimal angle. For example, if the optimal angle is found to be 60 degrees relative to the ground plane, the image reslicer 1430 may create a new series of images that are oriented at this angle, effectively minimizing the impact of perspective distortion and enhancing compressibility.

An image reconstructor 1440 compiles the optimized slices back into a coherent image series that can be efficiently compressed and decompressed. It takes the output from the image reslicer 1430 and reassembles the slices, ensuring that the spatial relationships and continuity of the original image series are preserved. For example, in a CAT scan, the image reconstructor 140 might use the position and orientation information associated with each resliced slice to stack them together in the correct order and alignment. This would involve applying the inverse of the rotation transformation used by the image reslicer 1430 to restore the original geometry of the image series. In aerial photography, the image reconstructor 1440 may use the mapping and projection information to stitch the resliced images together into a seamless image that accurately represents the ground location. This reconstruction process is essential for maintaining the integrity of the image data while enabling optimal compression. For instance, in a CAT scan of the heart, the image reconstructor 1440 would ensure that the resliced images are properly aligned and oriented to capture the full cardiac cycle without any gaps or discontinuities.

The reconstructed image series is then passed through an encoder 110, which applies lossy compression techniques, such as JPEG or HEVC, to reduce the data size. This step results in a compressed image 1460 but may introduce some loss of information. For example, in a CAT scan, the encoder 110 might use a high-quality JPEG setting to compress each slice individually, achieving a high compression ratio while preserving most of the important anatomical details. In aerial photography, the encoder 110 could use a state-of-the-art video codec like HEVC to compress the reconstructed image series as a video sequence, exploiting both spatial and temporal redundancies to achieve high compression efficiency.

To recover the lost information, the compressed image 1460 may be processed by a decoder 120, which decompresses the data using the appropriate decompression algorithm. For instance, in a CAT scan, the decoder 120 may use a JPEG decoder to reconstruct each compressed slice back to its original resolution and bit depth. In aerial photography, the decoder 120 may use an HEVC decoder to reconstruct the compressed video sequence back into a series of high-quality images. The decompressed image series is then fed into a multi-channel transformer 300.

The multi-channel transformer, which is a type of correlation network 300, is a trained deep learning model that learns correlations between the original image series and the compressed image series. It employs techniques such as convolutional layers for feature extraction and a channel-wise transformer with attention mechanism to capture inter-channel dependencies. For example, correlation network 300 might use skip connections to propagate high-resolution features from the encoder to the decoder, enabling accurate reconstruction of fine details. The channel-wise transformer would allow the model to weigh the importance of different image channels (e.g., color channels in aerial photography or tissue types in CAT scans) and adapt the upsampling process accordingly. By leveraging these learned correlations, correlation network 300 can effectively upsample the compressed image series and recover lost information. For instance, in a CAT scan of the abdomen, correlation network 300 could recover subtle details of the liver and kidneys that were lost during compression, resulting in a higher-quality reconstructed image series.

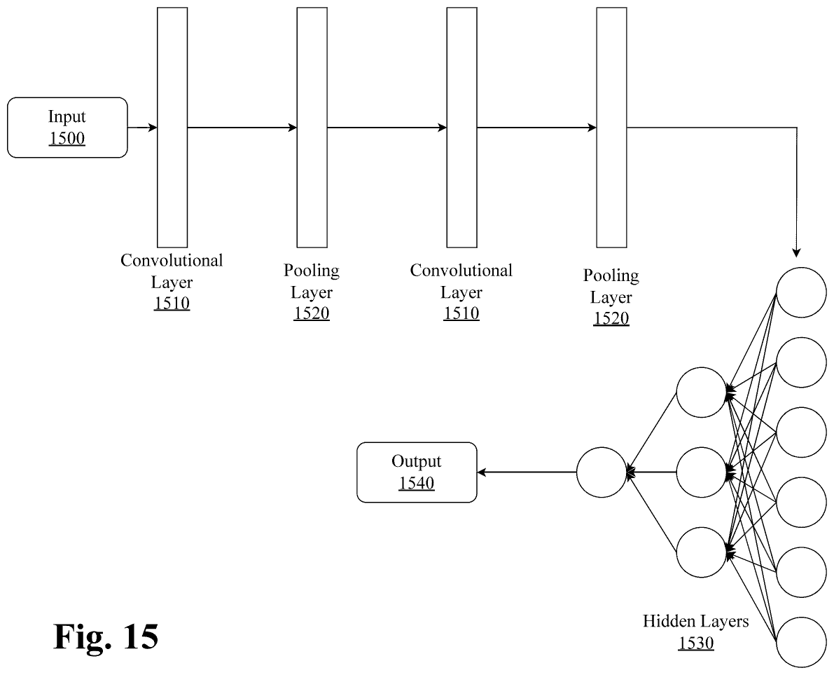

FIG. 15 is a block diagram illustrating a component of a system for image series transformation for optimal compressibility with neural upsampling, an angle optimizer, where the angle optimizer uses a convolutional neural network. An input layer 1500 receives the preprocessed image which needs to be sliced to improved compression.

The input image is then passed through a series of convolutional layers 1510. Each convolutional layer applies a set of learnable filters to the input, performing convolution operations to capture local patterns and spatial dependencies. These filters slide across the input data, computing element-wise multiplications and generating feature maps that highlight relevant patterns and features. The convolutional layers are designed to automatically learn and extract hierarchical representations of the input data, enabling the CNN to identify complex relationships and dependencies within the energy consumption patterns.

After each convolutional layer, a pooling layer 1520 may be applied to downsample the feature maps. Pooling layers reduce the spatial dimensions of the feature maps while retaining the most significant features. Common pooling operations include max pooling and average pooling, which select the maximum or average value within a specified window size. Pooling helps to reduce the computational complexity, control overfitting, and provide translation invariance to the learned features.

The CNN architecture may include multiple convolutional and pooling layers stacked together, allowing for the extraction of increasingly abstract and high-level features as the data progresses through the network. The number and size of the convolutional and pooling layers can be adjusted based on the complexity and characteristics of the input images.

After the convolutional and pooling layers, the extracted features may be flattened and passed through one or more hidden layers 1530. These hidden layers are fully connected, meaning that each neuron in a hidden layer is connected to all the neurons in the previous layer. The hidden layers enable the CNN to learn non-linear combinations of the extracted features and capture complex patterns and relationships within the data. An output layer 1540 produces the optimized angle predictions or recommendations based on the learned features. The output layer can have different configurations depending on the specific task, such as regression for predicting optimal slicing angles or classification for categorizing kinds of input images.

During the training process, the CNN learns the optimal values for the convolutional filters, pooling parameters, and fully connected weights by minimizing a defined loss function. The loss function measures the discrepancy between the predicted outputs and the actual energy consumption values or desired optimization targets. The CNN iteratively adjusts its parameters using optimization algorithms such as gradient descent and backpropagation to minimize the loss and improve its performance.

Once trained, the CNN-based angle optimizer 1420 can take new, unseen images and generate optimized predictions or recommendations for how to optimally slice the images to improve compression. The learned filters and weights enable the CNN to effectively capture and analyze the complex patterns and dependencies within the images, providing accurate and personalized insights for compression on any plurality of image inputs.

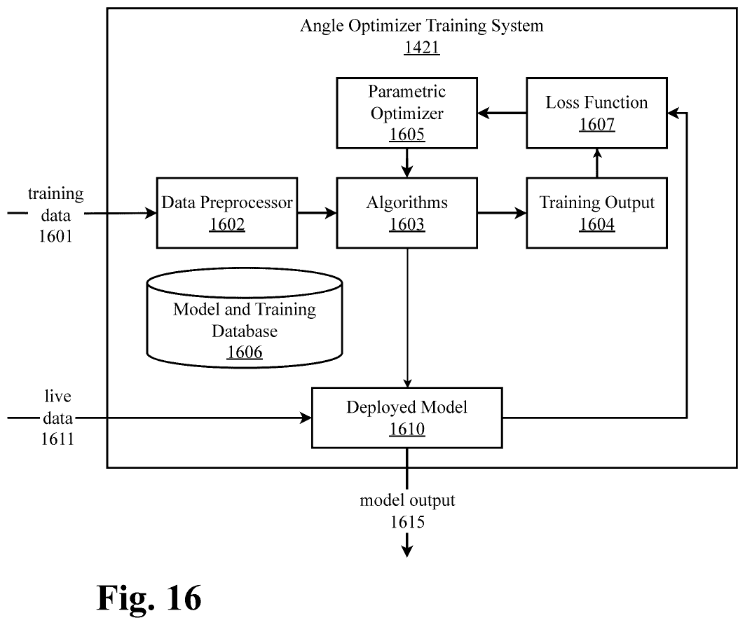

FIG. 16 is a block diagram illustrating a component of a system for image series transformation for optimal compressibility with neural upsampling, an angle optimizer training system. According to the embodiment, the angle optimizer training system 1421 may comprise a model training stage comprising a data preprocessor 1602, one or more machine and/or deep learning algorithms 1603, training output 1604, and a parametric optimizer 1605, and a model deployment stage comprising a deployed and fully trained model 1610 configured to perform tasks described herein such determining correlations between compressed data sets. The angle optimizer training system 1421 may be used to train and deploy an angle optimizer in order to support the services provided by system for image series transformation for optimal compressibility with neural upsampling.

At the model training stage, a plurality of training data 1601 may be received by the energy angle training system 1421. Data preprocessor 1602 may receive the input data (e.g., a plurality of images) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 1602 may also be configured to create training dataset, a validation dataset, and a test set from the plurality of input data 1601. For example, a training dataset may comprise 80% of the preprocessed input data, the validation set 10%, and the test dataset may comprise the remaining 10% of the data. The preprocessed training dataset may be fed as input into one or more machine and/or deep learning algorithms 1603 to train a predictive model for object monitoring and detection.

During model training, training output 1604 is produced and used to measure the accuracy and usefulness of the predictive outputs. During this process a parametric optimizer 1605 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the angle optimizer training system 1421 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 1607 to measure the system's performance. The loss function 1607 compares the training outputs with an expected output and determined how the algorithm needs to be changed in order to improve the quality of the model output. During the training stage, all outputs may be passed through the loss function 1607 on a continuous loop until the algorithms 1603 are in a position where they can effectively be incorporated into a deployed model 1615.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 1610 in a production environment making predictions based on live input data 1611 (e.g., a plurality of images). Further, model correlations and restorations made by deployed model can be used as feedback and applied to model training in the training stage, wherein the model is continuously learning over time using both training data and live data and predictions. A model and training database 1606 is present and configured to store training/test datasets and developed models. Database 1606 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 1603 may comprise a deep learning algorithm such as neural networks (e.g., recurrent, convolutional, long short-term memory networks, etc.).

In some implementations, the angle optimizer training system 1421 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 1606.

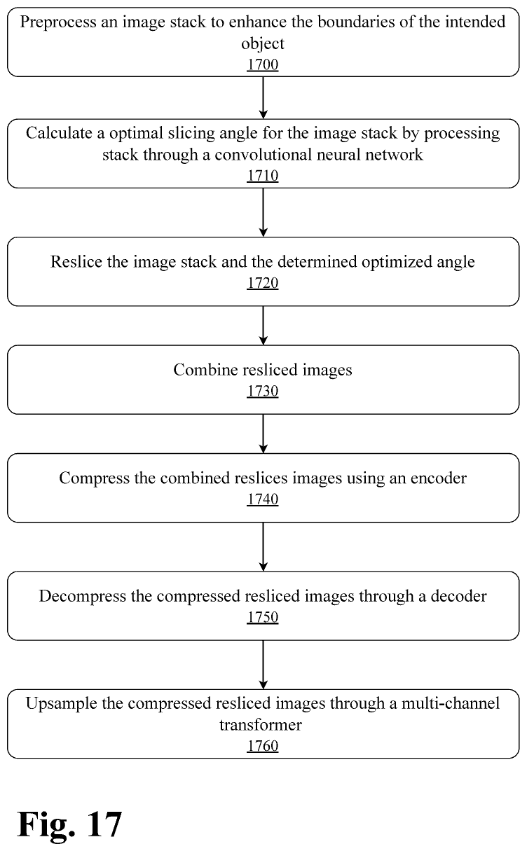

FIG. 17 is a flow diagram illustrating an exemplary method for optimizing the compression and decompression of medical images by slicing the images along various planes before compression. The method leverages advanced image processing, machine learning, and compression techniques to achieve high compression ratios while preserving critical anatomical details.

In a first step 1700, an input image stack undergoes preprocessing to enhance the boundaries of the intended object, such as an organ of interest. This step may involve techniques like edge detection, contrast enhancement, or noise reduction to accentuate the relevant structures and suppress background noise. For example, in a CT scan of the liver, preprocessing may include applying a Sobel filter to highlight the edges of the liver parenchyma and blood vessels while attenuating any imaging artifacts or surrounding tissues.

In a step 1710, determine the optimal slicing angle for the image stack by processing it through a convolutional neural network (CNN). The CNN is trained to predict the most compressible orientation based on the inherent structure and correlations in the data. It learns to extract relevant features, such as edges, textures, and patterns that are indicative of the underlying anatomy and its alignment. For instance, in an MRI scan of the heart, the CNN may identify the long axis of the left ventricle as the optimal reslicing angle, as it captures the most coherent and compressible representation of the cardiac geometry. In one embodiment, the image stack may be processed using a series of functions which, for each x position along the axis of motion: extracts the 2D slice at the current x position, applies edge detection to identify the organ boundaries of the slice, computes the gradient direction at each boundary point, determines the average gradient direction, which represents the perpendicular direction to the organ boundary at the current x position, and calculates the corresponding slicing angle based on the average gradient direction. An example of a series of functions using Mathematica that achieve this goal may be found in APPENDIX A.

Once the optimal slicing angle is determined, the image stack is resliced along that orientation in step a 1720. This involves resampling the data onto a new grid that is rotated or oblique relative to the original acquisition plane. The reslicing process may use interpolation techniques, such as trilinear or spline interpolation, to estimate the intensity values at the new voxel locations. For example, in a CT scan of the lungs, reslicing along a plane that follows the natural curvature of the bronchial tree could result in a more compact and efficient representation of the pulmonary structure.

In a step 1730, the resliced images are combined into a single volume or series. This step ensures that the resliced data is properly aligned and formatted for subsequent compression and processing. The combining process may involve concatenating the resliced images along a new axis, adjusting their spatial coordinates, or applying any necessary transformations to maintain the integrity of the data. For instance, in an MRI scan of the brain, the combined resliced images may form a new volume that is oriented along the anterior-posterior axis, with consistent voxel dimensions and spacing.

In a step 1740, the combined resliced images are compressed using an encoder, such as a video codec like H.265 or a specialized medical image compression algorithm. The encoder exploits the redundancy and correlations in the resliced data to achieve high compression ratios while minimizing perceptual distortion. It may use techniques like motion estimation, transform coding, and entropy coding to efficiently represent the resliced images in a compact bitstream. For example, in a CT scan of the abdomen, the encoder could use a wavelet-based compression scheme that adapts to the local texture and edge characteristics of the resliced data, resulting in a significantly reduced file size.

The compressed bitstream is then passed through a decoder in a step 1750 to reconstruct the resliced images. The decoder applies the inverse operations of the encoder to recover the resliced data from the compressed representation. This may involve techniques like motion compensation, inverse transforms, and entropy decoding to reconstruct the resliced images with minimal loss of quality. For instance, in an MRI scan of the knee, the decoder could use a deep learning-based approach to restore fine details and textures that may have been lost during compression, resulting in a more accurate and visually pleasing reconstruction.

Finally, in step 1760, the reconstructed resliced images are upsampled using a multi-channel transformer architecture as a correlation network. The correlation network learns to map the low-resolution resliced images to their high-resolution counterparts by exploiting the multi-scale dependencies and contextual information in the data. In one embodiment, it may utilize self-attention mechanisms to capture long-range relationships and generate realistic high-frequency details. For example, in a CT scan of the pancreas, the correlation network could upsample the resliced images, recovering fine structures like pancreatic ducts and blood vessels that may be critical for diagnostic interpretation.

The output of the method is a high-quality, high-resolution reconstruction of the original image stack, but with a significantly reduced file size due to the optimal reslicing and compression steps. This enables more efficient storage, transmission, and visualization of large medical image datasets, such as whole-body CT scans or time-series MRI acquisitions.

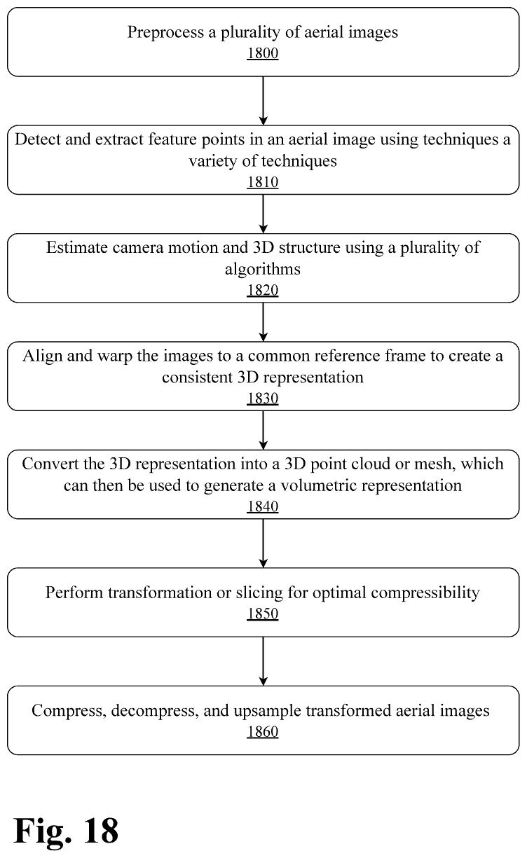

FIG. 18 is a flow diagram illustrating an exemplary method for optimizing the compression and decompression of aerial images by slicing the images along various planes before compression. In a first step 1800, a plurality of aerial images undergo preprocessing to enhance their quality and prepare them for subsequent analysis. This may include techniques like lens distortion correction, color balancing, or noise reduction to ensure consistent and accurate representation of the captured scene. For example, in a drone survey of a construction site, preprocessing may involve applying a radiometric calibration to account for variations in lighting and camera exposure across different images.

In a step 1810, detects and extracts feature points in the preprocessed aerial images using a variety of techniques. These features represent distinctive and stable points in the images that can be reliably matched across different views or scales. Common feature detection algorithms include SIFT (Scale-Invariant Feature Transform), SURF (Speeded Up Robust Features), or ORB (Oriented FAST and Rotated BRIEF). For instance, in a satellite image of an urban area, the method may extract corner points of buildings, road intersections, or other salient structures that are visible across multiple images.

Using the extracted feature points, a step 1820 estimates the camera motion and 3D structure of the scene using a plurality of algorithms. This process, known as Structure from Motion (SfM), involves solving for the camera positions, orientations, and intrinsic parameters that best explain the observed feature matches. Common SfM techniques include bundle adjustment, factorization, or incremental reconstruction. For example, in a drone survey of a natural landscape, SfM may recover the 3D coordinates of terrain features like rocks, trees, or rivers, as well as the trajectory of the drone camera.

Once the camera motion and 3D structure are estimated, a step 1830 aligns and warps the aerial images to a common reference frame, creating a consistent 3D representation of the scene. This involves applying geometric transformations to the images, such as rotation, translation, or scaling, to bring them into a unified coordinate system. The alignment process may also involve techniques like image stitching, mosaicking, or blending to create seamless transitions between overlapping views. For instance, in a satellite image of a coastal region, the method may warp and blend multiple images to create a large-scale, georeferenced image that covers the entire area of interest.

In a step 1840, the aligned 3D representation is converted into a 3D point cloud or mesh, which serves as the basis for generating a volumetric representation of the scene. A point cloud is a set of 3D points that represents the surface geometry of the scene, while a mesh is a more compact and structured representation that connects the points into a network of triangles or other polygonal primitives. The conversion process may involve techniques like Poisson surface reconstruction, Delaunay triangulation, or octree partitioning to create a coherent and efficient 3D model. For example, in a drone survey of an archaeological site, the method may generate a dense point cloud of the excavated structures and artifacts, which can be further processed into a textured 3D mesh for visualization and analysis.

With the volumetric representation obtained, a step 1850 performs transformations or slicing operations to achieve optimal compressibility of the aerial image stack. This may involve techniques like octree compression, wavelet transforms, or adaptive reslicing along dominant planes or axes in the 3D model. The goal is to exploit the inherent redundancy and correlations in the volumetric data to achieve high compression ratios while preserving essential features and details. For instance, in a satellite image of a forested region, the method may adaptively slice the 3D model along the terrain surface, aligning the compression scheme with the natural geometry of the trees and minimizing the impact of occlusions or shadows.

In a step 1860, compress, decompress, and upsample the transformed aerial image stack using state-of-the-art codec and deep learning techniques. The compression step may utilize video codecs like H.265 or VP9, which can efficiently encode the sliced volumetric data as a sequence of frames. The decompression step reconstructs the original data from the compressed bitstream, while the upsampling step enhances the resolution and quality of the reconstructed images using deep learning models like convolutional neural networks (CNNs) or generative adversarial networks (GANs). For example, in a drone survey of an agricultural field, the method may compress the sliced 3D model of the crop canopy, reconstruct it at a lower resolution, and then upsample it using a CNN that is trained to recover fine details of leaves, stems, and fruits.

The output of the method is a highly compressed and accurately reconstructed aerial image stack that retains the essential information and visual quality of the original data. This enables more efficient storage, transmission, and analysis of large-scale aerial datasets, such as those used in mapping, monitoring, or inspection applications.

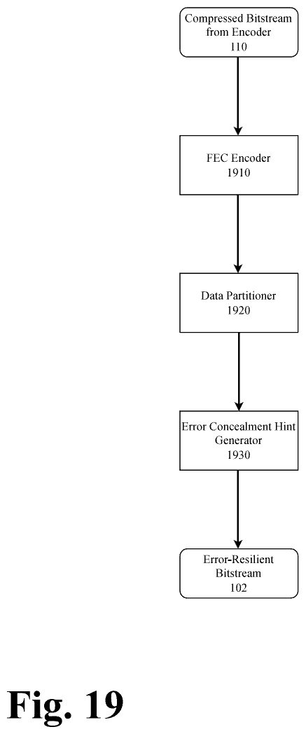

FIG. 19 is a block diagram illustrating exemplary architecture for the error resilience subsystem 1900, which is designed to enhance the robustness of compressed SAR image data against transmission errors and data loss. The subsystem comprises several key components that work together to apply various error resilience techniques to the compressed bitstream.

The input to the error resilience subsystem 1900 is the compressed bitstream from the encoder subsystem 110. This compressed data first enters a forward error correction (FEC) encoder 1910. The FEC encoder 1910 applies error correction coding to the compressed data, adding redundant information that can be used to detect and correct errors during transmission. In this embodiment, the FEC encoder 1910 can use either Reed-Solomon codes or Low-Density Parity-Check (LDPC) codes, depending on the specific requirements of the application.

Following the FEC encoder, the data flows into a data partitioner 1920. The data partitioner 1920 separates the compressed image data into multiple partitions based on their importance to image reconstruction. Typically, it creates at least three partitions: header information, low-frequency coefficients, and high-frequency coefficients. This partitioning allows for prioritized protection and transmission of the most critical image data.

Next, an error concealment hint generator 1930 analyzes the partitioned data and generates hints that can be used to conceal errors during the decoding process. These hints may include information about neighboring blocks or redundant feature data. The generator embeds these hints within the compressed data stream in a way that minimizes overhead while maximizing their utility during error concealment.

The partitioned and hint-embedded data then passes through a bitstream assembler 1940. This component reassembles the various partitions and integrates the error concealment hints into a cohesive bitstream structure that can be efficiently transmitted and later decoded.

Finally, an optional interleaver 1950 may be employed to spread burst errors across different parts of the bitstream. This helps to distribute any potential error bursts, making them easier to correct or conceal during the decoding process.

The output of the error resilience subsystem 1900 is an error-resilient bitstream that incorporates forward error correction, data partitioning, and error concealment hints. This enhanced bitstream is then ready for transmission or storage, with improved capability to withstand errors and data loss during these processes.

The error resilience subsystem 1900 is designed to be flexible and adaptable. The specific parameters of each component, such as the FEC code rate, partitioning scheme, and hint generation algorithm, can be adjusted based on the characteristics of the input data and the expected transmission conditions. This adaptability ensures that the system can provide optimal error resilience for a wide range of SAR imaging applications and transmission scenarios.

The error resilience techniques can be adapted for different types of image data. For medical imagery, such as CT or MRI scans, the data partitioning may prioritize diagnostically critical regions, identified through AI-assisted segmentation. For example, in brain scans, areas showing potential tumors or lesions would receive the highest protection. In aerial imagery, the partitioning might prioritize areas of high detail or known points of interest, such as urban centers or specific geological features. The error concealment hints for medical images might leverage inter-slice correlations, while for aerial imagery, they could exploit the continuity of geographical features across adjacent images.

The error resilience subsystem can be optimized for various transmission conditions. In high-noise environments, such as satellite communications in adverse weather, the system might increase the redundancy in forward error correction coding, potentially using more robust LDPC codes with lower code rates. For transmissions over networks with frequent but short interruptions, the interleaving depth could be increased to spread burst errors over a larger data range. In bandwidth-constrained scenarios, the system might employ more aggressive data partitioning, allocating a higher percentage of the bitstream to critical image components while more heavily compressing less important regions. For real-time applications with strict latency requirements, the system could use shorter block lengths in the error correction coding to reduce encoding and decoding delays, potentially at the cost of slightly reduced error correction capability.

The error resilience techniques applied by subsystem 1900 are designed to work in synergy with the AI deblocking network 123 during the decoding process. When the decoder subsystem 120 receives the error-resilient bitstream, it first applies the error correction and concealment techniques based on the embedded FEC codes and error concealment hints. The resulting corrected and partially reconstructed image data is then fed into the AI deblocking network 123.

The AI deblocking network 123 is trained to recognize and utilize the error resilience information embedded in the bitstream. The network's input layers are modified to accept not only the decompressed image data but also error flags indicating which regions were affected by transmission errors and subsequently corrected or concealed. The convolutional layers of the network are trained to identify artifacts resulting from both compression and error concealment, allowing for more effective removal of these artifacts. The channel-wise transformer component of the network is augmented to consider the reliability of different image regions based on the applied error resilience techniques. It assigns higher attention weights to regions that were received without errors or were more successfully corrected. Furthermore, the network incorporates an additional loss term during training that penalizes discrepancies between the reconstructed image and the original in areas flagged as affected by transmission errors.

This integrated approach allows the AI deblocking network to not only remove compression artifacts but also to refine and improve upon the initial error concealment performed by the decoder. The result is a more robust reconstruction process that leverages both traditional error resilience techniques and advanced deep learning methods to produce high-quality images even in the presence of significant transmission errors. By combining the strengths of error resilience coding and AI-based image enhancement, the system achieves superior image reconstruction quality and reliability across a wide range of transmission conditions and error scenarios.

In a non-limiting use case example, consider a scenario where SAR image data is being transmitted from a satellite to a ground station over a noisy communication channel. The error resilience subsystem 1900 can be configured as follows:

The FEC encoder 1910 applies a Reed-Solomon code with a code rate of 0.9, adding 10% overhead for error correction. This choice balances error correction capability with transmission efficiency. The data partitioner 1920 divides the compressed image data into three partitions: header information (5% of the data), low-frequency coefficients (35% of the data), and high-frequency coefficients (60% of the data). This partitioning ensures that the most critical information (header and low-frequency coefficients) receives stronger protection.

The error concealment hint generator 1930 creates hints based on the correlation between neighboring 8×8 pixel blocks. These hints are embedded within the high-frequency coefficient partition, utilizing approximately 1% of the total bitstream. The bitstream assembler 1940 then packages these components together, placing the header information and low-frequency coefficients at the beginning of the bitstream for prioritized transmission. Finally, the interleaver 1950 spreads the data over a depth of 1000 bits to combat potential burst errors during transmission.

During decoding, if errors are detected in the high-frequency coefficient partition, the decoder can use the error concealment hints to approximate the missing data based on successfully received neighboring blocks. This approach allows for graceful degradation of image quality in the presence of transmission errors, rather than catastrophic failure. This example demonstrates how the error resilience subsystem 1900 can be tailored to specific transmission conditions and data characteristics, providing robust protection for critical image components while maintaining overall system efficiency.

In another non-limiting use case example, consider a scenario where a series of high-resolution CT (Computed Tomography) scans of a patient's brain are being transmitted from a hospital's imaging center to a remote specialist for urgent consultation. The error resilience subsystem 1900 can be configured as follows: The FEC encoder 1910 employs a Low-Density Parity-Check (LDPC) code with a code rate of 0.8, providing strong error correction capabilities. This higher level of redundancy is chosen due to the critical nature of medical data where error-free transmission is paramount.

The data partitioner 1920 divides the compressed image data into four partitions: header information (5% of the data), diagnostic-quality regions of interest (ROIs) identified by AI (30% of the data), medium-priority regions (35% of the data), and background/low-priority regions (30% of the data). This partitioning ensures that the most critical diagnostic information receives the strongest protection and prioritized transmission. The error concealment hint generator 1930 creates hints based on the 3D structure of the CT scan series, exploiting inter-slice correlations. These hints are embedded within the medium-priority and low-priority partitions, using approximately 2% of the total bitstream.

The bitstream assembler 1940 packages these components together, placing the header information and diagnostic-quality ROIs at the beginning of the bitstream, followed by the medium-priority regions, and finally the background/low-priority regions. The interleaver 1950 is configured with a depth of 2000 bits to provide robust protection against burst errors that might occur during wireless transmission to the remote specialist's device.

During decoding, if any errors are detected in the medium-priority or low-priority regions, the decoder can use the error concealment hints to reconstruct the affected areas based on successfully received neighboring slices and regions. This approach ensures that the most critical diagnostic information is preserved with the highest fidelity, while any errors in less critical regions are concealed effectively.

This example demonstrates how the error resilience subsystem 1900 can be adapted to the specific requirements of medical imaging data transmission, where maintaining the integrity of diagnostically important regions is crucial, while still providing effective error resilience for the entire dataset.

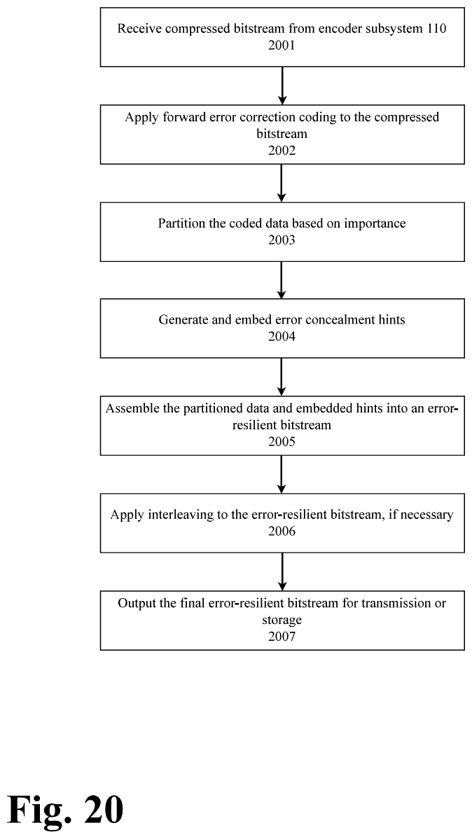

FIG. 20 is a method diagram illustrating the use of error-resilient subsystem 1900. The process begins when the subsystem receives the compressed bitstream from encoder subsystem 110 2001. Next, forward error correction coding is applied to the compressed bitstream, adding redundant information to enable error detection and correction during transmission 2002. The coded data is then partitioned based on importance, separating critical information such as headers and low-frequency coefficients from less crucial data 2003. Following this, the subsystem generates error concealment hints and embeds them within the partitioned data, providing additional information for error recovery during decoding 2004. The partitioned data and embedded hints are then assembled into a cohesive error-resilient bitstream, structuring the data for efficient transmission and decoding 2005. Optionally, interleaving may be applied to the error-resilient bitstream to distribute potential burst errors 2006. Finally, the subsystem outputs the final error-resilient bitstream, which is now prepared for transmission or storage with enhanced protection against data loss and transmission errors 2007.

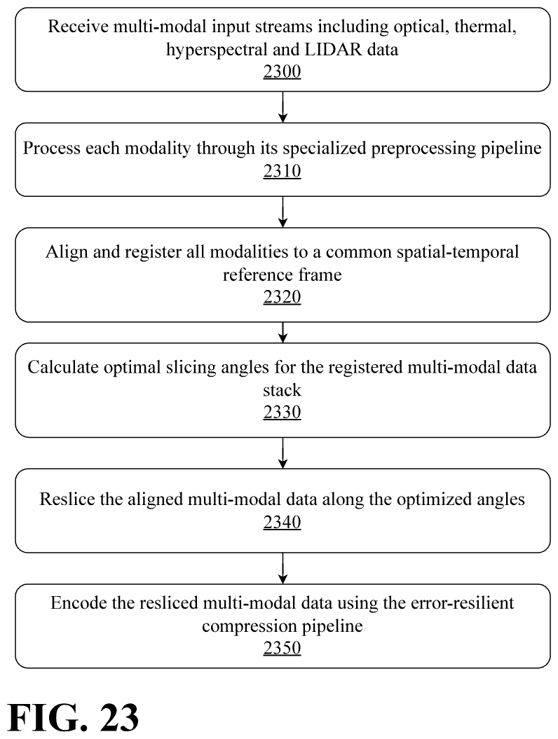

FIG. 23 is a flow diagram illustrating an exemplary method for optimizing the compression and decompression of multimodal data by slicing data along various planes before compression. In a first step 2300, multiple input streams comprising different modalities including optical, thermal, hyperspectral, and LIDAR data are received, where each modality represents different aspects of the captured scene-optical data providing visual information, thermal data capturing heat signatures, hyperspectral data offering material composition, and LIDAR data providing precise geometric measurements.

In a step 2310, the received data streams undergo specialized preprocessing through dedicated pipelines designed for each modality. For optical data, this includes color space conversion and lens distortion correction. Thermal data undergoes temperature calibration and range normalization. Hyperspectral data is processed through band selection and atmospheric correction. LIDAR data experiences point cloud filtering and surface reconstruction.

In a step 2320, the system aligns and registers all modalities to a common spatial-temporal reference frame. This step ensures that data from different sensors, potentially captured at different times and from different perspectives, is properly synchronized and geometrically aligned. The registration process may use feature matching and homography estimation to create a unified coordinate system across all modalities.

In a step 2330, optimal slicing angles are calculated for the registered multi-modal data stack. These angles are determined through analysis of the data structure across all modalities, identifying orientations that maximize compressibility while preserving the complementary information between different modality types. The optimization process may consider both spatial and spectral correlations in the data.

In a step 2340, the aligned multi-modal data is resliced along the optimized angles. This reslicing operation transforms the data into a representation that is more amenable to compression, exploiting redundancies both within and across modalities. The reslicing preserves the essential characteristics of each modality while enabling more efficient compression.

In a step 2350, the resliced multi-modal data is encoded using the error-resilient compression pipeline. This step applies forward error correction coding, data partitioning based on importance, and error concealment hint embedding to ensure robust transmission and storage of the compressed multi-modal data.

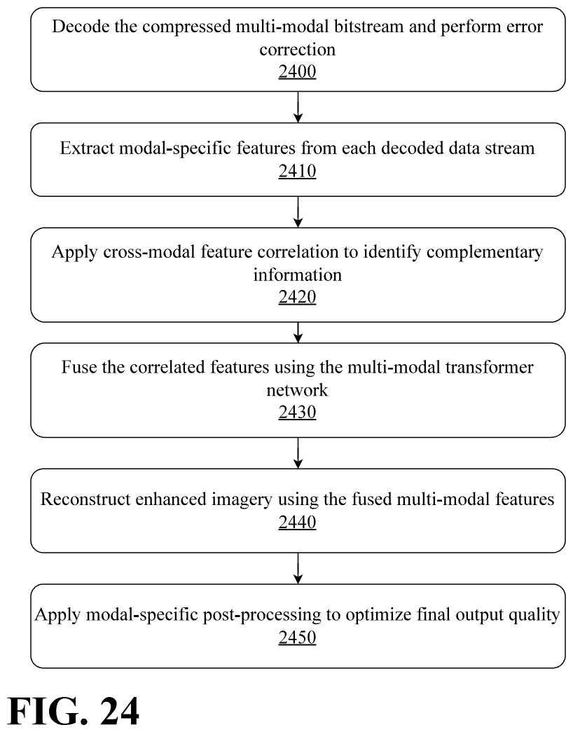

FIG. 24 is a flow diagram illustrating an exemplary method for reconstructing and enhancing the compressed and decompressed multimodal data that has been sliced. In a first step 2400, the compressed multi-modal bitstream is decoded and error correction is performed using the embedded forward error correction codes and error concealment hints, allowing for recovery from transmission errors and data loss.

In a step 2410, modal-specific features are extracted from each decoded data stream. This includes edge and texture features from optical data, temperature gradients from thermal data, spectral signatures from hyperspectral data, and geometric features from LIDAR data, with each feature extraction process optimized for its respective modality's characteristics.

In a step 2420, cross-modal feature correlation is applied to identify complementary information between different modalities. This process analyzes relationships between features across modalities, such as matching thermal signatures with optical edges, or correlating LIDAR-derived geometry with hyperspectral material properties.

In a step 2430, the correlated features are fused using the multi-modal transformer network. The transformer architecture employs self-attention mechanisms to weight the importance of different features and their relationships, creating a unified representation that preserves the most relevant information from each modality.

In a step 2440, enhanced imagery is reconstructed using the fused multi-modal features. This reconstruction process leverages the complementary information from all modalities to generate output that maintains the key characteristics of each input type while enhancing overall quality through cross-modal relationships.

In a step 2450, modal-specific post-processing is applied to optimize the final output quality. This includes color correction for optical data, temperature calibration refinement for thermal data, spectral enhancement for hyperspectral data, and geometry refinement for LIDAR data, ensuring each modality's output meets its specific quality requirements.

### Exemplary Computing Environment

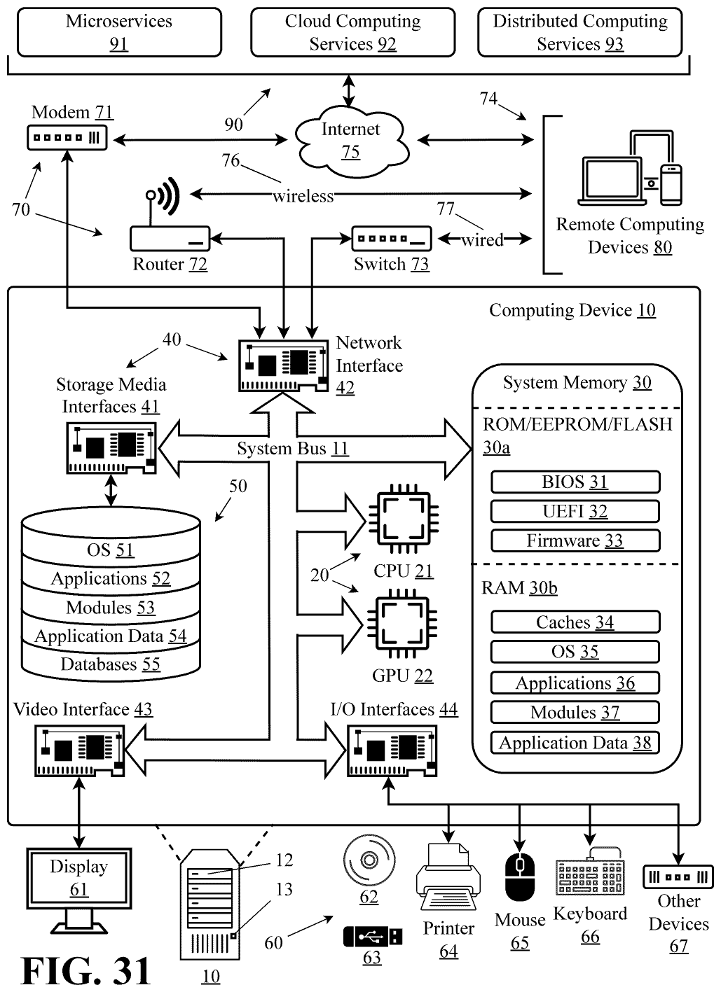

FIG. 31 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like CISC or RISC. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, and graph databases.

Applications (also known as computer software or software applications) are sets of programming instructions designed to perform specific tasks or provide specific functionality on a computer or other computing devices. Applications are typically written in high-level programming languages such as C++, Java, Scala, Rust, Go, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP or message queues. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

COMPUTER PROGRAM LISTING APPENDIX
SAMPLE MATHEMATICA CODE FOR OPTIMALLY SLICING A PLURALITY
OF IMAGES WITHOUT A CONVOLUTIONAL NEURAL NETWORK

```
‘‘‘mathematica
(* Function to preprocess the image stack *)
preprocessImageStack[imageStack_] := Module[{preprocessed},
  preprocessed = GaussianFilter[imageStack, 2]; (* Smoothing *)
  preprocessed = LaplacianGaussianFilter[preprocessed, 2]; (* Edge enhancement *)
  preprocessed
];
(* Function to compute the slicing angle at a given x position *)
computeSlicingAngle[slice_] := Module[{edges, gradients, avgGradient, angle},
  edges = EdgeDetect[slice, Method -> “Sobel”];
  gradients = GradientOrientationFilter[edges, 1];
  avgGradient = Mean[gradients[1, 1]]]; (* Average gradient direction *)
  angle = ArcTan[avgGradient[2]]/avgGradient[1]]]; (* Convert to angle *)
  angle
];
(* Function to reslice the image stack with adaptive angles *)
adaptiveReslice[imageStack_] := Module[{nx, ny, nz, preprocessed, angles,
reslicedStack},
  {nx, ny, nz} = Dimensions[imageStack];
  preprocessed = preprocessImageStack[imageStack];
  angles = Table[
    computeSlicingAngle[preprocessed[[x]]],
    {x, 1, nx}
  ];
  reslicedStack = Table[
    resliceImageStack[imageStack, angle],
    { angle, angles }
  ];
  reslicedStack
];
(* Function to combine resliced images, accounting for overlapping voxels *)
combineReslicedImages[reslicedStack_] := Module[{ combined, weights},
  combined = Total[reslicedStack];
  weights = Total[Unitize[reslicedStack], {2}];
  combined = MapThread[Divide, { combined, weights }, 2];
  combined
];
(* Example usage *)
imageStack = (* Load or generate your image stack *);
reslicedStack = adaptiveReslice[imageStack];
finalStack = combineReslicedImages[reslicedStack];
```

What is claimed is:

1. A collaborative autonomous vehicle sensor fusion system comprising:
a plurality of autonomous vehicles configured to:
capture multimodal sensor data;
identify safety-critical objects within the sensor data;
apply priority-based compression to the sensor data based on safety criticality of detected objects; and
share compressed sensor data via vehicle-to-vehicle communication; and
a multi-vehicle deblocking network configured to:
receive compressed sensor data from the plurality of autonomous vehicles;
enhance perception data for each autonomous vehicle using sensor data from multiple vehicles in the plurality; and
prioritize reconstruction quality for safety-critical objects over non-safety-critical objects;
wherein the system enables detection of safety-critical objects that are occluded from individual autonomous vehicles through collaborative sensor fusion across the plurality of autonomous vehicles.

2. The system of claim 1, wherein enhancing perception data comprises fusing multimodal sensor data from multiple vehicles by identifying cross-modal correlations between different sensor types and using the correlations to reconstruct sensor information that is degraded or occluded in individual vehicles.

3. The system of claim 1, wherein the priority-based compression applies different compression ratios to different regions of the sensor data, with safety-critical regions receiving lower compression ratios than non-safety-critical regions.

4. The system of claim 1, wherein identifying safety-critical objects comprises classifying vulnerable road users as having higher safety criticality than vehicles or infrastructure objects.

5. The system of claim 1, further comprising an error resilience subsystem configured to apply error correction coding with protection levels corresponding to the safety criticality of detected objects.

6. The system of claim 1, wherein the vehicle-to-vehicle communication adapts communication protocols based on latency requirements of the shared sensor data.

7. The system of claim 1, wherein each autonomous vehicle maintains autonomous operation capability using local sensor data when vehicle-to-vehicle communication is unavailable.

8. The system of claim 1, wherein the multi-vehicle deblocking network processes sensor data from vehicles at different spatial positions to overcome line-of-sight limitations affecting individual vehicles.

9. The system of claim 2, wherein the cross-modal correlations comprise spatial relationships between LiDAR geometry data and optical image features from multiple vehicles.

10. The system of claim 1, wherein the multimodal sensor data comprises at least two of: LiDAR point cloud data, optical camera data, thermal imaging data, and radar detection data.

11. A method for collaborative autonomous vehicle sensor fusion comprising the steps of:
capturing multimodal sensor data at each of a plurality of autonomous vehicles;
identifying safety-critical objects within the sensor data at each autonomous vehicle;
applying priority-based compression to the sensor data based on safety criticality of detected objects;
sharing compressed sensor data between the autonomous vehicles via vehicle-to-vehicle communication;
receiving the compressed sensor data from the plurality of autonomous vehicles at a multi-vehicle deblocking network;
enhancing perception data for each autonomous vehicle using sensor data from multiple vehicles in the plurality; and
prioritizing reconstruction quality for safety-critical objects over non-safety-critical objects;
wherein the method enables detection of safety-critical objects that are occluded from individual autonomous vehicles through collaborative sensor fusion across the plurality of autonomous vehicles.

12. The method of claim 11, wherein enhancing perception data comprises fusing multimodal sensor data from multiple vehicles by identifying cross-modal correlations between different sensor types and using the correlations to reconstruct sensor information that is degraded or occluded in individual vehicles.

13. The method of claim 11, wherein applying priority-based compression comprises applying different compression ratios to different regions of the sensor data, with safety-critical regions receiving lower compression ratios than non-safety-critical regions.

14. The method of claim 11, wherein identifying safety-critical objects comprises classifying vulnerable road users as having higher safety criticality than vehicles or infrastructure objects.

15. The method of claim 11, further comprising the step of applying error correction coding with protection levels corresponding to the safety criticality of detected objects.

16. The method of claim 11, wherein sharing compressed sensor data comprises adapting communication protocols based on latency requirements of the shared sensor data.

17. The method of claim 11, further comprising maintaining autonomous operation at each vehicle using local sensor data when vehicle-to-vehicle communication is unavailable.

18. The method of claim 11, wherein enhancing perception data comprises processing sensor data from vehicles at different spatial positions to overcome line-of-sight limitations affecting individual vehicles.

19. The method of claim 12, wherein identifying cross-modal correlations comprises determining spatial relationships between LiDAR geometry data and optical image features from multiple vehicles.

20. The method of claim 11, wherein capturing multimodal sensor data comprises capturing at least two of: LiDAR point cloud data, optical camera data, thermal imaging data, and radar detection data.
